(19) United States
(12) Patent Application Publication
(10) Pub. No.: US 2026/0275151 A1
(43) Pub. Date: Sep. 17, 2026

(54) COATING COMPOSITIONS BASED ON CYCLIC AND LINEAR OLEFINS WITH ADHESION PROMOTERS

(71) Applicant: MATERIA, INC., Pasadena, CA (US)

(72) Inventors: Shengxi LI, Arcadia, CA (US); Javier Antonio GARCIA, Gardena, CA (US); Brian Joseph ROHDE, Houston, TX (US); Andrew NICKEL, South Pasadena, CA (US); Wenliang Patrick YANG, Ballston Lake, NY (US)

(21) Appl. No.: 19/168,192

(22) PCT Filed: Mar. 25, 2024
(86) PCT No.: PCT/US2024/021363

§ 371 Date: Sep. 23, 2025

Related U.S. Application Data
(60) Provisional application No. 63/491,956, filed on Mar. 23, 2023.

(51) Int. Cl. C09D 145/00; C08K 3/36; C08K 9/04; C09D 5/08; C09D 7/43; C09D 7/61; C09D 7/63

(52) U.S. Cl. CPC C09D 145/00; C08K 3/36; C08K 9/04; C09D 5/084; C09D 7/43; C09D 7/61; C09D 7/63

(57) ABSTRACT

The invention relates to coating compositions, ROMP polymers, ROMP polymer composites, and anti-corrosion materials and methods for preventing corrosion of pipelines and associated equipment, structures, and objects used in offshore drilling. The invention relates to articles of manufacture comprising the coating compositions, ROMP polymers, ROMP polymer composites, and anti-corrosion materials.

### CROSS REFERENCE TO RELATED APPLICATIONS

The application claims the benefit of U.S. Provisional Patent Application No. 63/491,956, filed Mar. 23, 2023, the disclosure of which is incorporated herein by reference.

### TECHNICAL FIELD

This invention relates to compositions suitable for use as coatings. More particularly, this invention relates to compositions suitable for use as industrial coatings such as anti-corrosion coatings and protective coatings. This invention relates to compositions and methods for coating substrates. More particularly, the invention relates to coating compositions and methods for coating substrates, where the coating compositions comprise polymerized olefins and cyclic olefins, via different chemical transformations. The invention also relates to methods of applying the coatings to the substrates.

The coating compositions of the invention may be utilized for a wide range of substrates especially ones used in petrochemical and chemical production operations. The invention has utility in the fields of polymers, materials, and manufacture.

### BACKGROUND

Materials deteriorate from interaction with the environment by mechanisms including corrosion, erosion and other processes. Protective coatings can provide protection against surface property deterioration of a wide range of substrates. The protective coating can protect metal substrates from corrosion, protect polymer and composite substrates against deterioration due to ice, acid rain, salt water, weathering and UV, protect wood, concrete, brick substrates against deterioration due to moisture ingression and degradation.

According to the National Association of Corrosion Engineers International, corrosion is a naturally occurring phenomenon commonly defined as the deterioration of a material (usually a metal) that results from a chemical or electrochemical reaction with its environment. Corrosion causes severe damage and it is very costly to repair. Protective coatings are an effective way to provide protection against corrosion. Corrosion of metals occurs through either chemical or electrochemical reactions. Electrochemical corrosion is the most common form of metal corrosion. For metals such as iron and/or steel, corrosion happens when they come in contact with oxygen and moisture (e.g., humidity, vapour, immersion), and rust begins to form.

Exposure to water (e.g., ground water, sea water, atmospheric water, etc.), corrosive chemicals, ultraviolet radiation, ozone, and other harmful factors can cause the unprotected surfaces of objects such as, for example, automobiles, buses, boats, trains, other vehicles, aircrafts, bridges, signage, buildings, sidewalks, roads, subterranean pipelines and equipment, and petrochemical and chemical production equipment, to suffer from changes in quality over time leading to deterioration or failure of the object.

Corrosion is so widespread and so costly to repair, it is recommended to take effective precautionary measures when it comes to corrosion prevention.

One of the best ways to prevent corrosion is to apply a protective coating. Such a protective coating protects its substrate by preventing contact between the substrate and harsh environments (atmospheric, chemical, etc.).

Therefore, over the years there has been an ongoing need for coating compositions (e.g., anti-corrosion coating compositions) which provide surface protection to objects from corrosive materials or damaging environmental conditions.

Most pipes and pipelines used in petrochemical and chemical production operations are constructed of metal, typically some grade of steel, and many are jacketed in insulation. If during installation of the pipe or pipeline the insulation material covering the pipe or pipeline becomes damaged or degrades over time, the underlying surface of the pipe or pipeline is now at risk of being in direct contact with the atmospheric environment, which may lead to a host of problems including premature failure of the pipe or pipeline resulting in increased repair and/or replacement costs.

Therefore, there is a need for an underlying coating applied to the pipe or pipeline surface, between the pipe or pipeline surface and the insulation material, which will act as an anti-corrosion barrier in case the insulation material is damaged or degrades. This need has led to the introduction of a number of coating compositions for the purpose of protecting steel pipelines and structures.

Epoxy, polyamide and polyurethane based coating compositions have been used extensively to prevent corrosion of steel pipelines and structures.

The industry has relied on 2K epoxies, however, liquid 2-part epoxies typically require long cure cycles and are not as conducive to rapid coating operations that facilitate manufacturing.

Despite advances achieved in the art in the area of coating compositions, particularly anti-corrosion coating compositions for coating pipelines and structures, a continuing need exists for further improvements.

### SUMMARY OF THE INVENTION

The invention is directed to addressing one or more of the aforementioned concerns and relates to coating compositions and methods for coating substrates with the coating compositions of the invention. The coating compositions of the invention may be used for a variety of purposes, including without limitation, decoration; improving the barrier properties of packaging; protection of substrate materials which can be: metals such as steel, stainless steel, aluminum, copper, iron, nickel, titanium, silver, or nonmetals such as glass, concrete, ceramics, porcelain, brick, stone, plastics, rubber, wood, cloth, fabrics, or composites such as reinforced plastics, electronic assemblies; and/or protection of substrate surfaces from time wise changes in quality, or deterioration, due to environmental exposure. In other words, coating compositions of the invention may be applied to substrate surfaces to provide protection, including anti-corrosion protection, against deterioration of the substrate material and/or substrate surface due to environmental exposure.

Coating compositions of the invention may also be used as adhesives.

In particular, the invention provides coating compositions for coating pipes, pipelines, and structures used in petrochemical and chemical production operations to provide an anti-corrosion barrier against deterioration of the underlying pipe, pipeline, equipment, structure, or object due to environmental exposure and other corrosive materials. The coatings of the invention provide a constant protective lining that helps save pipes from the damaging effects of corrosion. Pipeline coating is one of the most reliable corrosion prevention methods used by industries today.

The coating compositions of the invention offer several advantages over the prior art materials used for providing a protective coating on pipes, pipelines, equipment, structures, and objects used in petrochemical and chemical production operations.

In particular, coating compositions of the invention may be formulated to meet a wide variety of application conditions and needs.

As an example of one advantage, the coating compositions of the invention are designed to provide long term corrosion inhibition by serving as an impermeable barrier to oxygen, water, ions, etc. The coating compositions of the invention are not porous. The coating compositions of the invention can be applied and cured in high humidity conditions and at colder temperatures than common coatings.

As an example of another advantage, the coating compositions of the invention can be formulated to have a wide range of tunable cure times.

For example, the coating compositions of the invention may be formulated to cure quickly (“fast cure”) so that they dry to the touch rapidly after being applied to the substrate surface. A fast-cure coating composition of the invention has rapid dry to touch time of less than 20 minutes, preferably less than 10 minutes and more preferably less than 1 minute, even within seconds of being applied to a surface. An article coated with a fast-cure composition of the invention is handleable and has a durable coating in less than 60 minutes, preferably less than 30 minutes and more preferably in 10 minutes or less after application. In comparison, liquid epoxies typically take many hours to cure.

As an example of another advantage, the coating compositions of the invention are solvent free.

As an example of another advantage, the coating compositions of the invention are resistant to cracking and delamination in hot/wet aqueous environments.

The coating compositions of the invention can be prepared by different chemical transformations and can be processed by a variety of methods.

The coating compositions may be cured by ring opening metathesis polymerization (ROMP) comprising reacting at least one cyclic olefin with at least one metal carbene olefin metathesis catalyst.

More particularly, the invention relates to a coating composition comprising, consisting essentially of, or consisting of:
a) at least one olefinic resin composition comprising, consisting essentially of, or consisting of:
   a.1) at least one olefinic component consisting of:
      a.1.1) at least one cyclic olefin selected from the group consisting of Formulae (I), (II), and (III), as defined herein; and
      a.1.2) optionally, at least one linear olefin of Formula (IV), as defined herein; and
   a.2) at least one metal carbene olefin metathesis catalyst; and
   a.3) optionally, at least one thermoplastic hydrocarbon resin;
b) optionally at least one inorganic filler;
c) at least on adhesion promoter; and
d) optionally, at least one coating additive.

The invention also relates to a ROMP polymer or a ROMP polymer composite comprising, consisting essentially of, or consisting of a reaction product of the coating composition of the invention.

The invention also relates to the use of the ROMP polymer and/or the ROMP polymer composite for coating or encasing an object.

The invention also relates to the use of the ROMP polymer or ROMP polymer composite to coat or encase an object from a surrounding environment.

The invention also relates to the ROMP polymer or ROMP polymer composite of the invention for use as coating and/or encasing materials.

The invention also relates to a process for providing a ROMP polymer coating for offshore applications, the process comprising, providing an object surface to be coated, providing the coating composition of the invention, contacting the object surface with the coating composition or applying the coating composition to the object surface, and subjecting the coating composition to conditions effective to polymerize the coating composition to form the ROMP polymer coating.

The invention also relates to a coating or encasing material comprising, consisting essentially of, or consisting of the coating composition, ROMP polymer, or ROMP polymer composite of the invention.

The invention also relates to a coating or encasing material for use in coating or encasing (1) an object; (2) at least a portion of an object; and/or (3) at least a portion of at least one surface of an object, wherein the coating or encasing material comprises the coating composition, ROMP polymer, or ROMP polymer composite of the invention.

The invention also relates to the use of a coating or encasing material for coating or encasing (1) an object; (2) at least a portion of an object; and/or (3) at least a portion of at least one surface of an object, wherein the coating or encasing material comprises the coating composition, ROMP polymer, or ROMP polymer composite of the invention.

The invention also relates to a method of coating or encasing an object from a surrounding fluid, the method comprising interposing a coating or encasing material between the object and the fluid where the coating or encasing material comprises the ROMP polymer or ROMP polymer composite of the invention.

The invention also relates to a method for coating or encasing (1) an object; (2) at least a portion of an object; and/or (3) at least a portion of at least one surface of an object, with a coating or encasing material, wherein the coating or encasing material is the ROMP polymer or ROMP polymer composite of the invention.

The invention also relates to a method for coating or encasing (1) an object; (2) at least a portion of an object; and/or (3) at least a portion of at least one surface of an object, with a coating or encasing material, comprising: contacting the coating composition of the invention with, or applying the coating composition of the invention to, (1) the object; (2) at least a portion of the object; and/or (3) at least a portion of at least one surface of the object; and subjecting the coating composition to conditions effective to promote a ROMP reaction of the coating composition to form the ROMP polymer or ROMP polymer composite of the invention, wherein the coating or encasing material is the ROMP polymer or ROMP polymer composite.

The invention also relates to a process for applying a coating or encasing material composition to an object, comprising: placing a mold around an object to define a cavity between an internal surface of the mold and the object; injecting a coating or encasing material composition in the cavity, wherein the coating or encasing material composition comprises the coating composition of the invention; and subjecting the coating or encasing material composition to conditions effective to promote a ROMP reaction of the coating composition to form the ROMP polymer or ROMP polymer composite of the invention.

The invention also relates to an object at least partially encased and/or coated by a coating or encasing material, where the coating or encasing material comprises the ROMP polymer or ROMP polymer composite of the invention.

The invention also relates to an article of manufacture comprising an object, wherein at least a portion of at least one surface of the object is coated with the ROMP polymer or ROMP polymer composite of the invention.

The invention also relates to an article of manufacture made by any of the methods described herein.

Embodiments herein are not meant to be construed in a limiting sense. Various modifications in form and detail of the embodiments of the invention, as well as other aspects and variations of the invention, will be apparent to the skilled artisan considering the following detailed description and examples.

### DETAILED DESCRIPTION OF THE INVENTION

### Terminology and Definitions

Unless otherwise indicated, the invention is not limited to specific reactants, substituents, catalysts, catalyst compositions, resin compositions, cyclic olefins, reaction conditions, or the like, as such may vary. It is also to be understood that the terminology used herein is for the purpose of describing particular embodiments only and is not to be interpreted as being limiting.

As used in the specification and the appended claims, the singular forms “a,” “an,” and “the” include plural referents unless the context clearly dictates otherwise. Thus, for example, reference to “a substituent” encompasses a single substituent as well as two or more substituents, and the like.

As used in the specification and the appended claims, the terms “for example,” “for instance,” “such as,” or “including” are meant to introduce examples that further clarify more general subject matter. Unless otherwise specified, these examples are provided only as an aid for understanding the invention, and are not meant to be limiting in any fashion.

In this specification and in the claims that follow, reference will be made to a number of terms, which shall be defined to have the following meanings:

The term “alkyl” as used herein refers to a linear, branched, or cyclic saturated hydrocarbon group typically although not necessarily containing 1 to about 24 carbon atoms, such as 1 to about 12 carbon atoms, such as methyl, ethyl, n-propyl, isopropyl, n-butyl, isobutyl, t-butyl, octyl, decyl, and the like, as well as cycloalkyl groups such as cyclopentyl, cyclohexyl, and the like. Generally, although again not necessarily, alkyl groups herein contain 1 to about 12 carbon atoms. The term “lower alkyl” refers to an alkyl group of 1 to 6 carbon atoms, and the specific term “cycloalkyl” refers to a cyclic alkyl group, typically having 4 to 8, such as 5 to 7, carbon atoms. The term “substituted alkyl” refers to alkyl substituted with one or more substituent groups, and the terms “heteroatom-containing alkyl” and “heteroalkyl” refer to alkyl in which at least one carbon atom is replaced with a heteroatom. If not otherwise indicated, the terms “alkyl” and “lower alkyl” include linear, branched, cyclic, unsubstituted, substituted, and/or heteroatom-containing alkyl and lower alkyl, respectively.

The term “alkylene” as used herein refers to a difunctional linear, branched, or cyclic alkyl group, where “alkyl” is as defined above.

The term “alkenyl” as used herein refers to a linear, branched, or cyclic hydrocarbon group of 2 to about 24 carbon atoms (e.g., 2 to about 12 carbon atoms) containing at least one double bond, such as ethenyl, n-propenyl, isopropenyl, n-butenyl, isobutenyl, octenyl, decenyl, tetradecenyl, hexadecenyl, eicosenyl, tetracosenyl, and the like. The term “lower alkenyl” refers to an alkenyl group of 2 to 6 carbon atoms, and the specific term “cycloalkenyl” refers to a cyclic alkenyl group, such as 5 to 8 carbon atoms. The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom. If not otherwise indicated, the terms “alkenyl” and “lower alkenyl” include linear, branched, cyclic, unsubstituted, substituted, and/or heteroatom-containing alkenyl and lower alkenyl, respectively.

The term “alkenylene” as used herein refers to a difunctional linear, branched, or cyclic alkenyl group, where “alkenyl” is as defined above.

The term “alkynyl” as used herein refers to a linear or branched hydrocarbon group of 2 to about 24 carbon atoms (e.g., 2 to about 12 carbon atoms) containing at least one triple bond, such as ethynyl, n-propynyl, and the like. The term “lower alkynyl” refers to an alkynyl group of 2 to 6 carbon atoms. The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom. If not otherwise indicated, the terms “alkynyl” and “lower alkynyl” include linear, branched, unsubstituted, substituted, and/or heteroatom-containing alkynyl and lower alkynyl, respectively.

The term “alkoxy” as used herein refers to an alkyl group bound through a single, terminal ether linkage; that is, an “alkoxy” group may be represented as —O-alkyl where alkyl is as defined above. A “lower alkoxy” group refers to an alkoxy group containing 1 to 6 carbon atoms. Analogously, “alkenyloxy” and “lower alkenyloxy” respectively refer to an alkenyl and lower alkenyl group bound through a single, terminal ether linkage, and “alkynyloxy” and “lower alkynyloxy” respectively refer to an alkynyl and lower alkynyl group bound through a single, terminal ether linkage.

The term “aryl” as used herein, and unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Aryl groups may contain 5 to 24 carbon atoms (e.g., 5 to 14 carbon atoms). Exemplary aryl groups contain one aromatic ring or two fused or linked aromatic rings, e.g., phenyl, naphthyl, biphenyl, diphenylether, diphenylamine, benzophenone, and the like. “Substituted aryl” refers to an aryl moiety substituted with one or more substituent groups, and the terms “heteroatom-containing aryl” and “heteroaryl” refer to aryl substituents in which at least one carbon atom is replaced with a heteroatom, as will be described in further detail infra.

The term “aryloxy” as used herein refers to an aryl group bound through a single, terminal ether linkage, wherein “aryl” is as defined above. An “aryloxy” group may be represented as —O-aryl where aryl is as defined above. Aryloxy groups may contain 5 to 24 carbon atoms (e.g., 5 to 14 carbon atoms). Examples of aryloxy groups include, without limitation, phenoxy, o-halo-phenoxy, m-halo-phenoxy, phalo-phenoxy, o-methoxy-phenoxy, m-methoxy-phenoxy, p-methoxy-phenoxy, 2,4dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Alkaryl and aralkyl groups may contain 6 to 24 carbon atoms (e.g., 6 to 16 carbon atoms). Alkaryl groups include, without limitation, p-methylphenyl, 2,4-dimethylphenyl, p-cyclohexylphenyl, 2,7dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4phenylcyclohexylmethyl, 4benzylcyclohexylmethyl, and the like. The terms “alkaryloxy” and “aralkyloxy” refer to substituents of the formula —OR wherein R is alkaryl or aralkyl, respectively, as just defined.

The term “acyl” refers to substituents having the formula —(CO)-alkyl, —(CO)-aryl, (CO)-aralkyl, —(CO)-alkaryl, —(CO)-alkenyl, or —(CO)-alkynyl, and the term “acyloxy” refers to substituents having the formula O(CO)-alkyl, O(CO)-aryl, —O(CO)-aralkyl, —O(CO)-alkaryl, —O(CO)-alkenyl, —O(CO)-alkynyl wherein “alkyl,” “aryl,” “aralkyl”, alkaryl, alkenyl, and alkynyl are as defined above.

The terms “cyclic” and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic, or polycyclic.

The terms “halo” and “halogen” are used in the conventional sense to refer to a chloro, bromo, fluoro, or iodo substituent.

“Hydrocarbyl” refers to univalent hydrocarbyl radicals containing 1 to about 30 carbon atoms, such as 1 to about 24 carbon atoms, such as 1 to about 12 carbon atoms, including linear, branched, cyclic, saturated, and unsaturated species, such as alkyl groups, alkenyl groups, alkynyl groups, aryl groups, and the like. The term “lower hydrocarbyl” intends a hydrocarbyl group of 1 to 6 carbon atoms, such as 1 to 4 carbon atoms, and the term “hydrocarbylene” refers to a divalent hydrocarbyl moiety containing 1 to about 30 carbon atoms, such as 1 to about 24 carbon atoms, such as 1 to about 12 carbon atoms, including linear, branched, cyclic, saturated, and unsaturated species. The term “lower hydrocarbylene” refers to a hydrocarbylene group of 1 to 6 carbon atoms. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom. Similarly, “substituted hydrocarbylene” refers to hydrocarbylene substituted with one or more substituent groups, and terms the “heteroatom-containing hydrocarbylene” and “heterohydrocarbylene” refer to hydrocarbylene in which at least one carbon atom is replaced with a heteroatom. Unless otherwise indicated, the term “hydrocarbyl” and “hydrocarbylene” are to be interpreted as including substituted and/or heteroatom-containing hydrocarbyl and heteroatom-containing hydrocarbylene moieties, respectively.

The term “heteroatom-containing” as in a “heteroatom-containing hydrocarbyl group” refers to a hydrocarbon molecule or a hydrocarbyl molecular fragment in which one or more carbon atoms is replaced with an atom other than carbon, e.g., nitrogen, oxygen, sulfur, phosphorus, or silicon, typically nitrogen, oxygen, or sulfur. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include without limitation alkoxyaryl, alkylsulfanyl-substituted alkyl, N-alkylated amino alkyl, and the like. Examples of heteroaryl substituents include without limitation pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups include without limitation pyrrolidino, morpholino, piperazino, piperidino, etc.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation: functional groups referred to herein as “Fn,” such as halo, hydroxyl, sulfhydryl, C₁-C₂₄ alkoxy, C₂-C₂₄ alkenyloxy, C₂-C₂₄ alkynyloxy, C₅-C₂₄ aryloxy, C₆-C₂₄ aralkyloxy, C₆-C₂₄ alkaryloxy, acyl (including C₂-C₂₄ alkylcarbonyl (—CO-alkyl) and C₆-C₂₄ arylcarbonyl (—CO-aryl)), acyloxy (—O-acyl, including C₂-C₂₄ alkylcarbonyloxy (—O—CO-alkyl) and C₆-C₂₄ arylcarbonyloxy (—O—CO-aryl)), C₂-C₂₄ alkoxycarbonyl (—(CO)—O-alkyl), C₆-C₂₄ aryloxycarbonyl (—(CO)—O-aryl), halocarbonyl (—CO)—X where X is halo), C₂-C₂₄ alkylcarbonato (—O—(CO)—O-alkyl), C₆-C₂₄ arylcarbonato (—O—(CO)—O-aryl), carboxy (—COOH), carboxylato (COO⁻), carbamoyl (—(CO)—NH₂), mono-(C₁-C₂₄ alkyl)-substituted carbamoyl ((CO)—NH(C₁-C₂₄ alkyl)), di-(C₁-C₂₄ alkyl)-substituted carbamoyl (—(CO)—N(C₁-C₂₄ alkyl)₂), mono-(C₁-C₂₄ haloalkyl)-substituted carbamoyl (—(CO)—NH(C₁-C₂₄ haloalkyl)), di-(C₁-C₂₄ haloalkyl)-substituted carbamoyl (—(CO)—N(C₁-C₂₄ haloalkyl)₂), mono-(C₅-C₂₄ aryl)-substituted carbamoyl ((CO)—NH-aryl), di-(C₅-C₂₄ aryl)-substituted carbamoyl (—(CO)—N(C₅-C₂₄ aryl)₂), di-N—(C₁-C₂₄ alkyl), N—(C₅-C₂₄ aryl)-substituted carbamoyl (—(CO)—N(C₁-C₂₄ alkyl) (C₅-C₂₄ aryl), thiocarbamoyl (—(CS)—NH₂), mono-(C₁-C₂₄ alkyl)-substituted thiocarbamoyl (—(CS)—NH(C₁-C₂₄ alkyl)), di-(C₁-C₂₄ alkyl)-substituted thiocarbamoyl (—(CS)—N(C₁-C₂₄ alkyl)₂), mono-(C₅-C₂₄ aryl)-substituted thiocarbamoyl (—(CS)—NH-aryl), di(C₅-C₂₄ aryl)-substituted thiocarbamoyl (—(CS)—N(C₅-C₂₄ aryl)₂), di-N—(C₁-C₂₄ alkyl), N—(C₅-C₂₄ aryl)-substituted thiocarbamoyl (—(CS)—N(C₁-C₂₄ alkyl) (C₅-C₂₄ aryl), carbamido (—NH—(CO)—NH₂), cyano (—C≡N), cyanato (—O—C≡N), thiocyanato (—S—C≡N), isocyanate (—N═C═O), thioisocyanate (—N═C═S), formyl (—(CO)—H), thioformyl ((CS)—H), amino (—NH₂), mono-(C₁-C₂₄ alkyl)-substituted amino (—NH(C₁-C₂₄ alkyl), di-(C₁-C₂₄ alkyl)-substituted amino (—N(C₁-C₂₄ alkyl)₂), mono-(C₅-C₂₄ aryl)-substituted amino (—NH(C₅-C₂₄ aryl), di-(C₅-C₂₄ aryl)-substituted amino (—N(C₅-C₂₄ aryl)₂), C₂-C₂₄ alkylamido (—NH—(CO)-alkyl), C₆-C₂₄ arylamido (—NH—(CO)-aryl), imino (—CR═NH where R includes without limitation hydrogen, C₁-C₂₄ alkyl, C₅-C₂₄ aryl, C₆-C₂₄ alkaryl, C₆-C₂₄ aralkyl, etc.), C₂-C₂₀ alkylimino (CR═N(alkyl), where R includes without limitation hydrogen, C₁C₂₄ alkyl, C₅-C₂₄ aryl, C₆-C₂₄ alkaryl, C₆-C₂₄ aralkyl, etc.), arylimino (—CR═N(aryl), where R includes without limitation hydrogen, C₁-C₂₀ alkyl, C₅-C₂₄ aryl, C₆-C₂₄ alkaryl, C₆-C₂₄ aralkyl, etc.), nitro (—NO₂), nitroso (NO), sulfo (—SO₂—OH), sulfonato (—SO₂—O⁻), C₁-C₂₄ alkylsulfanyl (—S-alkyl; also termed “alkylthio”), C₅-C₂₄ arylsulfanyl (—S-aryl; also termed “arylthio”), C₁-C₂₄ alkylsulfinyl (—(SO)-alkyl), C₅-C₂₄ arylsulfinyl (—(SO)-aryl), C₁-C₂₄ alkylsulfonyl (SO₂-alkyl), C₁-C₂₄ monoalkylaminosulfonyl (—SO₂—N(H) alkyl), C₁-C₂₄ dialkylaminosulfonyl (—SO₂—N(alkyl)₂), C₅-C₂₄ arylsulfonyl (—SO₂-aryl), boryl (—BH₂), borono (—B(OH)₂), boronato (—B(OR)₂ where R includes without limitation alkyl or other hydrocarbyl), phosphono (—P(O)(OH)₂), phosphonato (—P(O)(O⁻)₂), phosphinato (P(O)(O⁻)), phospho (—PO₂), and phosphino (—PH₂); and the hydrocarbyl moieties C₁-C₂₄ alkyl (e.g., C₁-C₁₂ alkyl, C₁-C₆ alkyl), C₂-C₂₄ alkenyl (e.g., C₂-C₁₂ alkenyl, C₂-C₆ alkenyl), C₂-C₂₄ alkynyl (e.g., C₂-C₁₂ alkynyl, C₂-C₆ alkynyl), C₅-C₂₄ aryl (e.g., C₅-C₁₄ aryl), C₆-C₂₄ alkaryl (e.g., C₆-C₁₆ alkaryl), and C₆-C₂₄ aralkyl (e.g., C₆-C₁₆ aralkyl).

By “functionalized” as in “functionalized hydrocarbyl,” “functionalized alkyl,” “functionalized olefin,” “functionalized cyclic olefin,” and the like, is meant that in the hydrocarbyl, alkyl, olefin, cyclic olefin, or other moiety, at least one hydrogen atom bound to a carbon (or other) atom is replaced with one or more functional groups such as those described hereinabove. The term “functional group” is meant to include any functional species that is suitable for the uses described herein. In particular, as used herein, a functional group would necessarily possess the ability to react with or bond to corresponding functional groups on a substrate surface.

In addition, the aforementioned functional groups may, if a particular group permits, be further substituted with one or more additional functional groups or with one or more hydrocarbyl moieties such as those specifically mentioned above. Analogously, the above-mentioned hydrocarbyl moieties may be further substituted with one or more functional groups or additional hydrocarbyl moieties as noted above.

“Optional” or “optionally” means that the subsequently described circumstance may or may not occur, so that the description includes instances where the circumstance occurs and instances where it does not. For example, the phrase “optionally substituted” means that a nonhydrogen substituent may or may not be present on a given atom, and, thus, the description includes structures wherein a non-hydrogen substituent is present and structures wherein a nonhydrogen substituent is not present.

The term “substrate material” as used herein, is intended to generally mean any material that the coating composition of the invention may be contacted with, applied to, or have the substrate material incorporated into the coating composition. Without limitation, such materials include reinforcing materials, such as filaments, fibers, rovings, mats, weaves, fabrics, knitted material, cloth or other known structures, glass fibers and fabrics, carbon fibers and fabrics, aramid fibers and fabrics, and polyolefin or other polymer fibers or fabrics. Other suitable substrate materials include metallic density modulators, microparticulate density modulators, such as microspheres, glass microspheres, ceramic microspheres, microballons, cenospheres, and macroparticulate density modulators, such as glass or ceramic beads. A ROMP polymer composite may be comprised of one substrate material or a mixture of different substrate materials.

The term “polymer backbone” is intended to mean the chains of atoms in a polymer that comprise the main chain and any crosslinks, if it is a crosslinked polymer.

The term “field joint” as used herein, is intended to generally mean a connection between adjoining members or parts, made at the time of installation (i.e., in the field). The term “field joint” is a term of art often used to describe the welded ends of individual lengths of pipe. For example, pipelines used to transport oil and/or gas is most often formed from many individual pieces of pipe, for example steel pipe. During the manufacturing of individual pieces of pipe, an anti-corrosion coating is often applied to the exterior surface of the pipe in such a manner that the exterior surface of the pipe ends remains uncoated. Furthermore, the pipe may be subsequently coated or encased with a material; however, the exterior surface of the pipe ends still remains uncoated. The pipeline is formed by connecting the individual pieces of pipe by welding together the uncoated pipe ends. At least part of this welding process may take place at an onshore facility prior to loading the pipe on a lay barge or reel ship, with the remainder of the connections made offshore prior to the pipeline being deployed in offshore use. In the alternative, during the manufacturing of individual pieces of pipe, an anti-corrosion coating may be applied to the exterior surface of the pipe in such a manner that the exterior surface of the pipe ends are also coated. In this instance, the anti-corrosion coating must be removed from the pipe ends prior to welding.

As is known in the art, weight percent (wt. %) can be represented by gas chromatography (GC) percent area (area %). Hence, GC area % obtained from the GC was reported as wt. %. Weight percent (wt. %) and percent by weight are used interchangeably herein. Mol percent (mol %) was calculated from the weight percent (wt. %) as is known in the art.

### Olefinic Resin Composition

The coating compositions of the invention contain an olefinic resin composition. The olefinic resin composition may be present in the coating composition in an amount ranging from about 5-99.99 wt. % (e.g., 10-99.98 wt. %, 15-99.89 wt. %, 20-99.88 wt. %, 25-99 wt. %, 30-95 wt. %, 35-90 wt. %, 40-85 wt. %, 45-80 wt. %, 50-75 wt. %, 55-70 wt. %, 60-65 wt. %), based on the total weight of the coating composition.

The olefinic resin composition comprises, consists essentially of, or consists of at least one olefinic component, at least one metal carbene olefin metathesis catalyst, and, optionally, at least one thermoplastic hydrocarbon resin.

### Olefinic Component

The olefinic component that may be used in the olefinic resin composition disclosed herein consists of about 80-100 wt. % (85 to 99.9 wt. %, 90 to 99 wt. %, 91 to 98 wt. %, 92 to 97 wt. %, 93 to 96 wt. %, 94 to 95 wt. %), based on the total weight of the olefinic component, of at least one cyclic olefin selected from the group consisting of Formulae (I), (II), and (III); and 0-20 wt. % (0.1 to 15 wt. %, 1 to 10 wt. %, 2 to 9 wt. %, 3 to 8 wt. %, 4 to 7 wt. %, 5 to 6 wt. %), based on the total weight of the olefinic component, of at least one linear olefin of Formula (IV), wherein the wt. % of the cyclic olefins of Formulae (I), (II), and (III), and the linear olefin of Formula (IV) add to 100 wt. % of the olefinic component.

In general, any cyclic olefin suitable for the reactions disclosed herein may be used, in the present invention. Such cyclic olefins may be optionally substituted, optionally heteroatom-containing, mono-unsaturated, di-unsaturated, or poly-unsaturated C₅ to C₂₄ hydrocarbons, that may be mono-, di-, or polycyclic. When the cyclic olefin comprises more than one ring, the rings may or may not be fused.

The cyclic olefin may generally be any strained or unstrained cyclic olefin, provided the cyclic olefin is able to participate in a polymerization reaction either individually or as part of a cyclic olefin composition.

The cyclic olefin of Formula (I) has the following structure:

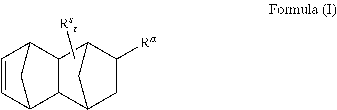

wherein:
   R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, —C(R^{h})(Rⁱ)C(O)NR^{o}ORⁿ, or

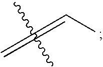

each R⁵ is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
t is 0, 1, 2, 3, 4, 5, or 6;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)-(optionally substituted C₅₋₂₄ aryl), —C(O)-(optionally substituted linear or branched C₂₋₂₄ alkenyl), or optionally substituted C₃₋₁₂ cycloalkenyl;
R^{h}, Rⁱ, R^{j}, R^{l}, R^{m}, Rⁿ, R^{o}, and R^{p} are, independently of one another, H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl; and
R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl.

The cyclic olefin may also be represented by Formula (I) wherein:
R^{a} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), an optionally substituted spiro heterocycle, optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
each R⁵ is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR^{l}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
t is 0, 1, 2, 3, or 4;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)-(optionally substituted C₆₋₁₀ aryl), —C(O)-(optionally substituted linear or branched C₂₋₁₂ alkenyl), or optionally substituted C₅₋₁₂ cycloalkenyl;
R^{h}, Rⁱ, R^{j}, R^{l}, R^{m}, Rⁿ, R^{o}, and R^{p} are, independently of one another, H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl.

The cyclic olefin may also be represented by Formula (I) wherein:
R^{a} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, or —CH₂-(optionally substituted C₅₋₇ cycloalkenyl);
t is 0;
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₁₂ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl.

Depending on the position of R^{s} on the tetracyclododeca-3-ene moiety, the cyclic olefin of Formula (I), can be of structure

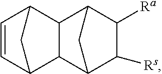

wherein: t is 1, R^{a} and R^{s} are as defined herein; and R^{a} and R^{s} can form an optionally substituted polycyclic ring with the rest of the molecule.

The cyclic olefin may also be represented by Formula (I) wherein: R^{a} is

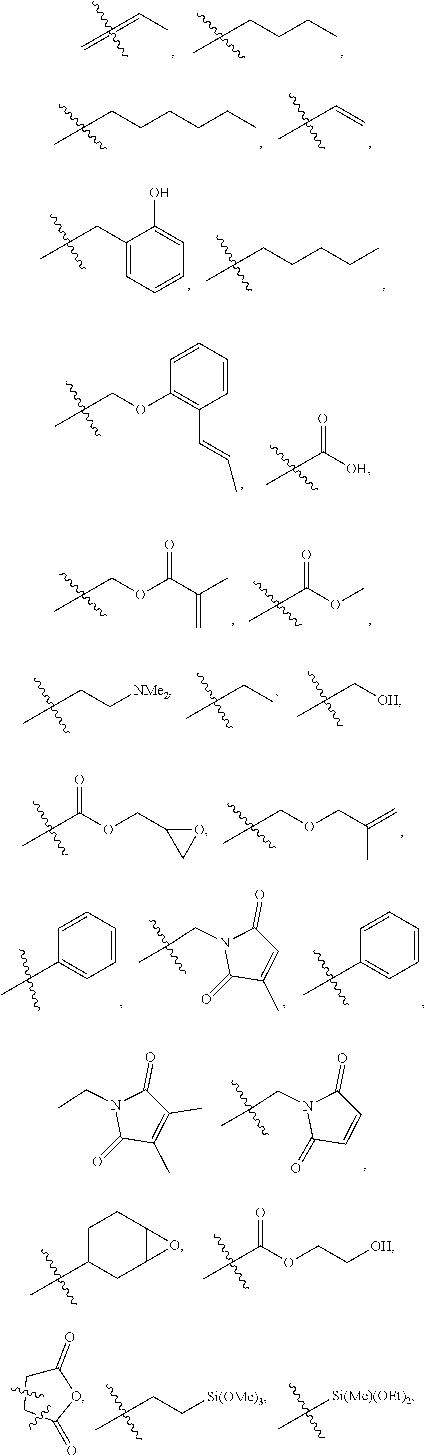

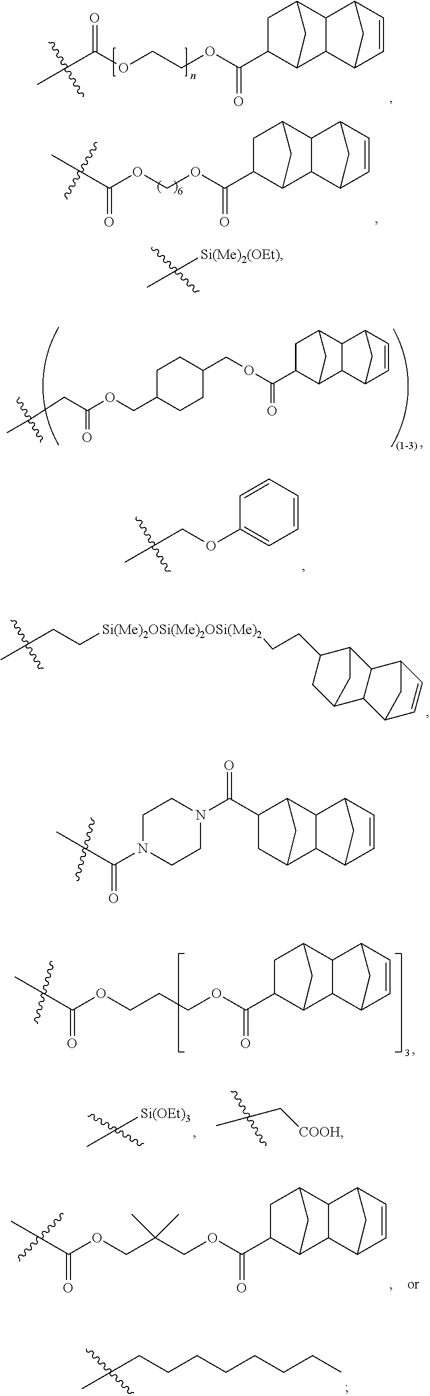

and t=0.

Non-limiting examples of monomers of Formula (I) can be represented by:

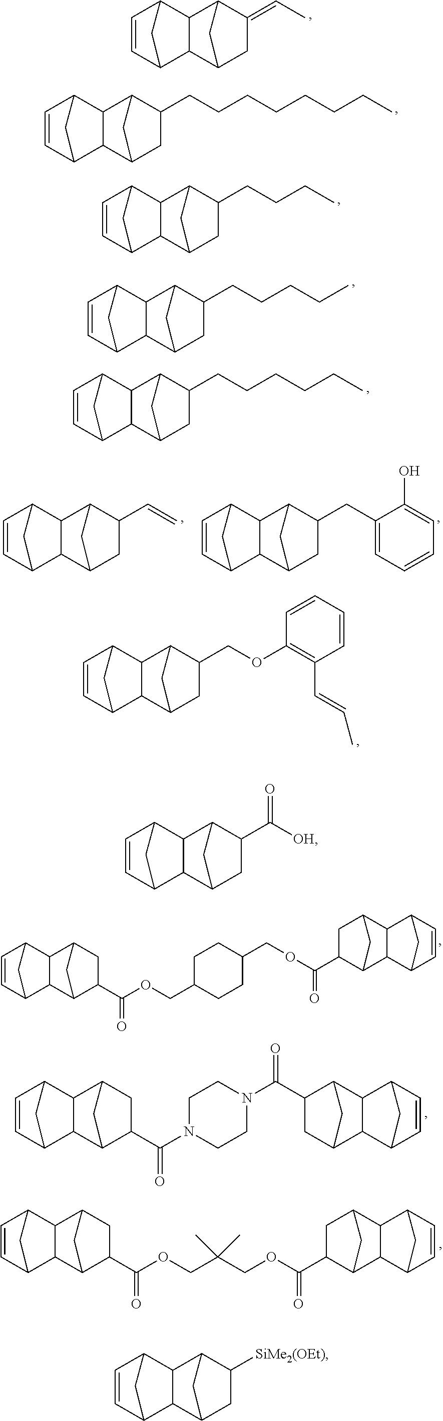

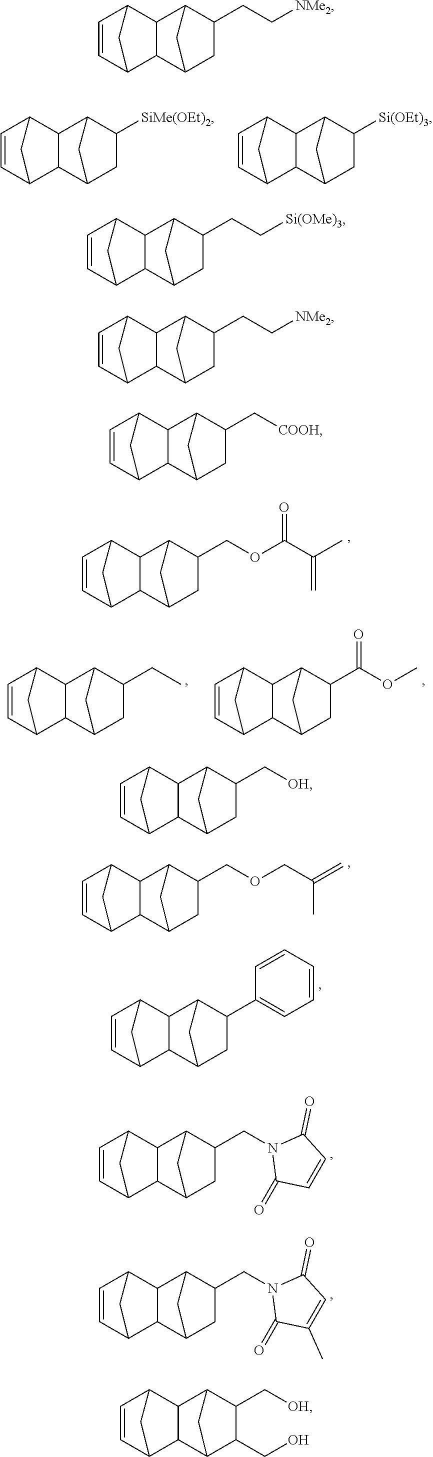

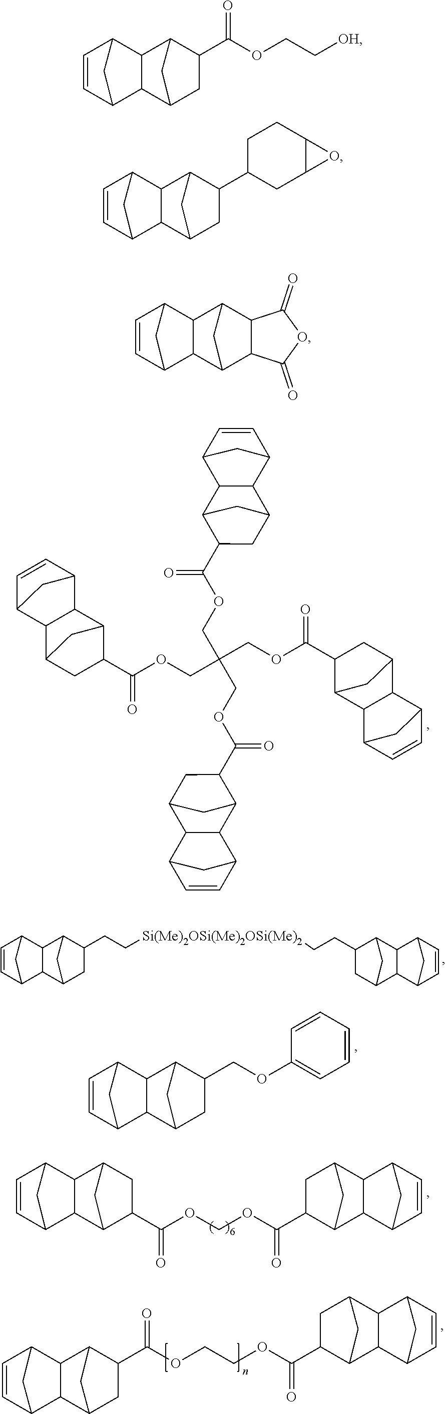

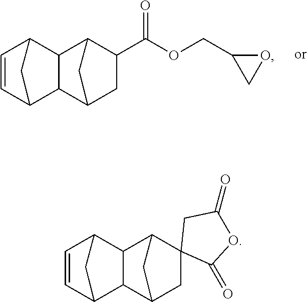 [SMILES: O=C(OCC1CO1)C1CC2CC1C1C3C=CC(C3)C21 ; "or" ; O=C1CC2(CC3CC2C2C4C=CC(C4)C32)C(=O)O1]

The cyclic olefin of Formula (II) has the following structure:

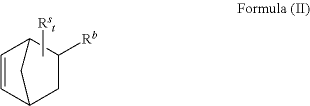

wherein:
   R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —Si(OR^{k})₃, —S(O)₂OR^{h}, —OS(O)₂R^{h}, optionally substituted heterocycle, an optionally substituted spiro heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
   each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
   t is 0, 1, 2, 3, 4, 5, or 6;
   R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
   R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)-(optionally substituted C₅₋₂₄ aryl), —C(O)-(optionally substituted linear or branched C₂₋₂₄ alkenyl), or optionally substituted C₃₋₁₂ cycloalkenyl;
   R^{h}, Rⁱ, R^{j}, R^{l}, R^{m}, Rⁿ, R^{o}, and R^{p} are, independently of one another, H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl; and
   R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl.

The cyclic olefin may also be represented by the structure of Formula (II) wherein:
R^{b} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
each R^{s} is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
t is 0, 1, 2, 3, or 4;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)-(optionally substituted C₆₋₁₀ aryl), —C(O)-(optionally substituted linear or branched C₂₋₁₂ alkenyl), or optionally substituted C₅₋₁₂ cycloalkenyl;
R^{h}, Rⁱ, R^{j}, R^{l}, R^{m}, Rⁿ, R^{o}, and R^{p} are, independently of one another, H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl.

The cyclic olefin may also be represented by Formula (II) wherein:
R^{b} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, an optionally substituted spiro heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, or —CH₂-(optionally substituted C₅₋₁₂ cycloalkenyl);
t is 0;
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₁₂ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl.

Depending on the position of R^{s} on the 2-norbornene moiety, the cyclic olefin of structure Formula (II), can be represented by

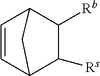

wherein: t=1, R^{s} and R^{b} are as defined herein; and R^{s} and R^{b} can form together an optionally substituted polycyclic structure with the rest of the molecule.

The cyclic olefin may also be represented by Formula (II) wherein:
R^{b} is

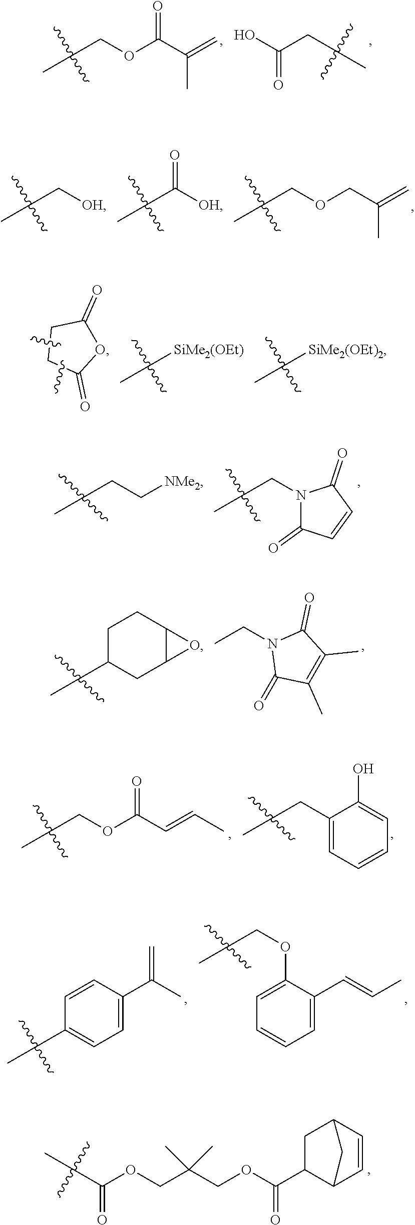

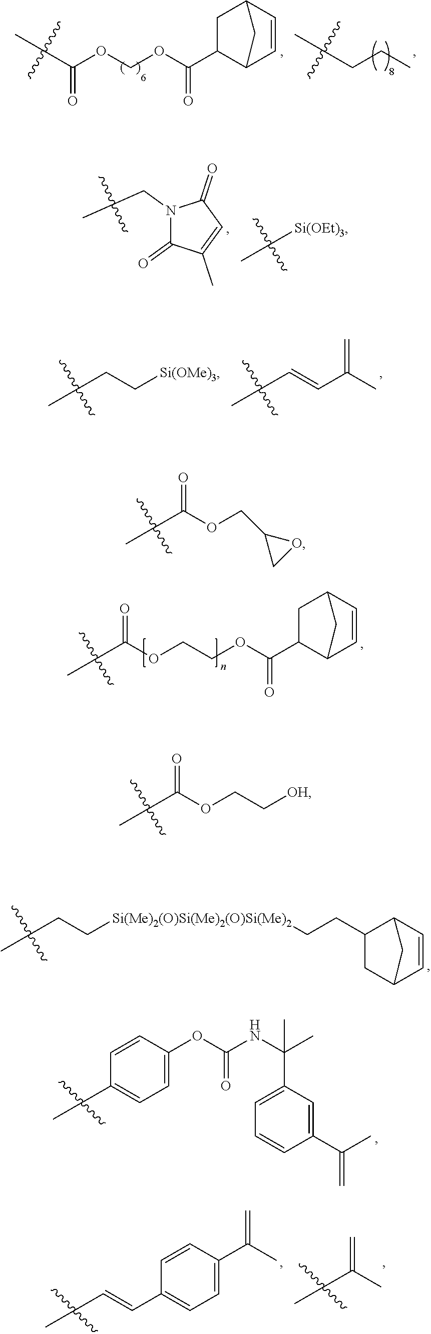

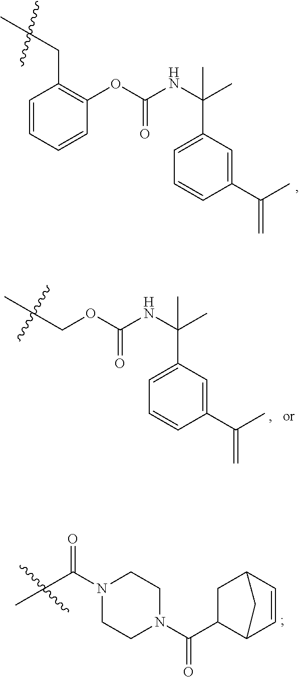 [SMILES: *Cc1ccccc1OC(=O)NC(C)(C)c1cccc(C(=C)C)c1 ; *COC(=O)NC(C)(C)c1cccc(C(=C)C)c1 ; *C(=O)N1CCN(C(=O)C2CC3C=CC2C3)CC1]

and t=0.

Non-limiting examples of monomers of Formula (II) can be represented by

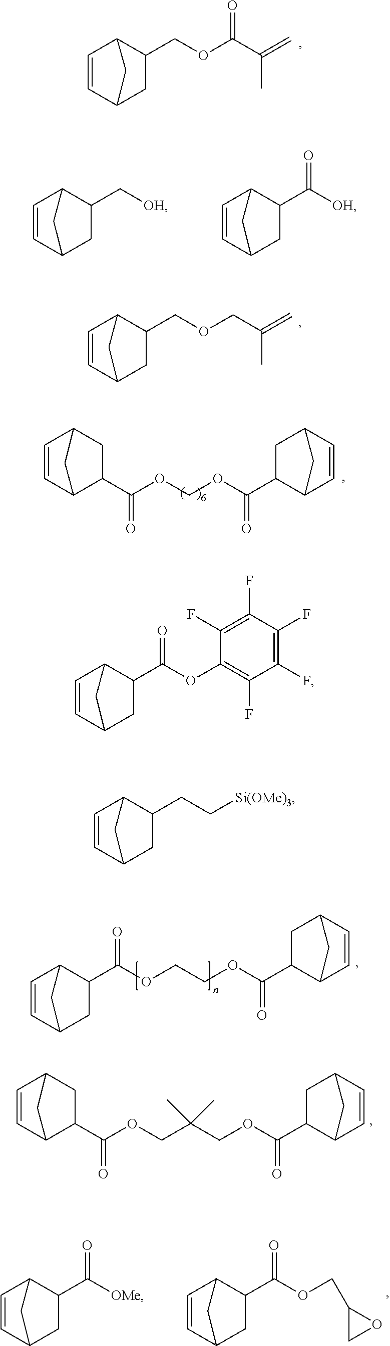

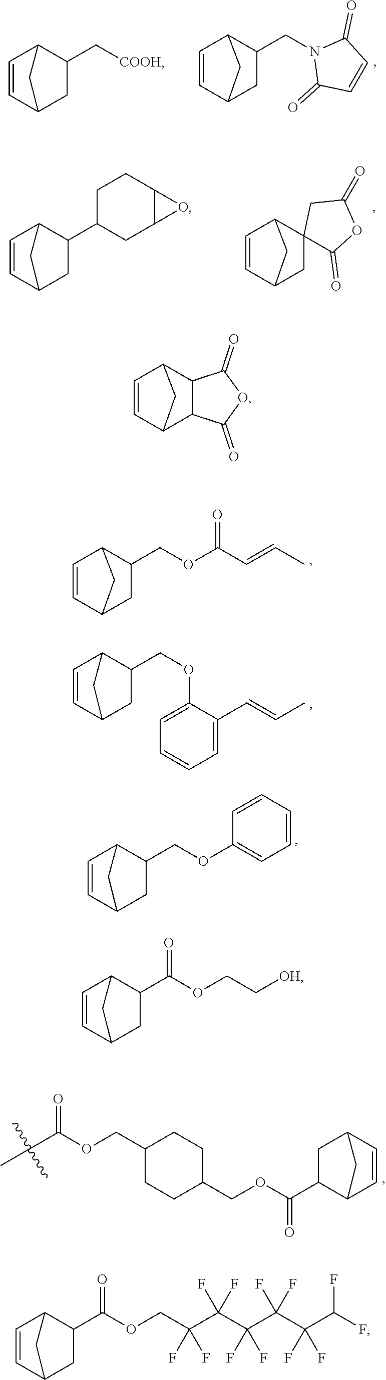

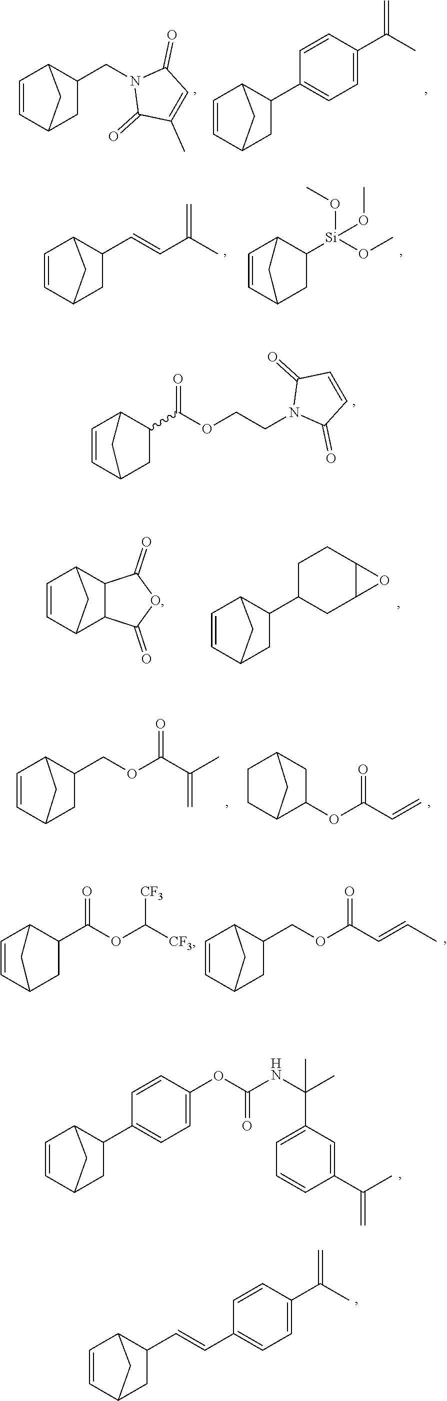

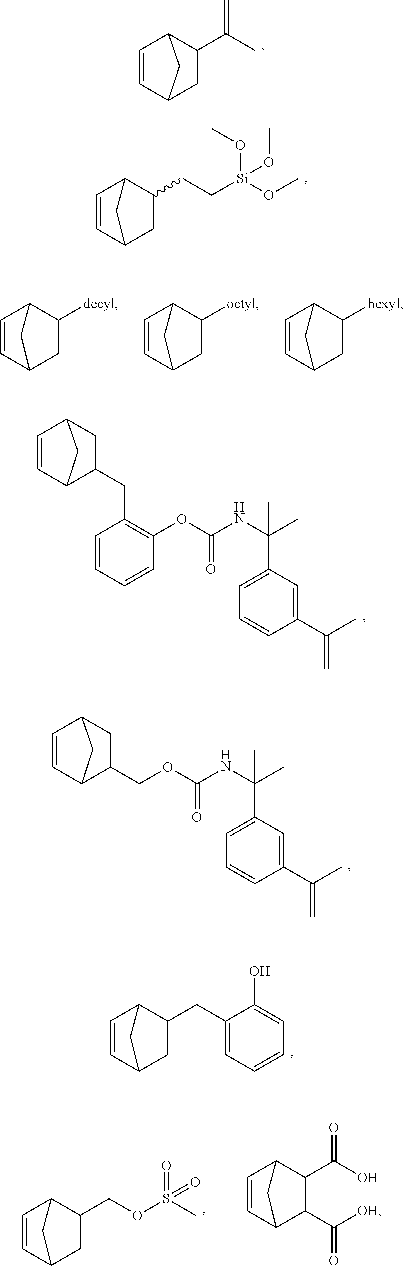

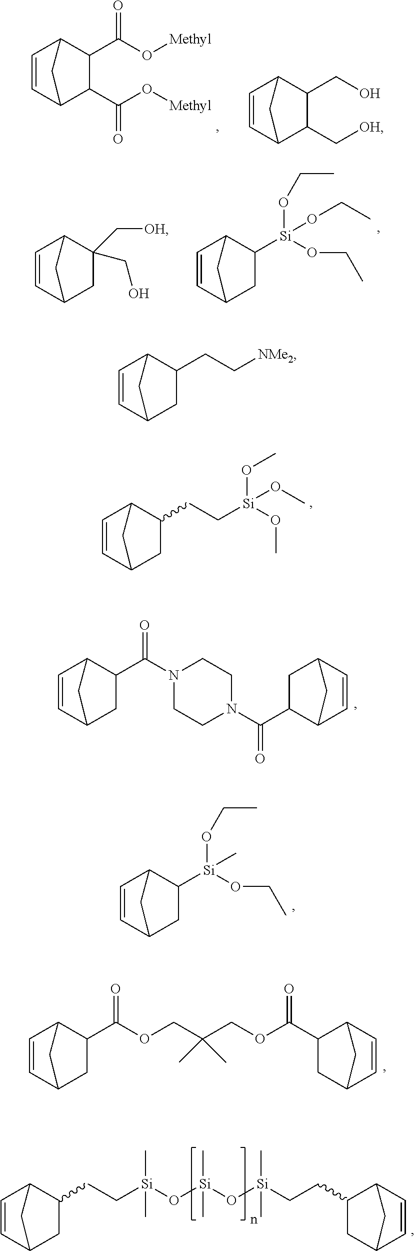

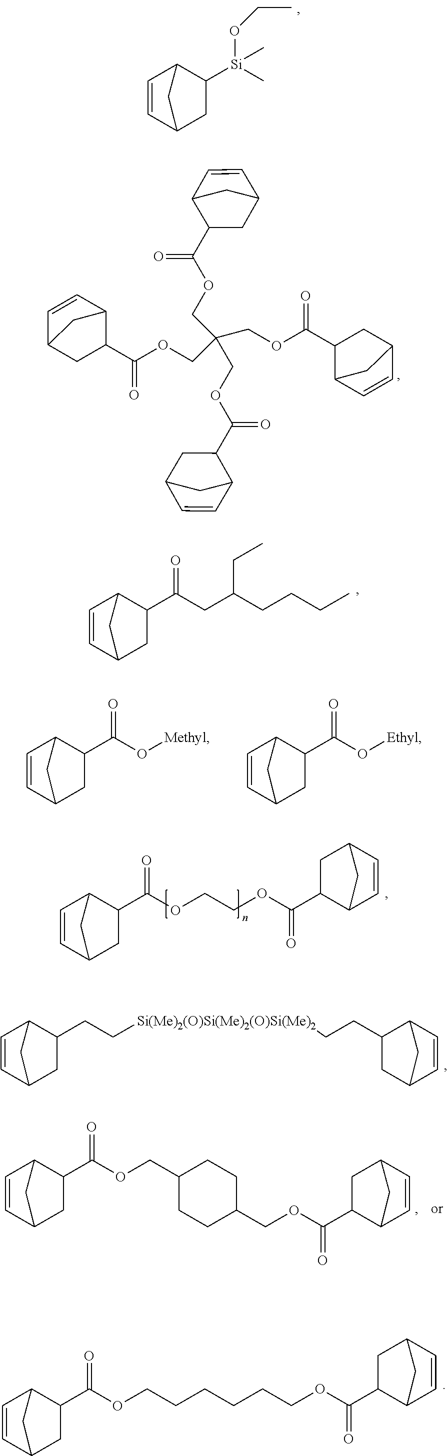

The cyclic olefin of Formula (III) has the following structure:

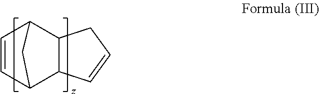

wherein z is 0, 1, 2, or 3.

The cyclic olefin may also be represented by the structure of Formula (III), wherein z is 1 or 2.

The cyclic olefin may also be represented by the structure of Formula (III), wherein z is 2.

Non-limiting examples of monomers of Formula (III) can be represented by

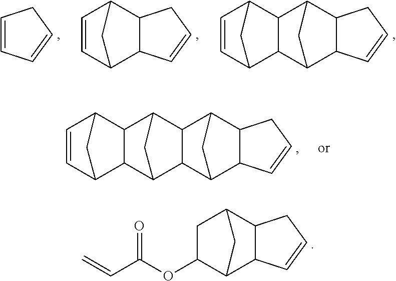

Examples of cyclic olefins of Formulae (I), (II), and (III) thus include, without limitation, dicyclopentadiene; tricyclopentadiene, tetracyclopentadiene; norbornene; 5-isobutyl-2-norbornene; 5,6-dimethyl-2-norbornene; 5-phenyl-2-norbornene; 5-benzyl-2-norbornene; 5-acetyl-2-norbornene; 5-methoxycarbonyl-2-norbornene; 5-ethoxycarbonyl-2-norbornene; 5-methyl-5-methoxycarbonyl-2-norbornene; 5-cyano-2-norbornene; 5,5,6-trimethyl-2-norbornene; endo,exo-5,6-dimethoxy-2-norbornene; endo,endo-5,6-dimethoxy-2-norbornene; endo,exo-5-6-dimethoxycarbonyl-2-norbornene; endo, endo-5,6-dimethoxycarbonyl-2-norbornene; norbornadiene; tricycloundecene; tetracyclododecene; 8-methoxycarbonyl-tetracyclododecene; 8-cyanotetracyclododecene; C₁-C₁₂ hydrocarbyl substituted norbornenes such as 5-methyl-2-norbornene; 5-ethyl-2-norbornene; 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like; C₂-C₁₂ hydrocarbyl substituted tetracyclododecenes such as 8-methyl-tetracyclododeca-3-ene; 8-ethyl-tetracyclododeca-3-ene; 8-butyl-tetracyclododeca-3-ene; 8-hexyl-tetracyclododeca-3-ene; 8-octyl-2-tetracyclododeca-3-ene; 8-decyl-2-tetracyclododeca-3-ene; 8-dodecyl-2-tetracyclododeca-3-ene; 8-vinyl-tetracyclododeca-3-ene; 8-ethylidene-2-tetracyclododeca-3-ene; 8-isopropenyl-tetracyclododeca-3-ene; 5-propenyl-tetracyclododeca-3-ene; and 5-butenyl-tetracyclododeca-3-ene.

It is well understood by one of skill in the art that bicyclic and polycyclic olefins as disclosed herein may consist of a variety of structural isomers and/or stereoisomers, any and all of which are suitable for use in the present invention. Any reference herein to such bicyclic and polycyclic olefins unless specifically stated, includes mixtures of any and all such structural isomers and/or stereoisomers.

The linear olefins used in the invention, may be optionally substituted, optionally heteroatom-containing, mono-unsaturated, or multi-unsaturated.

The linear olefin of Formula (IV) has the following structure in which R^{c} and R^{d} may be in a cis or trans configuration:

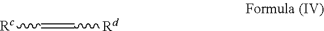

wherein:
   R^{c} and R^{d} are, independently of one another, H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
   R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
   R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)-(optionally substituted C₅₋₂₄ aryl), —C(O)-(optionally substituted linear or branched C₂₋₂₄ alkenyl), or optionally substituted C₃₋₁₂cycloalkenyl;
   R^{h}, Rⁱ, R^{j}, R^{l}, R^{m}, Rⁿ, R^{o}, and R^{p} are, independently of one another, H, optionally substituted linear or branched C₁₋₂₄ alkyl, optionally substituted C₃₋₁₀ cycloalkyl, optionally substituted heterocycle, optionally substituted C₅₋₂₄ aryl or optionally substituted C₃₋₁₂ cycloalkenyl; and
   R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl.

The linear olefins may also be represented by the structure of Formula (IV) wherein:
R^{c} and R^{d} are, independently of one another, H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, —CH₂-(optionally substituted C₅₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)-(optionally substituted C₆₋₁₀ aryl), —C(O)-(optionally substituted linear or branched C₂₋₁₂ alkenyl), or optionally substituted C₅₋₁₂ cycloalkenyl;
R^{h}, Rⁱ, R^{j}, R^{l}, R^{m}, Rⁿ, R^{o}, and R^{p} are, independently of one another, H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₁₂ cycloalkenyl.

The linear olefins may also be represented by Formula (IV) wherein:
R^{c} and R^{d} are, independently of one another, H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₁₂ cycloalkenyl, or —CH₂-(optionally substituted C₅₋₁₂ cycloalkenyl);
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl;
R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl; and
R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₁₂ cycloalkenyl.

The linear olefins may also be represented by Formula (IV) wherein:
R^{c} is H,

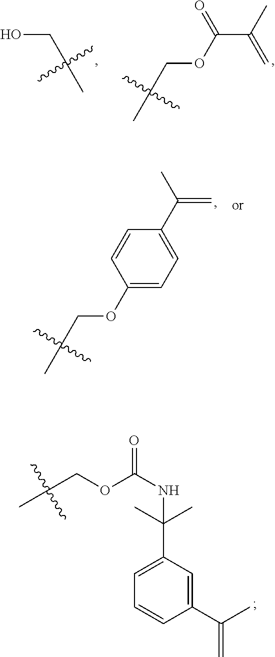

and R^{d} is

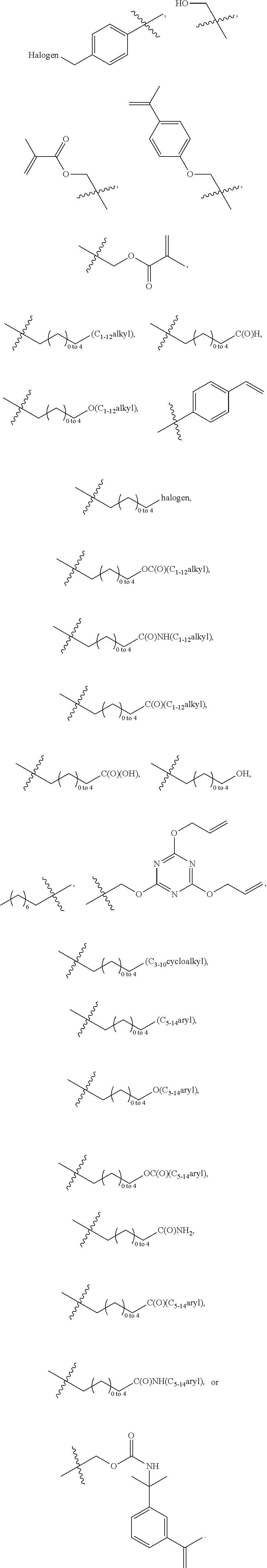

Non-limiting examples of Formula (IV) can be represented by

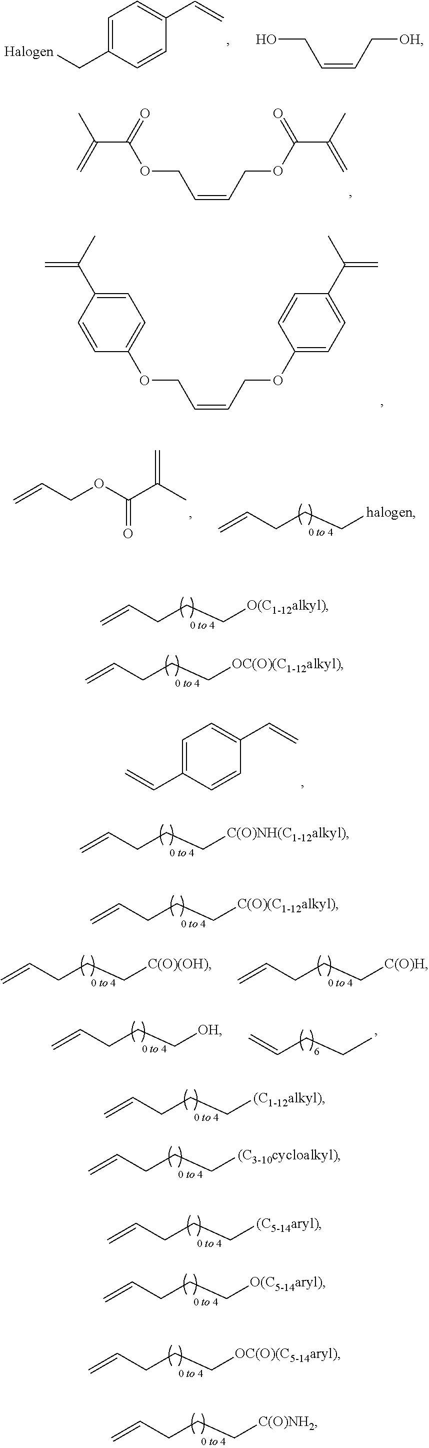

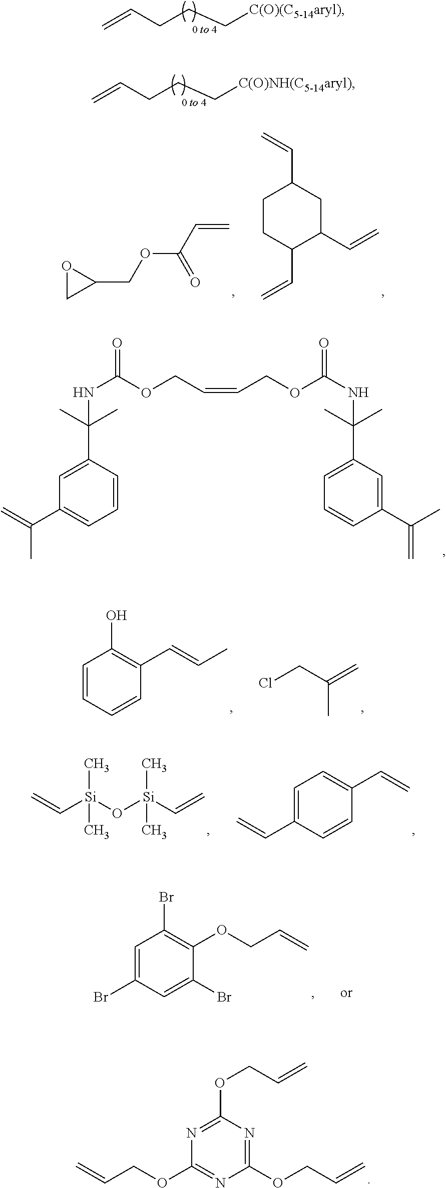

The olefinic component of the coating composition of the invention may comprise, consist essentially or, or consist of at least one cyclic olefin represented selected from the group consisting of Formulae (I) and (II); at least one cyclic olefin selected from the group consisting of Formulae (I) and (III), or at least one cyclic olefin selected from the group consisting of Formulae (II) and (III). A coating composition of the invention may contain only cyclic olefins of Formula (I), (II), and (III) or mixtures thereof, or as just mentioned, may contain at least one particular cyclic olefin selected from one of Formula (I), (II), and (III), but not contain a linear olefin of Formula (IV). A coating composition of the invention may contain at least one cyclic olefin selected from the group consisting of Formulae (III) (e.g., dicyclopentadiene (DCPD), tricyclopentadiene (TCPD), and mixtures thereof). A coating composition of the invention may contain dicyclopentadiene (DCPD) and tricyclopentadiene (TCPD). The DCPD and TCPD may be present in a ratio of 3:7 to 2:3 DCPD wt. %:TCPD wt. %.

In a coating composition of the invention, the olefinic component may comprise, consist essentially or, or consist of:
0 to 100% (0.1 to 99.9%, 0.5 to 99.8%, 1 to 99.7%, 5 to 99%, 10 to 95%, 15 to 90%, 20 to 85%, 25 to 80%, 30 to 75%, 35 to 70%, 40 to 65%, 45 to 60%, 50 to 55%) of at least one cyclic olefin of Formula (I);
0 to 100% (0.1 to 99.9%, 0.5 to 99.8%, 1 to 99.7%, 5 to 99%, 10 to 95%, 15 to 90%, 20 to 85%, 25 to 80%, 30 to 75%, 35 to 70%, 40 to 65%, 45 to 60%, 50 to 55%) of at least one cyclic olefin of Formula (II);
0 to 100% (0.1 to 99.9%, 0.5 to 99.8%, 1 to 99.7%, 5 to 99%, 10 to 95%, 15 to 90%, 20 to 85%, 25 to 80%, 30 to 75%, 35 to 70%, 40 to 65%, 45 to 60%, 50 to 55%) of at least one cyclic olefin of Formula (III); and
0 to 20% (0.1 to 15%, 0.5 to 10%, 1 to 9%, 2 to 8%, 3 to 7%, 4 to 6%) of at least one linear olefin of Formula (IV),
wherein the amount of cyclic olefins of Formula (I), (II), and (III), and the linear olefin of Formula (IV) add to 100%.

The olefinic component may be present in the coating composition of the invention in an amount ranging from about 35-99.9 wt. % (e.g., 40-99 wt. %, 45-98 wt. %, 50-95 wt. %, 55-90 wt. %, 60-85 wt. %, 65-80 wt. %, 70-75 wt. %), based on the total weight of the coating composition.

### Metal Carbene Olefin Metathesis Catalyst

A metal carbene olefin metathesis catalyst that may be used in the olefinic resin composition disclosed herein is a Group 8 transition metal complex having the structure of formula (I)

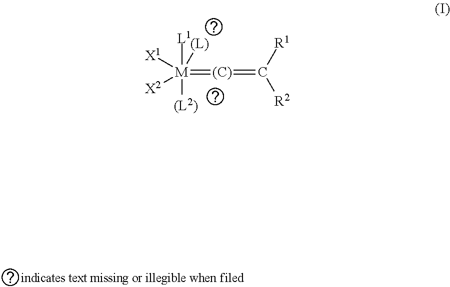

wherein:
   M is a Group 8 transition metal;
   L¹, L², and L³ are neutral electron donor ligands;
   n is 0 or 1, such that L³ may or may not be present;
   m is 0, 1, or 2;
   k is 0 or 1;
   X¹ and X² are anionic ligands; and
   R¹ and R² are independently selected from hydrogen, hydrocarbyl, substituted hydrocarbyl, heteroatom-containing hydrocarbyl, substituted heteroatom-containing hydrocarbyl, and functional groups,
   wherein any two or more of X¹, X², L¹, L², L³, R¹, and R² can be taken together to form one or more cyclic groups, and further wherein any one or more of X¹, X², L¹, L², L³, R¹, and R² may be attached to a support.

Additionally, in formula (I), one or both of R¹ and R² may have the structure —(W)ₙ—U⁺V⁻, wherein W is selected from hydrocarbylene, substituted hydrocarbylene, heteroatom-containing hydrocarbylene, or substituted heteroatom-containing hydrocarbylene; U is a positively charged Group 15 or Group 16 element substituted with hydrogen, hydrocarbyl, substituted hydrocarbyl, heteroatom-containing hydrocarbyl, or substituted heteroatom-containing hydrocarbyl; V is a negatively charged counterion; and n is 0 or 1. Furthermore, R¹ and R² may be taken together to form an indenylidene moiety.

Catalysts may contain Ru or Os as the Group 8 transition metal, with Ru preferred.

Numerous embodiments of the catalysts useful in the reactions disclosed herein are described in more detail infra. For the sake of convenience, the catalysts are described in groups, but it should be emphasized that these groups are not meant to be limiting in any way. That is, any of the catalysts useful in the invention may fit the description of more than one of the groups described herein.

A first group of catalysts, then, are commonly referred to as First Generation Grubbs-type catalysts, and have the structure of formula (I). For the first group of catalysts, M is a Group 8 transition metal, m is 0, 1, or 2, and n, X¹, X², L¹, L², L³, R¹, and R² are described as follows.

For the first group of catalysts, n is 0, and L¹ and L² are independently selected from phosphine, sulfonated phosphine, phosphite, phosphinite, phosphonite, arsine, stibine, ether, (including cyclic ethers), amine, amide, imine, sulfoxide, carboxyl, nitrosyl, pyridine, substituted pyridine, imidazole, substituted imidazole, pyrazine, substituted pyrazine and thioether. Exemplary ligands are trisubstituted phosphines. Trisubstituted phosphines may be of the formula PR^{H1}R^{H2}R^{H3}, where R^{H1}, R^{H2}, and R^{H3} are each independently substituted or unsubstituted aryl or C₁-C₁₀ alkyl, particularly primary alkyl, secondary alkyl, or cycloalkyl. L¹ and L² may be independently selected from the group consisting of trimethylphosphine (PMe₃), triethylphosphine (PEt₃), tri-n-butylphosphine (PBu₃), tri(ortho-tolyl)phosphine (P-o-tolyl₃), tri-tert-butylphosphine (P-tert-Bu₃), tricyclopentylphosphine (PCyclopentyl₃), tricyclohexylphosphine (PCy₃), triisopropylphosphine (P-i-Pr₃), trioctylphosphine (POct₃), triisobutylphosphine, (P-i-Bu₃), triphenylphosphine (PPh₃), tri(pentafluorophenyl)phosphine (P(C₆F₅)₃), methyldiphenylphosphine (PMePh₂), dimethylphenylphosphine (PMe₂Ph), and diethylphenylphosphine (PEt₂Ph). Alternatively, L¹ and L² may be independently selected from phosphabicycloalkane (e.g., monosubstituted 9-phosphabicyclo-[3.3.1]nonane, or monosubstituted 9-phosphabicyclo[4.2.1]nonane] such as cyclohexylphoban, isopropylphoban, ethylphoban, methylphoban, butylphoban, pentylphoban and the like).

X¹ and X² are anionic ligands, and may be the same or different, or are linked together to form a cyclic group, typically although not necessarily a five- to eight-membered ring. X¹ and X² may be each independently hydrogen, halide, or one of the following groups: C₁-C₂₀ alkyl, C₅-C₂₄ aryl, C₁-C₂₀ alkoxy, C₅-C₂₄ aryloxy, C₂-C₂₀ alkoxycarbonyl, C₆-C₂₄ aryloxycarbonyl, C₂-C₂₄ acyl, C₂-C₂₄ acyloxy, C₁-C₂₀ alkylsulfonato, C₅C₂₄ arylsulfonato, C₁-C₂₀ alkylsulfanyl, C₅-C₂₄ arylsulfanyl, C₁-C₂₀ alkylsulfinyl, NO₃, —N═C═O, —N═C═S, or C₅-C₂₄ arylsulfinyl. Optionally, X¹ and X² may be substituted with one or more moieties selected from C₁-C₁₂ alkyl, C₁-C₁₂ alkoxy, C₅-C₂₄ aryl, and halide, which may, in turn, with the exception of halide, be further substituted with one or more groups selected from halide, C₁-C₆ alkyl, C₁-C₆ alkoxy, and phenyl. X¹ and X² may be halide, benzoate, C₂-C₆ acyl, C₂-C₆ alkoxycarbonyl, C₁-C₆ alkyl, phenoxy, C₁-C₆ alkoxy, C₁-C₆ alkylsulfanyl, aryl, or C₁-C₆ alkylsulfonyl. X¹ and X² may each be halide, CF₃CO₂, CH₃CO₂, CFH₂CO₂, (CH₃)₃CO, (CF₃)₂(CH₃) CO, (CF₃)(CH₃)₂CO, PhO, MeO, EtO, tosylate, mesylate, or trifluoromethane-sulfonate. X¹ and X² may each be chloride.

R¹ and R² are independently selected from hydrogen, hydrocarbyl (e.g., C₁-C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), substituted hydrocarbyl (e.g., substituted C₁-C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), heteroatom-containing hydrocarbyl (e.g., heteroatom-containing C₁-C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), and substituted heteroatom-containing hydrocarbyl (e.g., substituted heteroatom-containing C₁C₂₀ alkyl, C₂-C₂₀ alkenyl, C₂-C₂₀ alkynyl, C₅-C₂₄ aryl, C₆-C₂₄ alkaryl, C₆-C₂₄ aralkyl, etc.), and functional groups. R¹ and R² may also be linked to form a cyclic group, which may be aliphatic or aromatic, and may contain substituents and/or heteroatoms. Generally, such a cyclic group will contain 4 to 12, such as 5, 6, 7, or 8 ring atoms.

In certain catalysts, R¹ is hydrogen and R² is selected from C₁-C₂₀ alkyl, C₂-C₂₀ alkenyl, and C₅-C₂₄ aryl, such as C₁-C₆ alkyl, C₂-C₆ alkenyl, and C₅-C₁₄ aryl. R² may be phenyl, vinyl, methyl, isopropyl, or t-butyl, optionally substituted with one or more moieties selected from C₁-C₆ alkyl, C₁-C₆ alkoxy, phenyl, and a functional group Fn as defined earlier herein. R² may be phenyl or vinyl substituted with one or more moieties selected from methyl, ethyl, chloro, bromo, iodo, fluoro, nitro, dimethylamino, methyl, methoxy, and phenyl. R² may be phenyl or —CH═C(CH₃)₂.

Any two or more (typically two, three, or four) of X¹, X², L¹, L², L³, R¹, and R² can be taken together to form a cyclic group, including bidentate or multidentate ligands, as disclosed, for example, in U.S. Pat. No. 5,312,940, the disclosure of which is incorporated herein by reference. When any of X¹, X², L¹, L², L³, R¹, and R² are linked to form cyclic groups, those cyclic groups may contain 4 to 12, such as 4, 5, 6, 7 or 8 atoms, or may comprise two or three of such rings, which may be either fused or linked. The cyclic groups may be aliphatic or aromatic, and may be heteroatom-containing and/or substituted. The cyclic group may, in some cases, form a bidentate ligand or a tridentate ligand. Examples of bidentate ligands include, but are not limited to, bisphosphines, dialkoxides, alkyldiketonates, and aryldiketonates.

A second group of catalysts, commonly referred to as Second Generation Grubbs-type catalysts, have the structure of formula (I), wherein L¹ is a carbene ligand having the structure of formula (II)

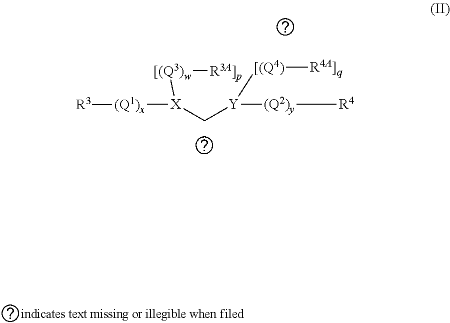

such that the complex may have the structure of formula (III)

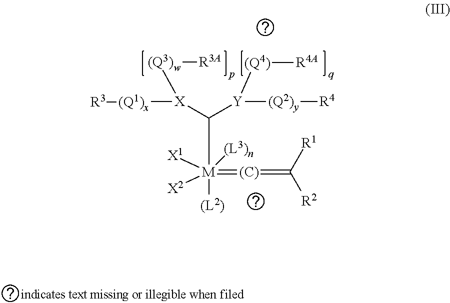

wherein M, m, n, X¹, X², L², L³, R¹, and R² are as defined for the first group of catalysts, and the remaining substituents are as follows:
   X and Y are heteroatoms typically selected from N, O, S, and P. Since O and S are divalent, p is necessarily 0 when X is O or S, q is necessarily 0 when Y is O or S, and k is 0 or 1. However, when X is N or P, then p is 1, and when Y is N or P, then q is 1. Both X and Y may be N;
   Q¹, Q², Q³, and Q⁴ are linkers, e.g., hydrocarbylene (including substituted hydrocarbylene, heteroatom-containing hydrocarbylene, and substituted heteroatom-containing hydrocarbylene, such as substituted and/or heteroatom-containing alkylene) or —(CO)—, and w, x, y, and z are independently 0 or 1, meaning that each linker is optional. w, x, y, and z may all be 0. Further, two or more substituents on adjacent atoms within Q¹, Q², Q³, and Q⁴ may be linked to form an additional cyclic group; and
   R³, R^{3A}, R⁴, and R^{4A} are independently selected from hydrogen, hydrocarbyl, substituted hydrocarbyl, heteroatom-containing hydrocarbyl, and substituted heteroatom-containing hydrocarbyl. In addition, X and Y may be independently selected from carbon and one of the heteroatoms mentioned above, no more than one of X or Y may be carbon. Also, L² and L³ may be taken together to form a single bindentate electron-donating heterocyclic ligand. Furthermore, R¹ and R² may be taken together to form an indenylidene moiety. Moreover, X¹, X², L², L³, X and Y may be further coordinated to boron or to a carboxylate.

In addition, any two or more of X¹, X², L¹, L², L³, R¹, R², R³, R^{3A}, R⁴, R^{4A}, Q¹, Q², Q³, and Q⁴ can be taken together to form a cyclic group, and any one or more of X¹, X², L², L³, Q¹, Q², Q³, Q⁴, R¹, R², R³, R^{3A}, R⁴, and R^{4A} may be attached to a support. Any two or more of X¹, X², L¹, L², L³, R¹, R², R³, R^{3A}, R⁴, and R^{4A} can also be taken to be -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group, or together to form a cyclic group, and any one or more of X¹, X², L², L³, Q¹, Q², Q³, Q⁴, R¹, R², R³, R^{3A}, R⁴, and R^{4A} may be attached to a support.

A particular class of carbene ligands having the structure of formula (II), where R^{3A} and R^{4A} are linked to form a cyclic group and at least one of X or Y is a nitrogen, or at least one of Q³ or Q⁴ is a heteroatom-containing hydrocarbylene or substituted heteroatom-containing hydrocarbylene, where at least one heteroatom is a nitrogen, are commonly referred to as N-heterocyclic carbene (NHC) ligands.

R^{3A} and R^{4A} may be linked to form a cyclic group so that the carbene ligand has the structure of formula (IV)

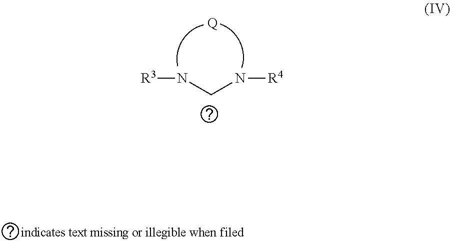

wherein R³ and R⁴ are as defined for the second group of catalysts above, with at least one of R³ and R⁴, such as both R³ and R⁴, being alicyclic or aromatic of one to about five rings, and optionally containing one or more heteroatoms and/or substituents. Q is a linker, typically a hydrocarbylene linker, including substituted hydrocarbylene, heteroatom-containing hydrocarbylene, and substituted heteroatom-containing hydrocarbylene linkers, wherein two or more substituents on adjacent atoms within Q may also be linked to form an additional cyclic structure, which may be similarly substituted to provide a fused polycyclic structure of two to about five cyclic groups. Q is often, although not necessarily, a two-atom linkage or a three-atom linkage.

Examples of N-heterocyclic carbene (NHC) ligands and acyclic diaminocarbene ligands suitable as L¹ thus include, but are not limited to, the following where DIPP or DiPP is diisopropylphenyl and Mes is 2,4,6trimethylphenyl:

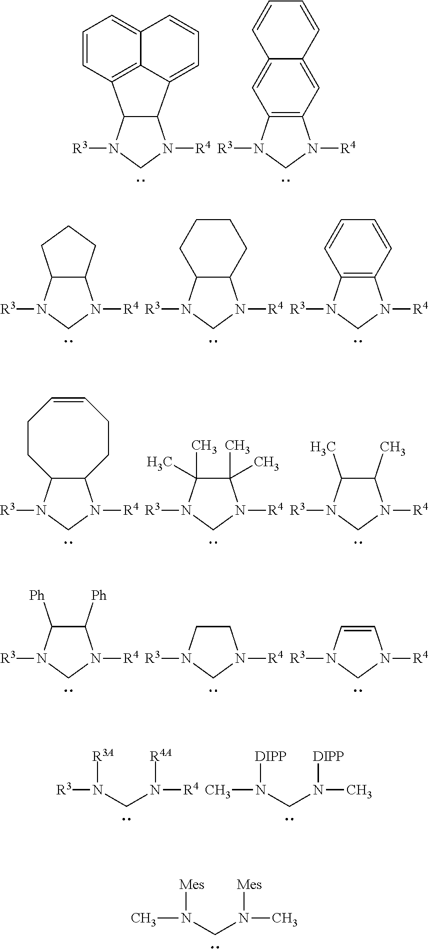

Additional examples of N-heterocyclic carbene (NHC) ligands and acyclic diaminocarbene ligands suitable as L¹ thus include, but are not limited to the following:

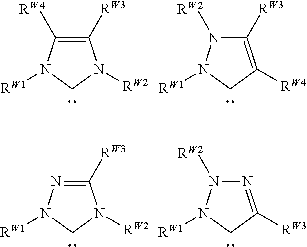

wherein R^{W1}, R^{W2}, R^{W3}, R^{W4} are independently hydrogen, unsubstituted hydrocarbyl, substituted hydrocarbyl, or heteroatom containing hydrocarbyl, and where one or both of R^{W3} and R^{W4} may be in independently selected from halogen, nitro, amido, carboxyl, alkoxy, aryloxy, sulfonyl, carbonyl, thio, or nitroso groups.

Additional examples of N-heterocyclic carbene (NHC) ligands suitable as L¹ are further described in U.S. Pat. Nos. 7,378,528; 7,652,145; 7,294,717; 6,787,620; 6,635,768; and 6,552,139, the disclosures of which are incorporated herein by reference.

Additionally, thermally activated N-Heterocyclic Carbene Precursors as disclosed in U.S. Pat. No. 6,838,489, the disclosure of which is incorporated herein by reference, may also be used with the invention.

When M is ruthenium, then, the complexes may have the structure of formula (V)

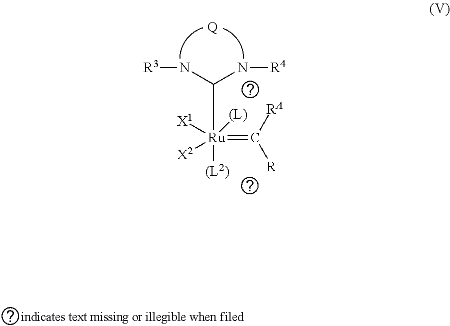

wherein n, X¹, X², L², L³, R¹, and R² are as defined for the first group of catalysts, and k, R³, R⁴, and Q are as defined for the second group of catalysts.

More preferably, Q is a two-atom linkage having the structure —CR¹¹R¹²—CR¹³R¹⁴- or —CR¹¹=CR¹³, such as —CR¹¹R¹²—CR¹³R¹⁴—, wherein R¹¹, R¹², R¹³, and R¹⁴ are independently selected from hydrogen, hydrocarbyl, substituted hydrocarbyl, heteroatom-containing hydrocarbyl, substituted heteroatom-containing hydrocarbyl, and functional groups. Examples of functional groups here include without limitation carboxyl, C₁-C₂₀ alkoxy, C₅-C₂₄ aryloxy, C₂-C₂₀ alkoxycarbonyl, C₅-C₂₄ alkoxycarbonyl, C₂-C₂₄ acyloxy, C₁-C₂₀ alkylthio, C₅-C₂₄ arylthio, C₁-C₂₀ alkylsulfonyl, and C₁-C₂₀ alkylsulfinyl, optionally substituted with one or more moieties selected from C₁-C₁₂ alkyl, C₁-C₁₂ alkoxy, C₅-C₁₄ aryl, hydroxyl, sulfhydryl, formyl, and halide. R¹¹, R¹², R¹³, and R¹⁴ may be independently selected from hydrogen, C₁-C₁₂ alkyl, substituted C₁-C₁₂ alkyl, C₁-C₁₂ heteroalkyl, substituted C₁-C₁₂ heteroalkyl, phenyl, and substituted phenyl. Alternatively, any two of R¹¹, R¹², R¹³, and R¹⁴ may be linked together to form a substituted or unsubstituted, saturated or unsaturated ring structure, e.g., a C₄-C₁₂ alicyclic group or a C₅ or C₆ aryl group, which may itself be substituted, e.g., with linked or fused alicyclic or aromatic groups, or with other substituents. In one further aspect, any one or more of R¹¹, R¹², R¹³, and R¹⁴ comprises one or more of the linkers. Additionally, R³ and R⁴ may be unsubstituted phenyl or phenyl substituted with one or more substituents selected from C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, C₆-C₂₄ aralkyl, C₆-C₂₄ alkaryl, or halide. Furthermore, X¹ and X² may be halogen.

When R³ and R⁴ are aromatic, they are typically although not necessarily composed of one or two aromatic rings, which may or may not be substituted, e.g., R³ and R⁴ may be phenyl, substituted phenyl, biphenyl, substituted biphenyl, or the like. R³ and R⁴ may be the same and are each unsubstituted phenyl or phenyl substituted with up to three substituents selected from C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, C₆-C₂₄ aralkyl, C₆-C₂₄ alkaryl, or halide. Any substituents present may be hydrogen, C₁-C₁₂ alkyl, C₁-C₁₂ alkoxy, C₅-C₁₄ aryl, substituted C₅-C₁₄ aryl, or halide. As an example, R³ and R⁴ are mesityl (i.e., Mes as defined herein).

In a third group of catalysts having the structure of formula (I), M, m, n, X¹, X², R¹, and R² are as defined for the first group of catalysts, L¹ is a strongly coordinating neutral electron donor ligand such as any of those described for the first and second group of catalysts, and L² and L³ are weakly coordinating neutral electron donor ligands in the form of optionally substituted heterocyclic groups. Again, n is 0 or 1, such that L³ may or may not be present. Generally, in the third group of catalysts, L² and L³ are optionally substituted five- or six-membered monocyclic groups containing 1 to 4 (e.g., 1 to 3, 1 to 2) heteroatoms, or are optionally substituted bicyclic or polycyclic structures composed of 2 to 5 such five- or six-membered monocyclic groups. If the heterocyclic group is substituted, it should not be substituted on a coordinating heteroatom, and any one cyclic moiety within a heterocyclic group will generally not be substituted with more than 3 substituents.

For the third group of catalysts, examples of L² and L³ include, without limitation, heterocycles containing nitrogen, sulfur, oxygen, or mixtures thereof.

Examples of nitrogen-containing heterocycles appropriate for L² and L³ include pyridine, bipyridine, pyridazine, pyrimidine, bipyridamine, pyrazine, 1,3,5-triazine, 1,2,4triazine, 1,2,3-triazine, pyrrole, 2H-pyrrole, 3H-pyrrole, pyrazole, 2H-imidazole, 1,2,3triazole, 1,2,4-triazole, indole, 3H-indole, 1H-isoindole, cyclopenta (b) pyridine, indazole, quinoline, bisquinoline, isoquinoline, bisisoquinoline, cinnoline, quinazoline, naphthyridine, piperidine, piperazine, pyrrolidine, pyrazolidine, quinuclidine, imidazolidine, picolylimine, purine, benzimidazole, bisimidazole, phenazine, acridine, and carbazole. Additionally, the nitrogen-containing heterocycles may be optionally substituted on a non-coordinating heteroatom with a non-hydrogen substitutent.

Examples of sulfur-containing heterocycles appropriate for L² and L³ include thiophene, 1,2-dithiole, 1,3-dithiole, thiepin, benzo (b) thiophene, benzo (c) thiophene, thionaphthene, dibenzothiophene, 2H-thiopyran, 4H-thiopyran, and thioanthrene.

Examples of oxygen-containing heterocycles appropriate for L² and L³ include 2Hpyran, 4H-pyran, 2-pyrone, 4-pyrone, 1,2-dioxin, 1,3-dioxin, oxepin, furan, 2H1benzopyran, coumarin, coumarone, chromene, chroman-4-one, isochromen-1-one, isochromen-3-one, xanthene, tetrahydrofuran, 1,4-dioxan, and dibenzofuran.

Examples of mixed heterocycles appropriate for L² and L³ include isoxazole, oxazole, thiazole, isothiazole, 1,2,3-oxadiazole, 1,2,4-oxadiazole, 1,3,4-oxadiazole, 1,2,3,4-oxatriazole, 1,2,3,5-oxatriazole, 3H-1,2,3-dioxazole, 3H-1,2-oxathiole, 1,3-oxathiole, 4H-1,2-oxazine, 2H1,3-oxazine, 1,4-oxazine, 1,2,5-oxathiazine, o-isooxazine, phenoxazine, phenothiazine, pyrano[3,4-b]pyrrole, indoxazine, benzoxazole, anthranil, and morpholine.

L² and L³ ligands may be aromatic nitrogen-containing and oxygen-containing heterocycles, such as monocyclic N-heteroaryl ligands that are optionally substituted with 1 to 3 (e.g., 1 or 2) substituents. Specific examples of L² and L³ ligands are pyridine and substituted pyridines, such as 3bromopyridine, 4-bromopyridine, 3,5-dibromopyridine, 2,4,6-tribromopyridine, 2,6dibromopyridine, 3-chloropyridine, 4-chloropyridine, 3,5-dichloropyridine, 2,4,6trichloropyridine, 2,6-dichloropyridine, 4-iodopyridine, 3,5-diiodopyridine, 3,5-dibromo-4-methylpyridine, 3,5-dichloro-4-methylpyridine, 3,5-dimethyl-4-bromopyridine, 3,5dimethylpyridine, 4-methylpyridine, 3,5-diisopropylpyridine, 2,4,6-trimethylpyridine, 2,4,6triisopropylpyridine, 4-(tert-butyl)pyridine, 4-phenylpyridine, 3,5-diphenylpyridine, 3,5dichloro-4-phenylpyridine, and the like.

In general, any substituents present on L² and/or L³ are selected from halo, C₁-C₂₀ alkyl, substituted C₁-C₂₀ alkyl, C₁-C₂₀ heteroalkyl, substituted C₁-C₂₀ heteroalkyl, C₅-C₂₄ aryl, substituted C₅-C₂₄ aryl, C₅-C₂₄ heteroaryl, substituted C₅-C₂₄ heteroaryl, C₆-C₂₄ alkaryl, substituted C₆-C₂₄ alkaryl, C₆-C₂₄ heteroalkaryl, substituted C₆-C₂₄ heteroalkaryl, C₆-C₂₄ aralkyl, substituted C₆-C₂₄ aralkyl, C₆-C₂₄ heteroaralkyl, substituted C₆-C₂₄ heteroaralkyl, and functional groups, with suitable functional groups including, without limitation, C₁-C₂₀ alkoxy, C₅-C₂₄ aryloxy, C₂-C₂₀ alkylcarbonyl, C₆-C₂₄ arylcarbonyl, C₂-C₂₀ alkylcarbonyloxy, C₆-C₂₄ arylcarbonyloxy, C₂-C₂₀ alkoxycarbonyl, C₆-C₂₄ aryloxycarbonyl, halocarbonyl, C₂-C₂₀ alkylcarbonato, C₆-C₂₄ arylcarbonato, carboxy, carboxylato, carbamoyl, mono-(C₁-C₂₀ alkyl)-substituted carbamoyl, di-(C₁-C₂₀ alkyl)-substituted carbamoyl, di-N—(C₁-C₂₀ alkyl), N—(C₅-C₂₄ aryl)-substituted carbamoyl, mono-(C₅-C₂₄ aryl)-substituted carbamoyl, di-(C₆-C₂₄ aryl)-substituted carbamoyl, thiocarbamoyl, mono-(C₁-C₂₀ alkyl)-substituted thiocarbamoyl, di(C₁C₂₀ alkyl)-substituted thiocarbamoyl, di-N—(C₁-C₂₀ alkyl)-N—(C₆-C₂₄ aryl)-substituted thiocarbamoyl, mono-(C₆-C₂₄ aryl)-substituted thiocarbamoyl, di-(C₆-C₂₄ aryl)-substituted thiocarbamoyl, carbamido, formyl, thioformyl, amino, mono-(C₁-C₂₀ alkyl)-substituted amino, di-(C₁-C₂₀ alkyl)-substituted amino, mono-(C₅-C₂₄ aryl)-substituted amino, di-(C₅-C₂₄ aryl)-substituted amino, di-N—(C₁-C₂₀ alkyl), N—(C₅-C₂₄ aryl)-substituted amino, C₂-C₂₀ alkylamido, C₆C₂₄ arylamido, imino, C₁-C₂₀ alkylimino, C₅-C₂₄ arylimino, nitro, and nitroso. In addition, two adjacent substituents may be taken together to form a ring, generally a five- or six-membered alicyclic or aryl ring, optionally containing 1 to 3 heteroatoms and 1 to 3 substituents as above.

Substituents on L² and L³ include, without limitation, halo, C₁-C₁₂ alkyl, substituted C₁-C₁₂ alkyl, C₁-C₁₂ heteroalkyl, substituted C₁-C₁₂ heteroalkyl, C₅-C₁₄ aryl, substituted C₅-C₁₄ aryl, C₅-C₁₄ heteroaryl, substituted C₅-C₁₄ heteroaryl, C₆-C₁₆ alkaryl, substituted C₆-C₁₆ alkaryl, C₆-C₁₆ heteroalkaryl, substituted C₆-C₁₆ heteroalkaryl, C₆-C₁₆ aralkyl, substituted C₆-C₁₆ aralkyl, C₆-C₁₆ heteroaralkyl, substituted C₆-C₁₆ heteroaralkyl, C₁-C₁₂ alkoxy, C₅-C₁₄ aryloxy, C₂-C₁₂ alkylcarbonyl, C₆-C₁₄ arylcarbonyl, C₂-C₁₂ alkylcarbonyloxy, C₆-C₁₄ arylcarbonyloxy, C₂-C₁₂ alkoxycarbonyl, C₆-C₁₄ aryloxycarbonyl, halocarbonyl, formyl, amino, mono-(C₁-C₁₂ alkyl)-substituted amino, di-(C₁-C₁₂ alkyl)-substituted amino, mono-(C₅-C₁₄ aryl)-substituted amino, di-(C₅-C₁₄ aryl)-substituted amino, and nitro.

In another embodiment, the substituents are halo, C₁-C₆ alkyl, C₁-C₆ haloalkyl, C₁-C₆ alkoxy, phenyl, substituted phenyl, formyl, N,N-di(C₁-C₆ alkyl)amino, nitro, and nitrogen heterocycles as described above (including, for example, pyrrolidine, piperidine, piperazine, pyrazine, pyrimidine, pyridine, pyridazine, etc.).

L² and L³ may also be taken together to form a bidentate or multidentate ligand containing two or more, generally two, coordinating heteroatoms such as N, O, S, or P, such as diimine ligands of the Brookhart type. One representative bidentate ligand has the structure of formula (VI)

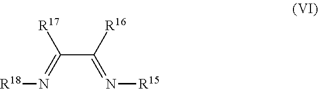

wherein R¹⁵, R¹⁶, R¹⁷, and R¹⁸ hydrocarbyl (e.g., C₁-C₂₀ alkyl, C₂-C₂₀ alkenyl, C₂-C₂₀ alkynyl, C₅-C₂₄ aryl, C₆-C₂₄ alkaryl, or C₆-C₂₄ aralkyl), substituted hydrocarbyl (e.g., substituted C₁-C₂₀ alkyl, C₂-C₂₀ alkenyl, C₂-C₂₀ alkynyl, C₅-C₂₄ aryl, C₆-C₂₄ alkaryl, or C₆-C₂₄ aralkyl), heteroatom-containing hydrocarbyl (e.g., C₁-C₂₀ heteroalkyl, C₅-C₂₄ heteroaryl, heteroatom-containing C₆-C₂₄ aralkyl, or heteroatom-containing C₆-C₂₄ alkaryl), or substituted heteroatom-containing hydrocarbyl (e.g., substituted C₁-C₂₀ heteroalkyl, C₅-C₂₄ heteroaryl, heteroatom-containing C₆-C₂₄ aralkyl, or heteroatom-containing C₆-C₂₄ alkaryl), or (1) R¹⁵ and R¹⁶, (2) R¹⁷ and R¹⁸, (3) R¹⁶ and R¹⁷, or (4) both R¹⁵ and R¹⁶, and R¹⁷ and R¹⁸, may be taken together to form a ring, i.e., an N-heterocycle. Cyclic groups in such a case may be five- and six-membered rings, typically aromatic rings.

In a fourth group of catalysts that have the structure of formula (I), two of the substituents are taken together to form a bidentate ligand or a tridentate ligand. Examples of bidentate ligands include, but are not limited to, bisphosphines, dialkoxides, alkyldiketonates, and aryldiketonates. Specific examples include P(Ph)₂CH₂CH₂P(Ph)₂-, As(Ph)₂CH₂CH₂As(Ph₂)—, —P(Ph)₂CH₂CH₂C(CF₃)₂O—, binaphtholate dianions, pinacolate dianions, —P(CH₃)₂ (CH₂)₂P(CH₃)₂—, and —OC(CH₃)₂ (CH₃)₂CO—. Bidentate ligands may be P(Ph)₂CH₂CH₂P(Ph)₂- and P(CH₃)₂ (CH₂)₂P(CH₃)₂—. Tridentate ligands include, but are not limited to, (CH₃)₂NCH₂CH₂P(Ph)CH₂CH₂N(CH₃)₂. Other tridentate ligands are those in which any three of X¹, X², L¹, L², L³, R¹, and R² (e.g., X¹, L¹, and L²) are taken together to be cyclopentadienyl, indenyl, or fluorenyl, each optionally substituted with C₂-C₂₀ alkenyl, C₂C₂₀ alkynyl, C₁-C₂₀ alkyl, C₅-C₂₀ aryl, C₁-C₂₀ alkoxy, C₂-C₂₀ alkenyloxy, C₂-C₂₀ alkynyloxy, C₅C₂₀ aryloxy, C₂-C₂₀ alkoxycarbonyl, C₁-C₂₀ alkylthio, C₁-C₂₀ alkylsulfonyl, or C₁-C₂₀ alkylsulfinyl, each of which may be further substituted with C₁-C₆ alkyl, halide, C₁-C₆ alkoxy or with a phenyl group optionally substituted with halide, C₁-C₆ alkyl, or C₁-C₆ alkoxy. In compounds of this type, X, L¹, and L² may be taken together to be cyclopentadienyl or indenyl, each optionally substituted with vinyl, C₁-C₁₀ alkyl, C₅-C₂₀ aryl, C₁-C₁₀ carboxylate, C₂-C₁₀ alkoxycarbonyl, C₁-C₁₀ alkoxy, or C₅-C₂₀ aryloxy, each optionally substituted with C₁-C₆ alkyl, halide, C₁-C₆ alkoxy or with a phenyl group optionally substituted with halide, C₁-C₆ alkyl or C₁C₆ alkoxy. X, L¹ and L² may be taken together to be cyclopentadienyl, optionally substituted with vinyl, hydrogen, methyl, or phenyl. Tetradentate ligands include, but are not limited to O₂C(CH₂)₂P(Ph)(CH₂)₂P(Ph)(CH₂)₂CO₂, phthalocyanines, and porphyrins.

Complexes wherein Y is coordinated to the metal are examples of a fifth group of catalysts, and are commonly called “Grubbs-Hoveyda” catalysts. Grubbs-Hoveyda metathesis-active metal carbene complexes may be described by the formula (VII)

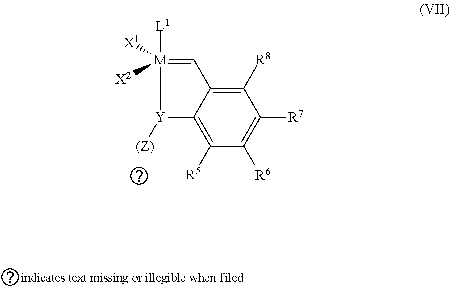

wherein:
   M is a Group 8 transition metal, particularly Ru or Os, or, more particularly, Ru;
   X¹, X², and L¹ are as previously defined herein for the first and second groups of catalysts;
   Y is a heteroatom selected from N, O, S, and P; for example, Y is O or N;
   R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, hydroxyl, ester, ether, amine, imine, amide, halogen-substituted amide, trifluoroamide, sulfide, disulfide, sulfonate, carbamate, silane, siloxane, phosphine, phosphate, borate, or -A-Fn, wherein “A” and Fn have been defined above; and any combination of Y, Z, R⁵, R⁶, R⁷, and R⁸ can be linked to form one or more cyclic groups;
   n is 0, 1, or 2, such that n is 1 for the divalent heteroatoms O or S, and n is 2 for the trivalent heteroatoms N or P; and
   Z is a group selected from hydrogen, alkyl, aryl, functionalized alkyl, functionalized aryl where the functional group(s) may independently be one or more or the following: alkoxy, aryloxy, halogen, carboxylic acid, ketone, aldehyde, nitrate, cyano, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and wherein any combination or combinations of X¹, X², L¹, Y, Z, R⁵, R⁶, R⁷, and R⁸ may be linked to a support. Additionally, R⁵, R⁶, R⁷, R⁸, and Z may independently be thioisocyanate, cyanato, or thiocyanato.

Examples of complexes comprising Grubbs-Hoveyda ligands suitable in the invention include:

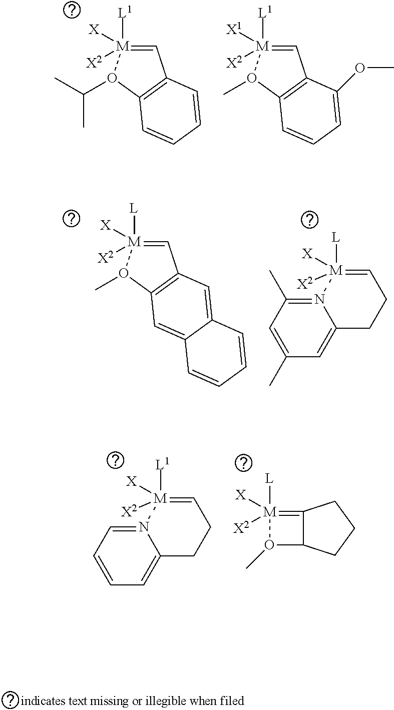

wherein L¹, X¹, X², and M are as described for any of the other groups of catalysts. Suitable chelating carbenes and carbene precursors are further described by Pederson et al. (U.S. Pat. Nos. 7,026,495 and 6,620,955, the disclosures of which are incorporated herein by reference) and Hoveyda et al. (U.S. Pat. No. 6,921,735 and WO0214376, the disclosures of which are incorporated herein by reference).

Other useful complexes include structures wherein L² and R² according to formulae (I), (III), or (V) are linked, such as styrenic compounds that also include a functional group for attachment to a support. Examples in which the functional group is a trialkoxysilyl functionalized moiety include, but are not limited to, the following:

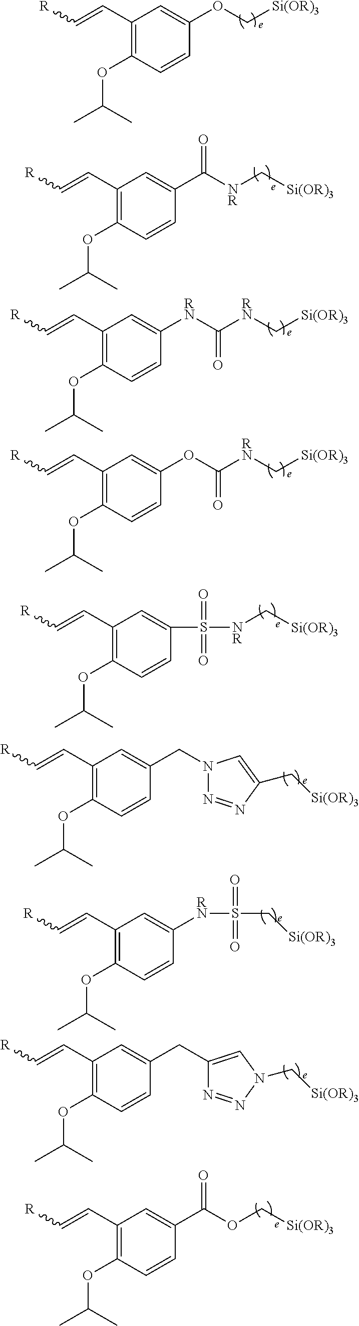

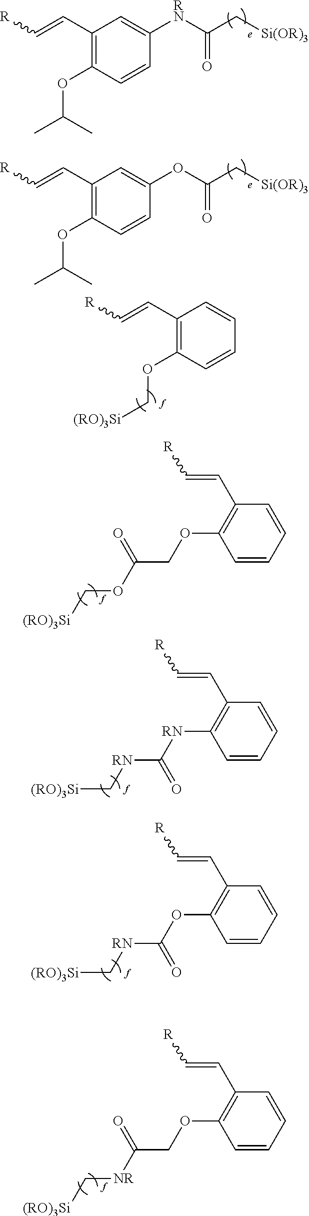

Further examples of complexes having linked ligands include those having linkages between a neutral NHC ligand and an anionic ligand, a neutral NHC ligand and an alkylidine ligand, a neutral NHC ligand and an L² ligand, a neutral NHC ligand and an L³ ligand, an anionic ligand and an alkylidine ligand, and any combination thereof. While the possible structures are too numerous to list herein, some suitable structures based on formula (III) include:

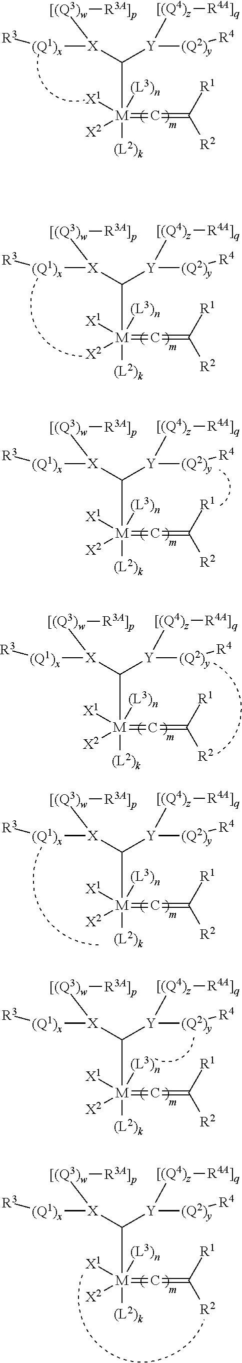

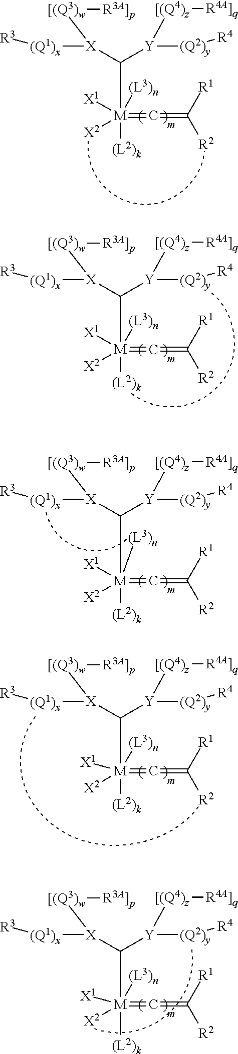

In addition to the catalysts that have the structure of formula (I), as described above, other transition metal carbene complexes include, but are not limited to:
neutral ruthenium or osmium metal carbene complexes containing metal centers that are formally in the +2 oxidation state, have an electron count of 16, are penta-coordinated, and are of the general formula (IX);
neutral ruthenium or osmium metal carbene complexes containing metal centers that are formally in the +2 oxidation state, have an electron count of 18, are hexa-coordinated, and are of the general formula (X);
cationic ruthenium or osmium metal carbene complexes containing metal centers that are formally in the +2 oxidation state, have an electron count of 14, are tetra-coordinated, and are of the general formula (XI); and
cationic ruthenium or osmium metal carbene complexes containing metal centers that are formally in the +2 oxidation state, have an electron count of 14 or 16, are tetra-coordinated or penta-coordinated, respectively, and are of the general formula (XII)

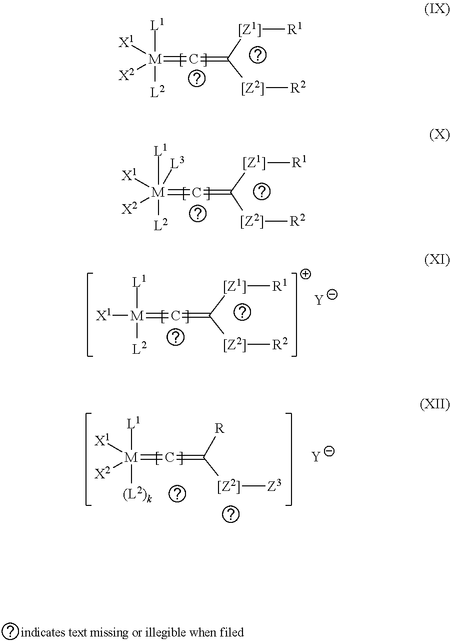

wherein:
M, X¹, X², L¹, L², L³, R¹, and R² are as defined for any of the previously defined four groups of catalysts;
r and s are independently 0 or 1;
t is an integer in the range of 0 to 5;
k is an integer in the range of 0 to 1;
Y is any non-coordinating anion (e.g., a halide ion, BF₄⁻, etc.);
Z¹ and Z² are independently selected from —O—, —S—, —NR²—, —PR²—, —P(═O)R²—, —P(OR²)—, —P(═O)(OR²)—, —C(═O)—, —C(═O)O—, —OC(═O)—, —OC(═O)O—, —S(═O)—, —S(═O)₂—, —, and an optionally substituted and/or optionally heteroatom—containing C₁-C₂₀ hydrocarbylene linkage;
Z³ is any cationic moiety such as —P(R²)₃⁺ or —N(R²)₃⁺; and
any two or more of X¹, X², L¹, L², L³, Z¹, Z², Z³, R¹, and R² may be taken together to form a cyclic group, e.g., a multidentate ligand, and wherein any one or more of X¹, X², L¹, L², L³, Z¹, Z², Z³, R¹, and R² may be attached to a support.

Additionally, another group of metal carbene olefin metathesis catalysts that may be used in the catalyst composition of the invention disclosed herein, is a Group 8 transition metal complex having the structure of formula (XIII):

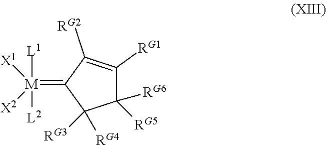

wherein:
   M is a Group 8 transition metal, particularly ruthenium or osmium, or more particularly, ruthenium;
   X¹, X², L¹ and L² are as defined for the first and second groups of catalysts defined above; and
   R^{G1}, R^{G2}, R^{G3}, R^{G4}, R^{G5}, and R^{G6} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, amine, alkylamine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{G1}, R^{G2}, R^{G3}, R^{G4}, R^{G5}, and R^{G6} may be linked together to form a cyclic group, or any one or more of the R^{G1}, R^{G2}, R^{G3}, R^{G4}, R^{G5}, and R^{G6} may be attached to a support.

Additionally, one Group 8 transition metal complex of formula XIII is a Group 8 transition metal complex of formula (XIV):

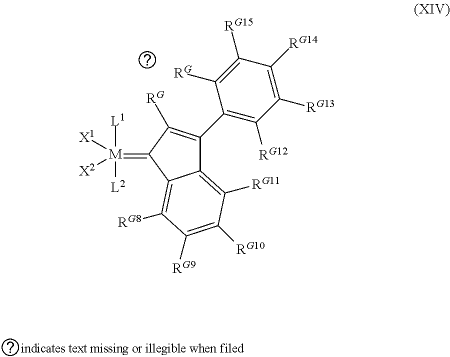

wherein:
   M, X¹, X², L¹, L², are as defined above for Group 8 transition metal complex of formula XIII; and
   R^{G7}, R^{G8}, R^{G9}, R^{G10}, R^{G11}, R^{G12}, R^{G13}, R^{G14}, R^{G15}, and R^{G16} are as defined above for R^{G1}, R^{G2}, R^{G3}, R^{G4}, R^{G5}, and R^{G6} for Group 8 transition metal complex of formula XIII or any one or more of the R^{G7}, R^{G8}, R^{G9}, R^{G10}, R^{G11}, R^{G12}, R^{G13}, R^{G14}, R^{G15}, and R^{G16} may be linked together to form a cyclic group, or any one or more of the R^{G7}, R^{G8}, R^{G9}, R^{G10}, R^{G11}, R^{G12}, R^{G13}, R^{G14}, R^{G15}, and R^{G16} may be attached to a support.

Additionally, another Group 8 transition metal complex of formula XIII is a Group 8 transition metal complex of formula (XV):

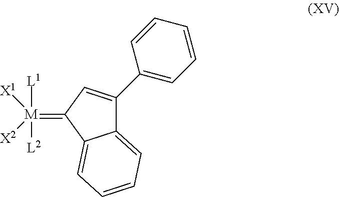

wherein M, X¹, X², L¹, and L² are as defined above for Group 8 transition metal complex of formula XIII.

Additionally, another group of olefin metathesis catalysts that may be used in the catalyst composition of the invention disclosed herein, is a Group 8 transition metal complex comprising a Schiff base ligand having the structure of formula (XVI):

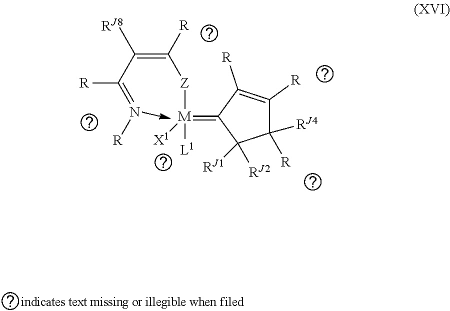

wherein:
   M is a Group 8 transition metal, particularly ruthenium or osmium, or more particularly, ruthenium;
   X¹ and L¹ are as defined for the first and second groups of catalysts defined above;
   Z is selected from the group consisting of oxygen, sulfur, selenium, NR^{J11}, PR^{J11}, AsR^{J11}, and SbR^{J11}; and
   R^{J1}, R^{J2}, R^{J3}, R^{J4}, R^{J5}, R^{J6}, R¹⁷, R^{J8}, R^{J9}, R^{J10}, and R^{J11} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, amine, alkylamine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{J1}, R^{J2}, R^{J3}, R^{J4}, R^{J5}, R^{J6}, R^{J7}, R^{J8}, R^{J9}, R^{J10}, and R^{J11} may be linked together to form a cyclic group, or any one or more of the R^{J1}, R^{J2}, R^{J3}, R^{J4}, R^{J5}, R^{J6}, R^{J7}, R^{J8}, R^{J9}, R^{J10}, and R^{J11} may be attached to a support.

Additionally, one Group 8 transition metal complex of formula (XVI) is a Group 8 transition metal complex comprising a Schiff base ligand having the structure of formula (XVII):

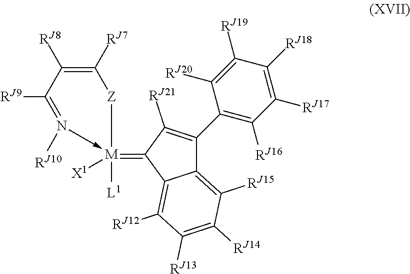

wherein:
   M, X¹, L¹, Z, R^{J7}, R^{J8}, R^{J9}, R^{J10}, and R^{J11} are as defined above for Group 8 transition metal complex of formula XVI; and
   R^{J12}, R^{J13}, R^{J14}, R^{J15}, R^{J16}, R^{J17}, R^{J18}, R^{J19}, R^{J20}, and R^{J21} are as defined above for R^{J1}, R^{J2}, R^{J3}, R^{J4}, R^{J5}, and R^{J6} for Group 8 transition metal complex of formula XVI, or any one or more of the R^{J7}, R^{J8}, R^{J9}, R^{J10}, R^{J11}, R^{J12}, R^{J13}, R^{J14}, R^{J15}, R^{J16}, R^{J17}, R^{J18}, R^{J19}, R^{J20}, and R^{J21} may be linked together to form a cyclic group, or any one or more of the R^{J7}, R^{J8}, R^{J9}, R^{J10}, R^{J11}, R^{J12}, R^{J13}, R^{J14}, R^{J15}, R^{J16}, R^{J17}, R^{J18}, R^{J19}, R^{J20}, and R^{J21} may be attached to a support.

Additionally, another Group 8 transition metal complex of formula (XVI) is a Group 8 transition metal complex comprising a Schiff base ligand having the structure of formula (XVIII):

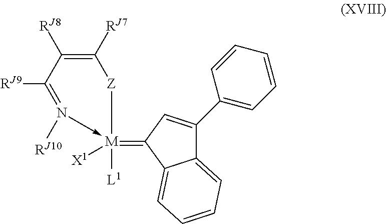

wherein M, X¹, L¹, Z, R^{J7}, R^{J8}, R^{J9}, R^{J10}, and R^{J11} are as defined above for Group 8 transition metal complex of formula (XVI).

Additionally, another group of olefin metathesis catalysts that may be used in the catalyst composition of the invention disclosed herein, is a Group 8 transition metal complex comprising a Schiff base ligand having the structure of formula (XIX):

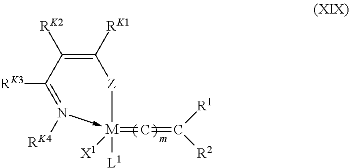

wherein:
   M is a Group 8 transition metal, particularly ruthenium or osmium, or more particularly, ruthenium;
   X¹, L¹, R¹, and R² are as defined for the first and second groups of catalysts defined above;
   Z is selected from the group consisting of oxygen, sulfur, selenium, NR^{K5}, PR^{K5}, AsR^{K5}, and SbR^{K5};
   m is 0, 1, or 2; and
   R^{K1}, R^{K2}, R^{K3}, R^{K4}, and R^{K5} are each independently selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, cyano, isocyanate, thioisocyanate, cyanato, thiocyanato, hydroxyl, ester, ether, thioether, amine, alkylamine, imine, amide, halogen-substituted amide, trifluoroamide, sulfide, disulfide, sulfonate, carbamate, silane, siloxane, phosphine, phosphate, borate, or -A-Fn, wherein “A” is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the arylalkylene can be substituted or unsubstituted, and wherein hetero atoms and/or functional groups may be present in either the aryl or the alkyl portions of the alkylene and arylalkylene groups, and Fn is a functional group, or any one or more of the R^{K1}, R^{K2}, R^{K3}, R^{K4}, and R^{K5} may be linked together to form a cyclic group, or any one or more of the R^{K1}, R^{K2}, R^{K3}, R^{K4}, and R^{K5} may be attached to a support.

In addition, catalysts of formulas (XVI) to (XIX) may be optionally contacted with an activating compound, where at least partial cleavage of a bond between the Group 8 transition metal and at least one Schiff base ligand occurs, wherein the activating compound is either a metal or silicon compound selected from the group consisting of copper (I) halides; zinc compounds of the formula Zn(R^{Y1})₂, wherein R^{Y1} is halogen, C₁-C₇ alkyl or aryl; tin compounds represented by the formula SnR^{Y2}R^{Y3}R^{Y4}R^{Y5} wherein each of R^{Y2}, R^{Y3}, R^{Y4} and R^{Y5} is independently selected from the group consisting of halogen, C₁-C₂₀ alkyl, C₃-C₁₀ cycloalkyl, aryl, benzyl and C₂-C₇ alkenyl; and silicon compounds represented by the formula SiR^{Y6}R^{Y7}R^{Y8}R^{Y9} wherein each of R^{Y6}, R^{Y7}, R^{Y8}, R^{Y9} is independently selected from the group consisting of hydrogen, halogen, C₁-C₂₀ alkyl, halo, C₁-C₇ alkyl, aryl, heteroaryl, and vinyl. In addition, catalysts of formulas (XVI) to (XIX) may be optionally contacted with an activating compound where at least partial cleavage of a bond between the Group 8 transition metal and at least one Schiff base ligand occurs, wherein the activating compound is an inorganic acid such as hydrogen iodide, hydrogen bromide, hydrogen chloride, hydrogen fluoride, sulfuric acid, nitric acid, iodic acid, periodic acid, perchloric acid, HOClO, HOClO₂ and HOlO₃. In addition, catalysts of formulas (XVI) to (XIX) may be optionally contacted with an activating compound where at least partial cleavage of a bond between the Group 8 transition metal and at least one Schiff base ligand occurs, wherein the activating compound is an organic acid such as sulfonic acids including but not limited to methanesulfonic acid, aminobenzenesulfonic acid, benzenesulfonic acid, napthalenesulfonic acid, sulfanilic acid and trifluoromethanesulfonic acid; monocarboxylic acids including but not limited to acetoacetic acid, barbituric acid, bromoacetic acid, bromobenzoic acid, chloroacetic acid, chlorobenzoic acid, chlorophenoxyacetic acid, chloropropionic acid, cis-cinnamic acid, cyanoacetic acid, cyanobutyric acid, cyanophenoxyacetic acid, cyanopropionic acid, dichloroacetic acid, dichloroacetylacetic acid, dihydroxybenzoic acid, dihydroxymalic acid, dihydroxytartaric acid, dinicotinic acid, diphenylacetic acid, fluorobenzoic acid, formic acid, furancarboxylic acid, furoic acid, glycolic acid, hippuric acid, iodoacetic acid, iodobenzoic acid, lactic acid, lutidinic acid, mandelic acid, α-naphtoic acid, nitrobenzoic acid, nitrophenylacetic acid, o-phenylbenzoic acid, thioacetic acid, thiophene-carboxylic acid, trichloroacetic acid, and trihydroxybenzoic acid; and other acidic substances such as but not limited to picric acid and uric acid.

In addition, other examples of catalysts that may be used in the catalyst composition of the invention are located in the following disclosures, the disclosures of which are incorporated herein by reference, U.S. Pat. Nos. 7,687,635; 7,671,224; 6,284,852; 6,486,279; and 5,977,393; International Publication Number WO 2010/037550; and U.S. patent application Ser. Nos. 12/303,615; 10/590,380; 11/465,651 (Publication No.: US 2007/0043188); and Ser. No. 11/465,651 (Publication No.: US 2008/0293905 Corrected Publication); and European Pat. Nos. EP 1757613 B1 and EP 1577282 B1.

Non-limiting examples of catalysts that may be used to prepare supported complexes and in the reactions disclosed herein include the following, some of which for convenience are identified throughout this disclosure by reference to their molecular weight:

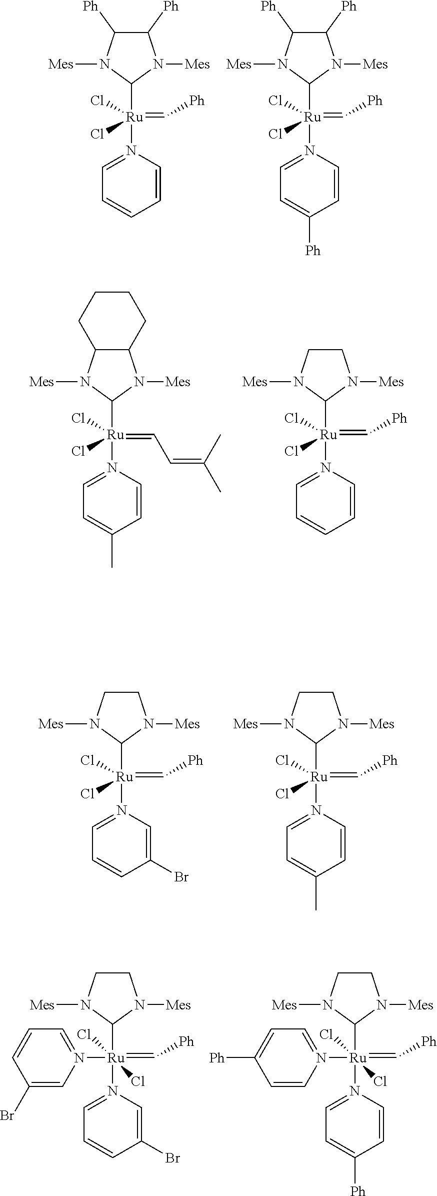

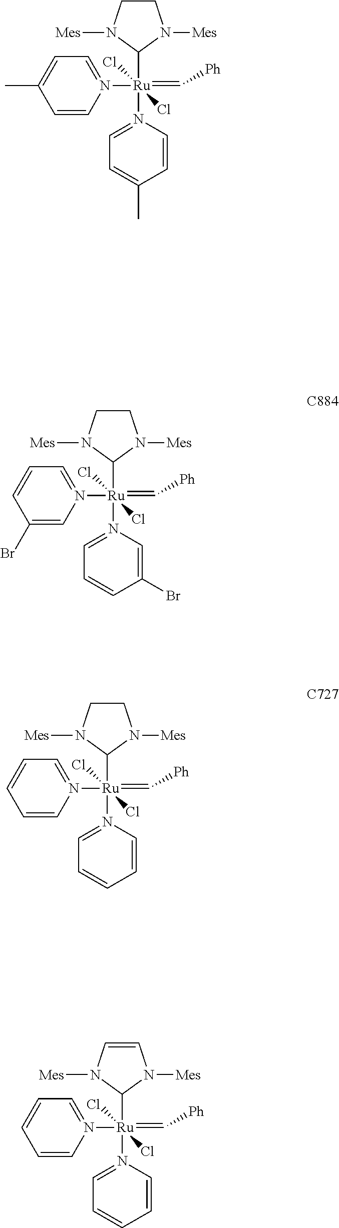

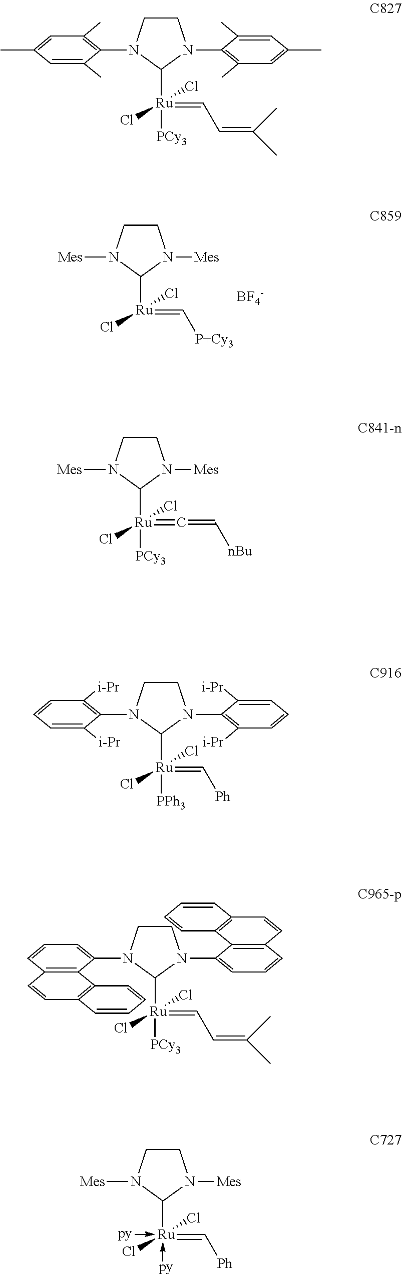

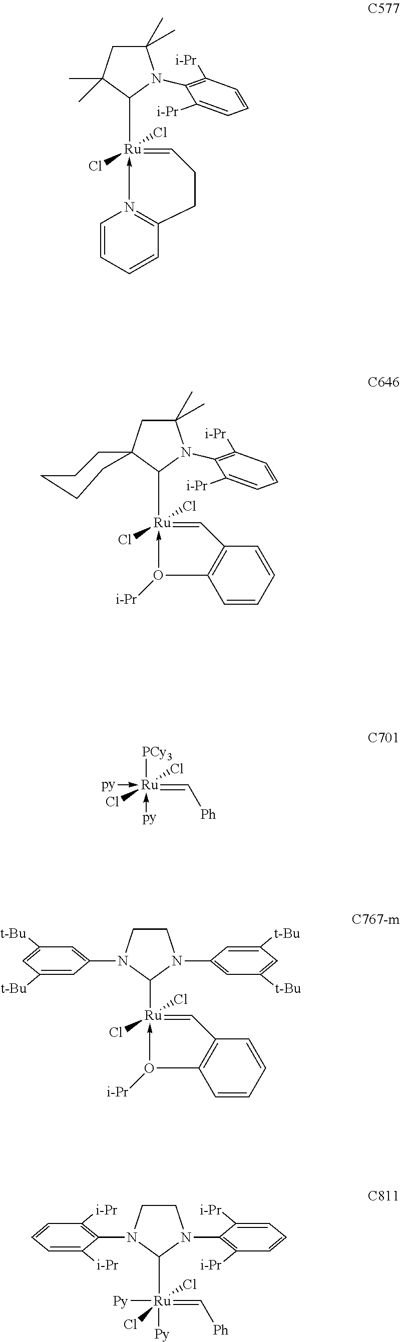

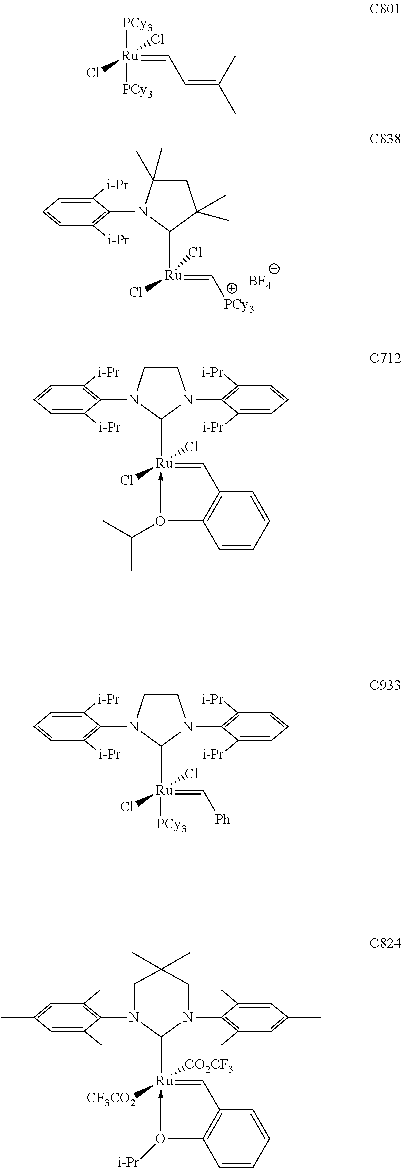

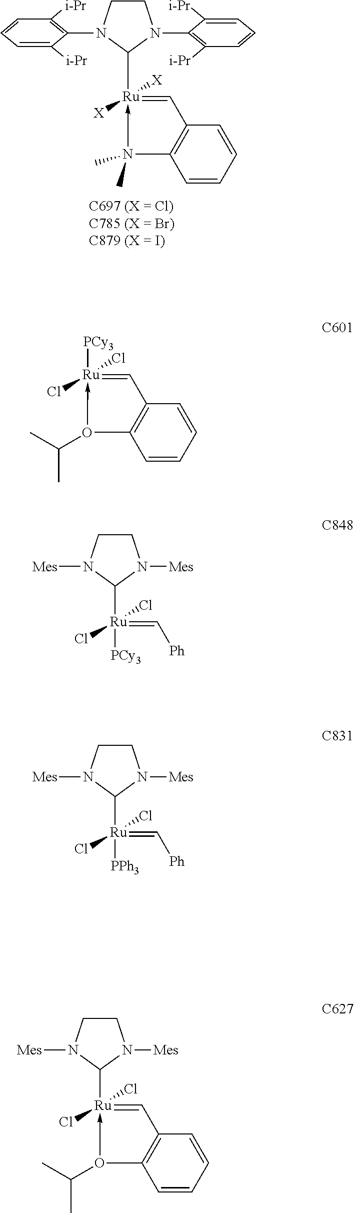

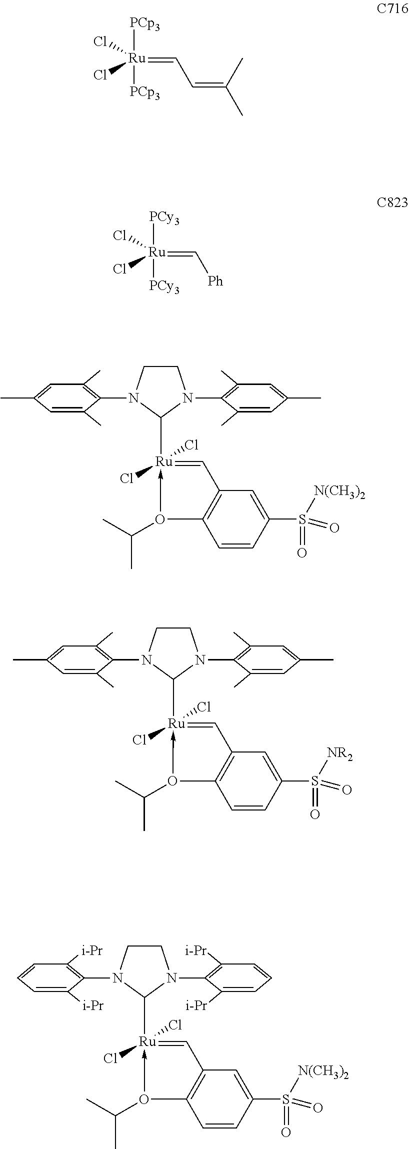

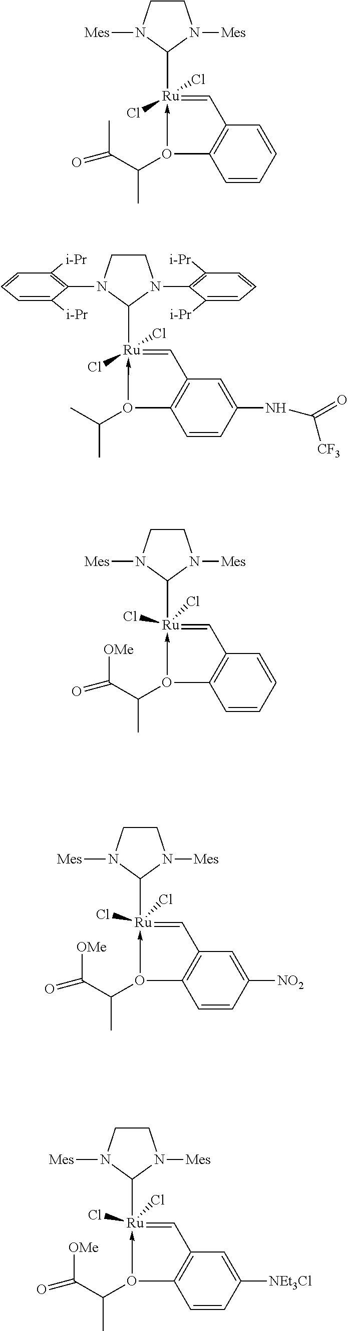

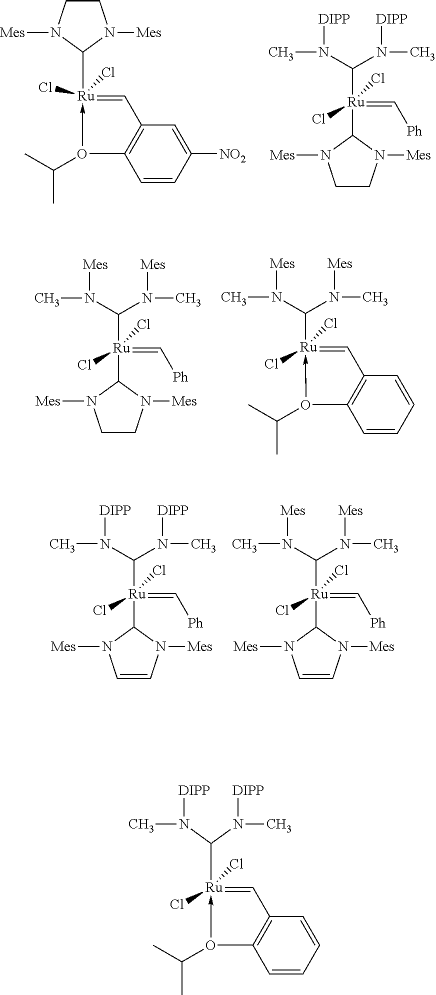

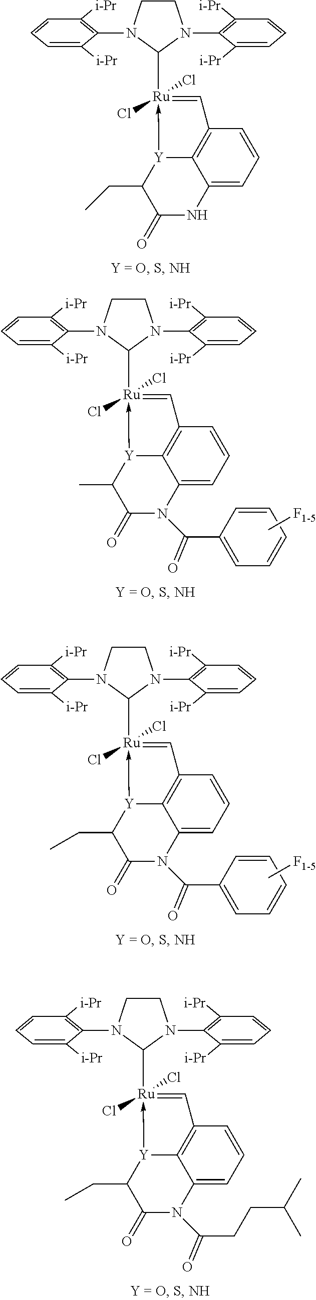

In the foregoing molecular structures and formulae, Ph represents phenyl, Cy represents cyclohexyl, Cp represents cyclopentyl, Me represents methyl, Bu represents n-butyl, t-Bu represents tert-butyl, i-Pr represents isopropyl, py represents pyridine (coordinated through the N atom), Mes represents mesityl (i.e., 2,4,6trimethylphenyl), DiPP and DIPP represents 2,6-diisopropylphenyl, and MiPP represents 2isopropylphenyl.

Further examples of catalysts useful to prepare supported complexes and in the reactions disclosed herein include the following: ruthenium (II) dichloro(3-methyl-2-butenylidene) bis(tricyclopentylphosphine) (C716); ruthenium (II) dichloro(3-methyl-2butenylidene) bis(tricyclohexylphosphine) (C801); ruthenium (II) dichloro(phenylmethylene)bis(tricyclohexylphosphine) (C823); ruthenium (II) (1,3-bis-(2,4,6-trimethylphenyl)-2-imidazolidinylidene)dichloro(phenylmethylene) (triphenylphosphine) (C830); ruthenium (II) dichloro(phenylvinylidene)bis(tricyclohexylphosphine) (C835); ruthenium (II) dichloro(tricyclohexylphosphine) (o-isopropoxyphenylmethylene) (C601); ruthenium (II) (1,3-bis-(2, 4,6-trimethylphenyl)-2-imidazolidinylidene)dichloro(phenylmethylene) bis(3bromopyridine) (C884); [1,3-bis-(2,4,6-trimethylphenyl)-2-imidazolidinylidene]dichloro(o-isopropoxyphenylmethylene)ruthenium(II) (C627); [1,3-bis-(2,4,6-trimethylphenyl)-2-imidazolidinylidene]dichloro(benzylidene) (triphenylphosphine)ruthenium(II) (C831); [1,3-bis-(2,4,6-trimethylphenyl)-2-imidazolidinylidene]dichloro(benzylidene)(methyldiphenylphosphine)ruthenium(II) (C769); [1,3-bis-(2,4,6-trimethylphenyl)-2-imidazolidinylidene]dichloro(benzylidene) (tricyclohexylphosphine)ruthenium(II) (C848); [1,3-bis-(2,4,6-trimethylphenyl)-2-imidazolidinylidene]dichloro(benzylidene) (diethylphenylphosphine)ruthenium(II) (C735); [1,3-bis-(2,4,6-trimethylphenyl)-2-imidazolidinylidene]dichloro(benzylidene) (tri-n-butylphosphine)ruthenium(II) (C771); [1,3-bis-(2,4,6-trimethylphenyl)-2-imidazolidinylidene]dichloro(3-methyl-2-butenylidene) (triphenylphosphine)ruthenium(II) (C809); [1,3-bis-(2,4,6-trimethylphenyl)-2-imidazolidinylidene]dichloro(3-methyl-2-butenylidene)(methyldiphenylphosphine)ruthenium(II) (C747); [1,3-bis-(2,4,6-trimethylphenyl)-2-imidazolidinylidene]dichloro(3-methyl-2-butenylidene) (tricyclohexylphosphine)ruthenium(II) (C827); [1,3-bis-(2,4,6-trimethylphenyl)-2-imidazolidinylidene] dichloro(3-methyl-2-butenylidene) (diethylphenylphosphine)ruthenium(II) (C713); [1,3-bis-(2,4,6-trimethylphenyl)-2-imidazolidinylidene]dichloro(3-methyl-2-butenylidene) (tri-n-butylphosphine)ruthenium(II) (C749); [1,3-bis-(2,4,6-trimethylphenyl)-2-imidazolidinylidene] dichloro(phenylindenylidene) (triphenylphosphine)ruthenium(II) (C931); [1,3-bis-(2,4,6-trimethylphenyl)-2-imidazolidinylidene]dichloro(phenylindenylidene)(methylphenylphosphine)ruthenium(II) (C869); [1,3-bis-(2,4,6-trimethylphenyl)-2-imidazolidinylidene]dichloro(phenylindenylidene) (tricyclohexylphosphine)ruthenium(II) (C949); [1,3-bis-(2,4,6-trimethylphenyl)-2-imidazolidinylidene]dichloro(phenylindenylidene) (diethylphenylphosphine)ruthenium(II) (C835); and [1,3-bis-(2,4,6-trimethylphenyl)-2-imidazolidinylidene]dichloro(phenylindenylidene) (tri-n-butylphosphine)ruthenium(II) (C871).

Still further catalysts useful in ROMP reactions, and/or in other metathesis reactions, such as ring-closing metathesis, cross metathesis, ring-opening cross metathesis, self-metathesis, ethenolysis, alkenolysis, acyclic diene metathesis polymerization, and combinations thereof, include the following structures:

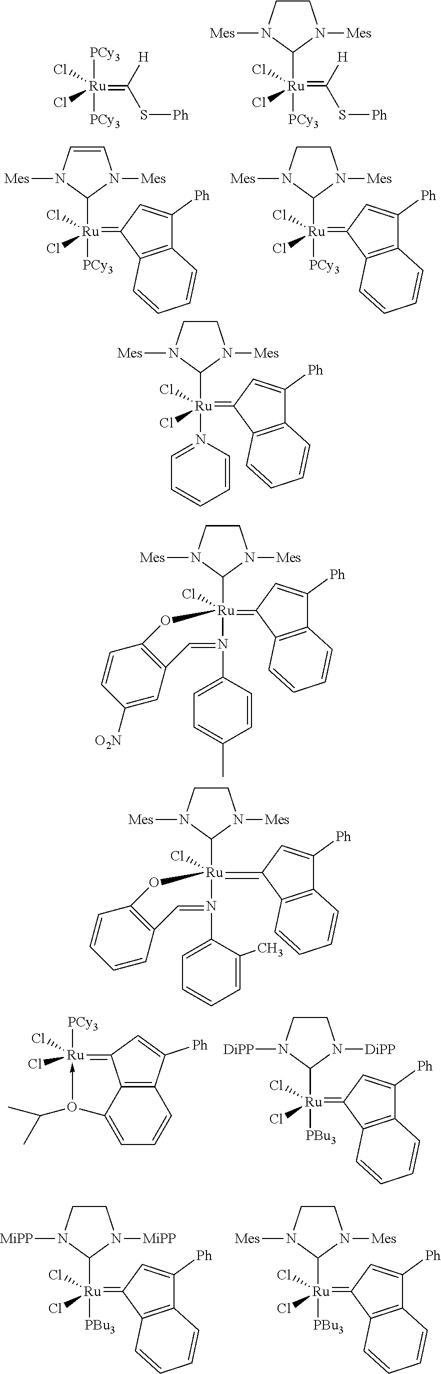

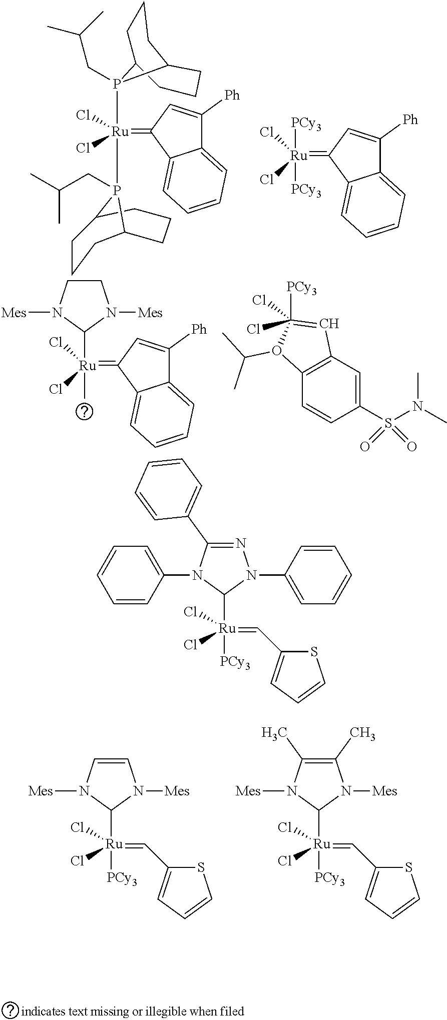

In general, the transition metal complexes used as catalysts herein can be prepared by several different methods, such as those described by Schwab et al. (1996) J. Am. Chem. Soc. 118:100-110, Scholl et al. (1999) Org. Lett. 6:953-956, Sanford et al. (2001) J. Am. Chem. Soc. 123:749-750, U.S. Pat. Nos. 5,312,940, and 5,342,909, the disclosures of which are incorporated herein by reference. Also see U.S. Pat. Pub. No. 2003/0055262 to Grubbs et al., WO 02/079208, and U.S. Pat. No. 6,613,910 to Grubbs et al., the disclosures of which are incorporated herein by reference. Synthetic methods are described in WO 03/11455A1 to Grubbs et al., the disclosure of which is incorporated herein by reference.

Metal carbene olefin metathesis catalysts may be Group 8 transition metal complexes having the structure of formula (I) commonly called “First Generation Grubbs” catalysts, formula (III) commonly called “Second Generation Grubbs” catalysts, or formula (VII) commonly called “Grubbs-Hoveyda” catalysts.

Metal carbene olefin metathesis catalysts may have the structure of formula (I)

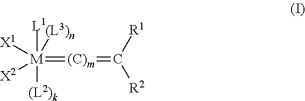

wherein:
   M is a Group 8 transition metal;
   L¹, L², and L³ are neutral electron donor ligands;
   n is 0 or 1;
   m is 0, 1, or 2;
   k is 0 or 1;
   X¹ and X² are anionic ligands;
   R¹ and R² are independently selected from hydrogen, hydrocarbyl, substituted hydrocarbyl, heteroatom-containing hydrocarbyl, substituted heteroatom-containing hydrocarbyl, and functional groups,
   wherein any two or more of X¹, X², L¹, L², L³, R¹, and R² can be taken together to form one or more cyclic groups, and further wherein any one or more of X¹, X², L¹, L², L³, R¹, and R² may be attached to a support;
and formula (VII)

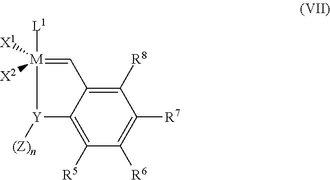

wherein:
   M is a Group 8 transition metal;
   L¹ is a neutral electron donor ligand;
   X¹ and X² are anionic ligands;
   Y is a heteroatom selected from O or N;
   R⁵, R⁶, R⁷, and R⁸ are independently selected from hydrogen, hydrocarbyl, substituted hydrocarbyl, heteroatom-containing hydrocarbyl, substituted heteroatom-containing hydrocarbyl, and functional groups;
   n is 0, 1, or 2; and
   Z is selected from hydrogen, hydrocarbyl, substituted hydrocarbyl, heteroatom-containing hydrocarbyl, substituted heteroatom-containing hydrocarbyl, and functional groups,
   wherein any combination of Y, Z, R⁵, R⁶, R⁷, and R⁸ can be linked to form one or more cyclic groups, and further wherein any combination of X¹, X², L¹, Y, Z, R⁵, R⁶, R⁷, and R⁸ may be attached to a support.

Metal carbene olefin metathesis catalysts may have the structure of formula (I)

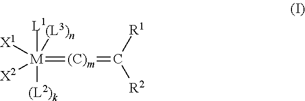

wherein:
   M is ruthenium;
   n is 0;
   m is 0;
   k is 1;
   L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
   X¹ and X² are chloride; and
   R¹ is hydrogen and R² is phenyl or —CH═C(CH₃)₂ or thienyl; or R¹ and R² are taken together to form 3-phenyl-1H-indene;
and formula (VII)

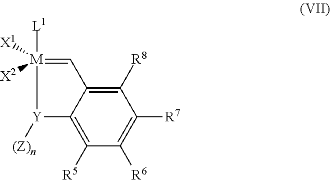

wherein:
   M is ruthenium;
   L¹ is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
   X¹ and X² are chloride;
   Y is oxygen;
   R⁵, R⁶, R⁷, and R⁸ are each hydrogen;
   n is 1; and
   Z is isopropyl.

An example of metal carbene olefin metathesis catalysts having the structure of formula (I)

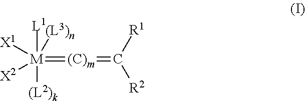

wherein:
   M is ruthenium;
   n is 0;
   m is 0;
   k is 1;
   L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
   X¹ and X² are chloride; and
   R¹ is hydrogen and R² is phenyl or —CH═C(CH₃)₂ or thienyl; or R¹ and R² are taken together to form an indenylidene moiety.

An example of metal carbene olefin metathesis catalysts having the structure of formula (VII)

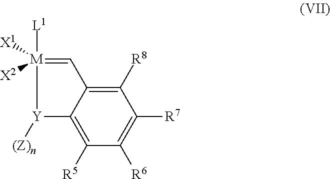

wherein:
   M is ruthenium;
   L¹ is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene;
   X¹ and X² are chloride;
   Y is oxygen;
   R⁵, R⁶, R⁷, and R⁸ are each hydrogen;
   n is 1; and
   Z is isopropyl.

An example of a metal carbene olefin metathesis catalyst having the structure of formula (XV):

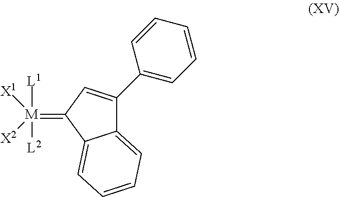

wherein:
   M is ruthenium;
   X¹ and X² are chloride; and
   L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ is an N-heterocyclic carbene selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or L¹ and L² are N-heterocyclic carbenes independently selected from the group consisting of 1,3-bis(2,4,6-trimethylphenyl)-2-imidazolidinylidene, 1,3-bis(2,4,6-trimethylphenyl)imidazol-2-ylidene, 1,3-bis(2,6-di-isopropylphenyl)-2-imidazolidinylidene, and 1,3-bis(2,6-di-isopropylphenyl)imidazol-2-ylidene.

Metal carbene olefin metathesis catalysts include, for example, Umicore's Ruthenium Metathesis Grubbs Catalysts® 1st Generation M101 (dichloro(3-phenyl-1H-inden-1-ylidene)bis(tricyclohexylphosphine)ruthenium(II)) M102 (dichloro(benzylidene)bis(tricyclohexylphosphine)ruthenium(II)), M103 (dichloro(3-methyl-2-butenylidene)bis(tricyclohexylphosphine)ruthenium(II)), M104 (dichloro(2-thienylmethylene)bis(tricyclohexylphosphine)ruthenium(II)), and M110 (dichlorobis(isobutylphobane)(3-phenyl-1H-indenylidene)ruthenium(II)); Umicore's Ruthenium Metathesis Grubbs Catalysts® 2nd Generation M200 ([1,3-bis(2,4,6-trimethylphenyl)-2-imidazolidinylidene]dichloro(3-phenyl-1H-inden-1-ylidene) (triphenylphosphine)ruthenium(II)), M201 ([1,3-bis(2,6-diisopropylphenyl)-2-imidazolidinylidene]dichloro(3-phenyl-1H-inden-1-ylidene) (triphenylphosphine)ruthenium(II)), M202 ([1,3-bis(2,4,6-trimethylphenyl)-2-imidazolidinylidene]dichloro(3-phenyl-1H-inden-1-ylidene)(tricyclohexylphosphine)ruthenium(II)), M203 ([1,3-bis(2,4,6-trimethylphenyl)imidazol-2-ylidene]dichloro(3-phenyl-1H-inden-1-ylidene) (tricyclohexylphosphine)ruthenium(II)), M204 ([1,3-Bis(2,4,6-trimethylphenyl)-2-imidazolidinylidene]dichloro(benzylidene) (tricyclohexylphosphine)ruthenium(II)), M206 ([1,3-bis(2,6-diisopropylphenyl)-2-imidazolidinylidene]-dichloro(benzylidene)(tricyclohexylphosphine)ruthenium(II)), M207 ([1,3-Bis(2,4,6-trimethylphenyl)-2-imidazolidinylidene]dichloro(3-methyl-2-butenylidene)(tricyclohexylphosphine)ruthenium(II)), M208 ([4,5-Dimethyl-1,3-bis(2,4,6-trimethylphenyl)imidazol-2-ylidene]-dichloro(2-thienylmethylene)(tricyclohexylphosphine)ruthenium(II)), M209 ([1,3-Bis(2,4,6-trimethylphenyl)imidazol-2-ylidene]dichloro(2-thienylmethylene) (tricyclohexylphosphine)ruthenium(II)), and M220 (cis-[1,3-bis(2,4,6-trimethylphenyl)-2-imidazolidinylidene]dichloro(3-phenyl-1H-inden-1-ylidene)(triisopropylphosphite)ruthenium(II)); Umicore's Ruthenium Metathesis Grubbs Catalysts® 2nd Generation (N ligands) M310 ([1,3-bis(2,4,6-trimethylphenyl)-2-imidazolidinylidene]dichloro(3-phenyl-1H-inden-1-ylidene) (pyridyl)ruthenium(II)) and M350 (1,3-bis(2,4,6-trimethylphenyl)-2-imidazolidinylidene]-[2-[[(2-methylphenyl)imino]methyl]-phenolyl]-[3-phenyl-1H-inden-1-ylidene](chloro)ruthenium(II)); Umicore's Ruthenium Metathesis Hoveyda-Grubbs Catalysts® 1st/2nd Generation M700 (dichloro(2-isopropoxybenzylidene) (tricyclohexylphosphine)ruthenium(II)), M710 ([1,3-bis(2,4,6-trimethylphenyl)-2-imidazolidinylidene]dichloro[(2-isopropoxy) (5-trifluoroacetamido)benzylidene]ruthenium(II)), M711 ([1,3-bis(2,6-diisopropylphenyl)-2-imidazolidinylidene]dichloro[(2-isopropoxy) (5-trifluoroacetamido)benzylidene]ruthenium(II)), M720 ([1,3-bis-(2,4,6-trimethylphenyl)-2-imidazolidinylidene]dichloro(2-isopropoxybenzylidene)ruthenium(II)), M721 ([1,3-bis-(2-tolyl)-2-imidazolidinylidene]dichloro(2-isopropoxybenzylidene)ruthenium(II)), M722 ([1,3-bis-(2,6-diisopropylphenyl)-2-imidazolidinylidene]dichloro(2-isopropoxybenzylidene)ruthenium(II)), M730 ([1,3-bis(2,4,6-trimethylphenyl)-2-imidazolidinylidene]dichloro[5-(isobutoxycarbonylamido)-2-isopropoxybenzylidene]ruthenium(II)), and M731 ([1,3-bis(2,6-diisopropylphenyl)-2-imidazolidinylidene]dichloro[5-(isobutoxycarbonylamido)-2-isopropoxybenzylidene]ruthenium(II)); Umicore's Bis-NHC Ruthenium Metathesis Grubbs Catalysts® 2nd Generation M800 (bis[1,3-bis(2,4,6-trimethylphenyl)-2-imidazolidinylidene]dichloro(3-phenyl-1H-inden-1-ylidene)ruthenium(II)); and Umicore's Z-Selective Ruthenium Metathesis Hoveyda-Grubbs Catalysts® 2nd Generation M2001 (1-[Rel-(2R,5R,7R)-adamantane-2,1-diyl][3-(2,4,6-trimethylphenyl)]2-imidazolidinylylidene](nitrato-O,O′) (o-isopropoxybenzylidene)ruthenium(II)).

The metal carbene olefin metathesis catalyst that may also be used in the invention include those, for example, disclosed in PCT/US2021/045673, the disclosure of which is incorporated herein by reference.

Suitable supports for any of the catalysts described herein may be of synthetic, semi-synthetic, or naturally occurring materials, which may be organic or inorganic, e.g., polymeric, ceramic, or metallic. Attachment to the support will generally, although not necessarily, be covalent, and the covalent linkage may be direct or indirect. Indirect covalent linkages are typically, though not necessarily, through a functional group on a support surface. Ionic attachments are also suitable, including combinations of one or more anionic groups on the metal complexes coupled with supports containing cationic groups, or combinations of one or more cationic groups on the metal complexes coupled with supports containing anionic groups.

When utilized, suitable supports may be selected from silicas, silicates, aluminas, aluminum oxides, silica-aluminas, aluminosilicates, zeolites, titanias, titanium dioxide, magnetite, magnesium oxides, boron oxides, clays, zirconias, zirconium dioxide, carbon, polymers, cellulose, cellulosic polymers amylose, amylosic polymers, or a combination thereof. The support may comprise silica, a silicate, or a combination thereof.

It is also possible to use a support that has been treated to include functional groups, inert moieties, and/or excess ligands. Any of the functional groups described herein are suitable for incorporation on the support, and may be generally accomplished through techniques known in the art. Inert moieties may also be incorporated on the support to generally reduce the available attachment sites on the support, e.g., to control the placement, or amount, of a complex linked to the support.

The metal carbene olefin metathesis catalyst may be utilized in olefin metathesis reactions according to techniques known in the art. The metal carbene olefin metathesis catalyst are typically added to the coating composition as a solid, a solution, or as a suspension. When the metal carbene olefin metathesis catalyst is added to the coating composition as a suspension, the metal carbene olefin metathesis catalyst is suspended in a carrier oil, such as mineral oil, paraffin oil, soybean oil, tri-isopropylbenzene, or any hydrophobic liquid which has a sufficiently high viscosity so as to permit effective dispersion of the catalyst(s), and which is sufficiently inert and which has a sufficiently high boiling point so that is does not act as a low-boiling impurity in the olefin metathesis reaction. It will be appreciated that the amount of catalyst that is used (i.e., the “catalyst loading”) in the reaction is dependent upon a variety of factors such as the identity of the reactants and the reaction conditions that are employed. Therefore, the catalyst loading may be optimally and independently chosen for each reaction. In general, however, the catalyst will be present in an amount that ranges from a low of about 0.1 ppm, 1 ppm, or 5 ppm, to a high of about 10 ppm, 15 ppm, 25 ppm, 50 ppm, 100 ppm, 200 ppm, 500 ppm, or 1000 ppm relative to the amount of an olefinic substrate.

The catalyst will generally be present in an amount that ranges from a low of about 0.00001 mol %, 0.0001 mol %, or 0.0005 mol %, to a high of about 0.001 mol %, 0.0015 mol %, 0.0025 mol %, 0.005 mol %, 0.01 mol %, 0.02 mol %, 0.05 mol %, or 0.1 mol % relative to the cyclic olefin(s) present in the cyclic olefin composition.

When expressed as the molar ratio of monomer to catalyst, the catalyst (the “monomer to catalyst ratio”), loading will generally be present in an amount that ranges from a low of about 10,000,000:1, 1,000,000:1, or 200,00:1, to a high of about 100,000:1 66,667:1, 40,000:1, 20,000:1, 10,000:1, 5,000:1, or 1,000:1.

The metathesis reactions disclosed herein may be carried out under a dry, inert atmosphere. Such an atmosphere may be created using any inert gas, including such gases as nitrogen and argon. The use of an inert atmosphere is optimal in terms of promoting catalyst activity, and reactions performed under an inert atmosphere typically are performed with relatively low catalyst loading. The reactions disclosed herein may also be carried out in an oxygen-containing and/or a water-containing atmosphere, and the reactions may be carried out under ambient conditions. The presence of oxygen or water in the reaction may, however, necessitate the use of higher catalyst loadings as compared with reactions performed under an inert atmosphere. Where the vapor pressure of the reactants allows, the reactions disclosed herein may also be carried out under reduced pressure.

The reactions disclosed herein may be carried out in a solvent, and any solvent that is inert towards cross-metathesis may be employed. Generally, solvents that may be used in the metathesis reactions include organic, protic, or aqueous solvents, such as aromatic hydrocarbons, chlorinated hydrocarbons, ethers, aliphatic hydrocarbons, alcohols, water, or mixtures thereof. Example solvents include benzene, toluene, p-xylene, methylene chloride, 1,2-dichloroethane, dichlorobenzene, chlorobenzene, tetrahydrofuran, diethyl ether, pentane, methanol, ethanol, water, or mixtures thereof. The reactions disclosed herein may be carried out neat, i.e., without the use of a solvent.

It will be appreciated that the temperature at which a metathesis reaction according to methods disclosed herein is conducted can be adjusted as needed, and may be at least about 78° C., 40° C., −10° C., 0° C., 10° C., 20° C., 25° C., 35° C., 50° C., 70° C., 100° C., or 150° C., or the temperature may be in a range that has any of these values as the upper or lower bounds. The reactions may be carried out at a temperature of at least about 35° C., or the reactions are carried out at a temperature of at least about 50° C.

When expressed as the wt. % of catalyst, the at least one metal carbene olefin metathesis catalyst may be present in the olefinic resin composition in an amount ranging from about 0.01-40 wt. % (e.g., 0.1-35 wt. %, 1-35 wt. %, 5-25 wt. %, 10-20 wt. %), based on the total weight of the olefinic resin composition.

### Thermoplastic Hydrocarbon Resins

The coating composition of the invention may contain at least one thermoplastic hydrocarbon resin.

Thermoplastic hydrocarbon resins that may be used in the coating compositions of the invention can be any that is known in the art. Thermoplastic hydrocarbon resins include, but are not limited to, PMR, DCPD, C5, C9, C5/C9, terpene, and IC thermoplastic resins, for example, as well as hydrogenated, partially-hydrogenated, and non-hydrogenated versions of these resins, and mixtures thereof.

The term “C5 thermoplastic resin” as used herein means aliphatic C5 hydrocarbon thermoplastic resins that are produced from the polymerization of monomers comprising C5 and/or C6 olefin species boiling in the range from about 20° C. to about 200° C. at atmospheric pressure. These monomers are typically generated from petroleum processing, e.g., cracking. The aliphatic C5 hydrocarbon thermoplastic resins of this invention can be produced by any method known in the art. The aliphatic C5 hydrocarbon thermoplastic resins may be prepared by cationic polymerization of a cracked petroleum feed containing C5 and C6 paraffins, olefins, and diolefins also referred to as “C5 monomers.” These monomer streams are comprised of cationically polymerizable monomers such as 1,3-pentadiene which is the primary reactive component along with cyclopentene, pentene, 2-methyl-2-butene, 2-methyl-2-pentene, cyclopentadiene, and dicyclopentadiene. The polymerizations are catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). In addition to the reactive components, nonpolymerizable components in the feed include saturated hydrocarbons that are in some instances co-distilled with the unsaturated components such as pentane, cyclopentane, or 2-methylpentane. Solid acid catalysts can also be utilized to produce aliphatic C5 hydrocarbon thermoplastic resins. Aliphatic C5 hydrocarbon thermoplastic resins include non-hydrogenated, partially hydrogenated, or fully hydrogenated resins. Aliphatic C5 thermoplastic resins can be obtained as Piccotac® C5 and Eastotac® C5 H₂ thermoplastic resins from Eastman Chemical Company (Kingsport, Tenn., US).

The term “C5/C9 thermoplastic resin” as used herein means an aliphatic/aromatic hydrocarbon C5/C9 thermoplastic resin that is produced from the polymerization of monomers comprising at least one unsaturated aromatic C8, C9, and/or C10 species boiling in the range from about 100° C. to about 300° C. at atmospheric pressure and at least one monomer comprising C5 and/or C6 olefin species boiling in the range from about 20° C. to about 200° C. at atmospheric pressure. C5 and/or C6 species may include paraffins, olefins, and diolefins also referred to as “C5 monomers.” These monomer streams are comprised of cationically polymerizable monomers such as 1,3-pentadiene which is the primary reactive component along with cyclopentene, pentene, 2-methyl-2-butene, 2-methyl-2-pentene, cyclopentadiene, and dicyclopentadiene. Unsaturated aromatic C8, C9, and/or C10 monomers may be derived from petroleum distillates resulting from naphtha cracking and are referred to as “C9 monomers.” These monomer streams are comprised of cationically polymerizable monomers such as styrene, alpha methyl styrene, beta-methyl styrene, vinyl toluene, indene, dicyclopentadiene, divinylbenzene, and other alkyl substituted derivatives of these components. The cationic polymerization is in some instances catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). Solid acid catalysts are also utilized to produce aliphatic/aromatic C5/C9 hydrocarbon thermoplastic resins. In addition to the reactive components, non-polymerizable components include, aromatic hydrocarbons such as xylene, ethyl benzene, cumene, ethyl toluene, indane, methylindane, naphthalene and other similar specifies. The non-polymerizable components of the feed stream may be incorporated into the thermoplastic resins via alkylation reactions. Aliphatic/aromatic C5/C9 hydrocarbon thermoplastic resins include non-hydrogenated, partially hydrogenated resins, and hydrogenated resins. Aliphatic/aromatic C5/C9 thermoplastic resins can be obtained as Piccotac® thermoplastic resin from Eastman Chemical Company. The proportion of C5 to C9 is not limited. In other words, the amount of C5 monomer in the C5/C9 thermoplastic resin can be anywhere from 0.1 to 100% and vice versa the amount of C9 monomer in the C5/C9 thermoplastic resin can be from 0.1 to 100%.

The term “C9 thermoplastic resin” as used herein means an aromatic C9 hydrocarbon thermoplastic resin that is a thermoplastic resin produced from the polymerization of monomers comprising unsaturated aromatic C8, C9, and/or C10 species boiling in the range from about 100° C. to about 300° C. at atmospheric pressure. These monomers are typically generated from petroleum processing, e.g., cracking. The aromatic C9 hydrocarbon thermoplastic resins of this invention can be produced by any method known in the art. Aromatic C9 hydrocarbon thermoplastic resins may be prepared by cationic polymerization of aromatic C8, C9, and/or C10 unsaturated monomers derived from petroleum distillates resulting from naphtha cracking and are referred to as “C9 monomers.” These monomer streams are comprised of cationically polymerizable monomers such as styrene, alpha methyl styrene (AMS), beta-methyl styrene, vinyl toluene, indene, dicyclopentadiene, divinylbenzene, and other alkyl substituted derivatives of these components. Aliphatic olefin monomers with four to six carbon atoms are also present during polymerization in some C9 resins. The polymerization is in some instances catalyzed using Friedel-Crafts polymerization catalysts such as Lewis acids (e.g., boron trifluoride (BF₃), complexes of boron trifluoride, aluminum trichloride (AlCl₃), and alkyl aluminum chlorides). In addition to the reactive components, nonpolymerizable components include, but are not limited to, aromatic hydrocarbons such as xylene, ethyl benzene, cumene, ethyl toluene, indane, methylindane, naphthalene, and other similar chemical species. The nonpolymerizable components of the feed stream may be incorporated into the thermoplastic resins via alkylation reactions. C9 hydrocarbon thermoplastic resins include non-hydrogenated, partially hydrogenated, or fully hydrogenated resins. Aromatic C9 hydrocarbon thermoplastic resins can be obtained as Picco®. C9 thermoplastic resin, and aliphatic hydrogenated and aliphatic/aromatic partially hydrogenated C9 H₂ hydrocarbon thermoplastic resins can be obtained as Regalite® thermoplastic resin from Eastman Chemical Company.

The term “DCPD thermoplastic resin” as used herein means dicyclopentadiene (DCPD) thermoplastic resin, most commonly formed through ring opening metathesis polymerization (ROMP) of dicyclopentadiene in the presence of a strong acid catalyst, such as maleic acid or aqueous sulphuric acid, or thermal polymerization. Dicyclopentadiene may also be formed by a Diels Alder reaction from two cyclopentadiene molecules and exists in two stereo-isomers:endo-DCPD and exo-DCPD. Typically, greater than 90% of the DCPD molecules present in commercial grades of DCPD are in the endo form. DCPD thermoplastic resins include aromatic-modified DCPD resins as well as hydrogenated, partially hydrogenated, and non-hydrogenated resins, though in most instances herein only H₂ DCPD is described since it is the most readily commercially available form of DCPD. Aromatic-modified DCPD is also contemplated as a DCPD thermoplastic resin. Aromatic modification is, for instance, by way of C9 resin oil, styrene, or alpha methyl styrene (AMS), and the like. Hydrogenated and partially hydrogenated DCPD and hydrogenated and partially hydrogenated aromatic-modified DCPD resin is commercially available as Escorez® 5000-series resin (ExxonMobil Chemical Company, TX, US).

The term “IC thermoplastic resin” or “IC resin” as used herein means indene-coumarone (IC) thermoplastic resin, i.e., a synthetic thermoplastic terpene resin formed using feedstocks of indene and coumarone made from heavy-solvent naphtha obtained from the distillation of coal tar, which is a by-product of coke production. Heavy-solvent naphtha is rich in coumarone and indene, but most especially indene, and can be modified with phenol. These feedstocks can be formed by polymerization in BF₃ or BF₃ etherates. Catalysts can be removed by an alkaline wash or lime after polymerization. The resin can be isolated by steam distilling off the unreacted naphtha. IC thermoplastic resins can be used as plasticizers, and secure stress-strain properties at high levels. Examples of such resins include Novares® C indene-coumarone and Novares® CA phenol-modified indene-coumarone thermoplastic resin, which are commercially available from Rutgers Germany GmbH, Duisburg, Germany.

The term “PMR” as used herein means pure monomer thermoplastic resins. Pure monomer thermoplastic resins are produced from the polymerization of styrene-based monomers, such as, styrene, alpha-methyl styrene, vinyl toluene, and other alkyl substituted styrenes. Pure monomer thermoplastic resins are produced by any method known in the art. Pure monomer feedstock for the production of pure monomer thermoplastic resins are in some cases synthetically generated or highly purified monomer species. For example, styrene can be generated from ethyl benzene or alpha methyl styrene from cumene. Pure monomer hydrocarbon thermoplastic resins may be prepared by cationic polymerization of styrene-based monomers such as styrene, alpha-methyl styrene, vinyl toluene, and other alkyl substituted styrenes using Friedel-Crafts polymerization catalysts such as Lewis acids (e.g., boron trifluoride (BF₃), complexes of boron trifluoride, aluminum trichloride (AlCl₃), and alkyl aluminum chlorides). Solid acid catalysts can also be utilized to produce pure monomer thermoplastic resins. The pure monomer thermoplastic resins disclosed herein are non-hydrogenated, partially hydrogenated, or fully hydrogenated resins.

The term “hydrogenated” as used herein is also indicated alternatively in the shorthand “H₂” and when H₂ is used preceding or following a resin type it is intended to indicate that resin type is hydrogenated or partially hydrogenated, such as “PMR H₂” and “C5 H₂” for example. When “H₂” is used herein, ““H₂” is meant to encompass both fully hydrogenated resin samples and partially hydrogenated resin samples. Thus, “H₂” refers to the condition in which the resin is either fully hydrogenated or at least partially hydrogenated. Pure monomer thermoplastic resins are in some instances obtained as Piccolastic® styrenic hydrocarbon thermoplastic resins, Kristalex® styrenic/alkyl styrenic hydrocarbon thermoplastic resins, Piccotex® alkyl styrenic hydrocarbon thermoplastic resins, and Regalrez® hydrogenated or partially hydrogenated pure monomer thermoplastic resins from Eastman Chemical Company (Kingsport, Tenn., US).

The term “terpene thermoplastic resin” or “polyterpene resin” as used herein means thermoplastic resins produced from at least one terpene monomer. For example, α-pinene, β-pinene, d-limonene, and dipentene can be polymerized in the presence of aluminum chloride to provide polyterpene thermoplastic resins. Other examples of polyterpene thermoplastic resins include Sylvares® TR 1100 and Sylvatraxx® 4125 terpene thermoplastic resin (AZ Chem Holdings, LP, Jacksonville, Fla., US), and Piccolyte® A125 terpene thermoplastic resin (Pinova, Inc., Brunswick, Ga., US). Terpene thermoplastic resins can also be modified with aromatic compounds. Sylvares® ZT 105LT and Sylvares® ZT 115 LT terpene thermoplastic resins are aromatically modified (Az Chem Holdings, LP, Jacksonville, Fla., US).

Preferably, the thermoplastic hydrocarbon resin is selected from the group consisting of wherein the thermoplastic hydrocarbon resin is selected from the group consisting of PB-100, Nevchem® 100, LX®-2181, Nevchem® 140, and mixtures thereof.

It is to be understood that encompassed by the above definitions of certain types of thermoplastic hydrocarbon resins, such as DCPD, PMR, C5, C9, C5/C9, IC, terpene, and the like, including hydrogenated, partially-hydrogenated, and non-hydrogenated versions of these resins, that these thermoplastic hydrocarbon resins include resins of similar types generated by mixing or blending of dissimilar feedstocks to produce heterogeneous mixtures of the feedstocks used to generate the thermoplastic hydrocarbon resins. Furthermore, it is to be understood that at least with respect to the PMR and terpene thermoplastic hydrocarbon resins discussed herein these thermoplastic hydrocarbon resins encompass various known derivatives of such thermoplastic hydrocarbon resins such as phenol-modified and rosin-modified versions of the resins.

The at least one thermoplastic hydrocarbon resin that may be used in the invention include, for example, the thermoplastic hydrocarbon resins disclosed in PCT/US2021/045673, the disclosure of which is incorporated herein by reference.

The thermoplastic hydrocarbon resin may have a number average molecular weight between 200 and 3000 g/mol.

The thermoplastic hydrocarbon resin may have a glass transition temperature in the range of 30 to 150° C. (e.g., 40 to 140° C., 50 to 130° C., 60 to 120° C., 70 to 110° C., 80 to 100° C., 90 to 95° C.).

The thermoplastic hydrocarbon resin may be present in the coating composition in an amount ranging from 0-about 25 wt. % (e.g., 0-21 wt. %, 0.01-20 wt. %, 0.1-15 wt. %, 0.5-10 wt. %, 1-9 wt. %, 2-8 wt. %, 3-7 wt. %, 4-6 wt. %), based on the total weight of the coating composition.

### Inorganic Fillers

The coating composition of the invention may be optionally formulated with inorganic fillers. Inorganic fillers that may be used in the coating compositions of the invention include, without limitation, such as, for example, aluminum powder or alloys thereof, aluminum flakes (e.g., aluminum flake paste) or alloys thereof, zinc aluminum flakes (e.g., zinc aluminum flake paste) or alloys thereof, micaceous iron oxide, mica, glass flakes, calcium metasilicate, wollastonite, talc, calcium carbonate, barium sulfate, silica, dolomite, silicates, kaolin, feldspar, carbon nanotubes, and graphene.

Preferred inorganic fillers include mica, micaceous iron oxide, aluminum flakes (paste), Zn Al flakes (paste), talc, glass flake, and mixtures thereof. Metallic flakes such as zinc, aluminum, magnesium, nickel, etc. can be added as inorganic fillers to coatings as sacrificial anodes to provide cathodic protection. They can also be used in combination with electrically conducting fillers as taught in U.S. Pat. No. 7,794,626, the disclosure of which is incorporated herein by reference, to provide galvanic anti-corrosion protection to the substrates.

The inorganic filler in the coating composition of the invention may be present in the coating composition in an amount ranging from about 0-70 wt. % (e.g., 0.1-65 wt. % 0.5-60 wt. %, 1-55 wt. %, 5-50 wt. %, 10-45 wt. %, 15-40 wt. %, 20-35 wt. %, 25-30 wt. %), based on the total weight of the coating composition. In some preferred embodiments, 0-about 20 wt. % (e.g., 0.05-15 wt. %, 0.1 to 10 wt. %, 0.5 to 5 wt. %, 1 to 4 wt. %, 2 to 3 wt. %) or about 14-64 wt. % (e.g., 27-58 wt. %) of the inorganic filler may be present in the coating composition, based on the total weight of the coating composition.

### Adhesion Promoters

The adhesion promoter used in the coating composition of the invention may be selected from functionalized polyolefins.

For example, the polyolefin may be acid-functionalized. Acid-functionalized polyolefins that may be used as the adhesion promoter include those disclosed in U.S. Pat. No. 7,465,773, the disclosure of which is incorporated herein by reference. For example, adhesion promoters that may be used in the invention may be an acid-functionalized polyolefin, such as a polyolefin comprising maleic anhydride. The polyolefin may be unsaturated, comprising alkene moieties, such as polybutadiene. The polyolefin may have a vinyl content of no greater than 40, 35, or 30 wt. %. The polyolefin may have an average anhydride equivalent weight ranging from 200-5000 g/mole per anhydride group (e.g., no greater than 4000, 3000, 2000, 1000, or 500 g/mole per anhydride group). The polyolefin comprising maleic anhydride is a liquid, typically having a viscosity at 20 or 25° C. of at least 2000, 3000, 4000, or 5000 mPas. (DIN EN ISO 3219). The viscosity at 20 or 25° C. may be no greater than 75,000 mPas (e.g., no greater than 30,000, 25,000, 20,000, or 15,000 or 10,000 mPas; less than 1000 or 500 mPas). The polyolefin may have a viscosity of at least 50,000; 75,000; 100,000; 125,000; or 150,000 mPas at 45, 50, or 55° C. The viscosity is indicative of the molecular weight. The polyolefin may have a molecular weight (Mn) of no greater than 10,000; 9,000; 8,000; 7,000; 6,000; 5,000; 4,500; 4,000; 3,500; or 3,000 g/mole. The polyolefin may have a molecular weight (Mn) of at least 1,000, 1,100, 1,200, 1,300, 1,400, 1,500, 1,600, 1,700, 1,800, 1,900, or 2,000 g/mole. An acid-functionalized polyolefin that may be used as an adhesion promoter is polybutadiene modified with maleic anhydride (e.g., Cray Valley's Ricon® 130 MA8, Ricon® 130 MA13, Ricon® 130 MA20, Ricon 131 MA5, Ricon® 131 MA10, Ricon® 131 MA20, Ricon® 184 MA6, Ricobond® 1731 HS, Ricobond® 1756 HS, and Ricobond® 2031; Evonik's Polyvest® EP MA 100, Polyvest® MA 75, Polyvest® EP MV MA 60; and Synthomer's Lithene® Ultra PM4-7.5MA, Lithene® Ultra N4-B-10MA, Lithene® Ultra N4-5000-10 MA, Lithene® Ultra N4-5000-15 MA, Lithene® Ultra AL-15MA).

Other adhesion promoters that may be used in the invention include silane-functionalized polyolefins, such as a polyolefin comprising silane (also referred to herein as silane grafted polyolefin). The polyolefin may be unsaturated, comprising alkene moieties, such as polybutadiene. The average silane functionality per polymer chain may be between 0.1 and 2. The polyolefin comprising silane is a liquid, typically having a viscosity at 20 or 25° C. of at least 2000, 3000, 4000, 5000, 7500, 15000, or 30000 mPas. (DIN EN ISO 3219). The viscosity at 20 or 25° C. may be no greater than 75,000 mPas (e.g., no greater than 30,000, 25,000, 20,000, or 15,000 or 10,000 mPas; less than 1000 or 500 mPas). The polyolefin may have a viscosity of at least 50,000; 75,000; 100,000; 125,000; or 150,000 mPas at 45, 50, or 55° C. The viscosity is indicative of the molecular weight. The polyolefin may have a molecular weight (Mn) of no greater than 10,000; 9,000; 8,000; 7,000; 6,000; 5,000; 4,500; 4,000; 3,500; or 3,000 g/mole. The polyolefin may have a molecular weight (Mn) of at least 800, 900, 1,000, 1,100, 1,200, 1,300, 1,400, 1,500, 1,600, 1,700, 1,800, 1,900, or 2,000 g/mole. A silane-functionalized polyolefin that may be used as an adhesion promoter is silane functionalized polybutadiene (also referred to herein as silane grafted polybutadiene). Silane-functionalized polybutadienes include, without limitation, Cray Valley's Ricon® 603; Evonik's Polyvest® ST-E 60 and Polyvest® ST-E 100; and Shin Etsu's X-12-1267B, and X-12-1267B-ES

Epoxidized polybutadienes may also be used, including, without limitation, Nagase's DENALEX® R-15EPT and DENALEX® R-45EPT; and Cray Valley's Poly Bd® 605E and Poly Bd® 700S.

Silane and maleic anhydride modified polyolefins may also be used, including, without limitation, Shin Etsu's X-12-1287A.

Silane and epoxy modified adhesion promoters may also be used, including, without limitation, Shin Etsu's KR-516, an oligomeric coupling agent that contains reactive functional groups in addition to alkoxysilyl groups.

Isocyanate terminated polybutadiene prepolymers may also be used, including, without limitation, Cray Valley's Krasol® LBD2000 (TDI based), Krasol® LBD3000 (TDI based), Krasol® NN-22 (MDI based), Krasol® NN-23 (MDI based), and Krasol® NN-25 (MDI based).

Preferred adhesion promoters are functionalized polybutadienes, such as maleic anhydride-functionalized polybutadienes, silane-functionalized polybutadienes, epoxidized polybutadienes, silane and maleic anhydride modified polybutadienes, and mixtures thereof.

The at least one adhesion promoter may be a liquid.

The at least one adhesion promoter may have an acid content of between 0.1 to 100 mgKOH/g (e.g., 1 to 75 mgKOH/g, 5 to 50 mgKOH/g, 10 to 25 mgKOH/g, 15 to 20 mgKOH/g).

The adhesion promoter may be present in the coating composition in an amount ranging from about 0.01-10 wt. % (e.g., 0.05-9 wt. %, 0.05-6 wt. %, 0.1-8 wt. %, 0.5-7 wt. %, 1-6 wt. %, 2-5 wt. %, 3-4 wt. %), based on the total weight of the coating composition.

### Coating Additives

The coating composition of the invention may be optionally formulated with coating additives. Suitable coating additives include, but are not limited to, a gel modifier, a hardness modulator, an impact modifier, an antioxidant, an antiozonant, a binder, a thixotrope, a rheology modifier, a corrosion inhibitor, a dispersant, a wetting agent, a plasticizer, a pigment, a flame retardant, a dye, fibers, a reinforcement material, a coupling agent, a UV absorber, a UV light stabilizer, a film former, a lubricant.

Preferably, the coating additive is selected from the group consisting of at least one rheology modifier, at least one corrosion inhibitor, at least one pigment, and mixtures thereof.

Suitable rheology modifiers include inorganic and organic rheology modifiers. Inorganic rheology modifiers include clays and organoclays of hectorite, bentonite, attapulgite, kaolin, pyrophilite and talc; minerals such as fumed silica, precipitated silica, precipitated calcium carbonate, and montmorillonite, metal organic gellants such as zirconates, aluminates. Organic rheology modifiers include castor oil derivatives, modified polyurea, polyamides, calcium sulfonates, cellulose, shydrophobic ethoxylated urethane resins, Examples of suitable rheology modifiers include fumed silica such as Cab-O-Sil TS610, TS720 from Cabot Corp and AEROSIL 972, AEROSIL 974 from Evonik, organoclay such as BENTOLITE L-10, BENTOLITE-WH, CLAYTONE 40, CLAYTONE AF, MINERAL COLLOID BP, Garamite 7303 from BYK Chemie, USA; Bentonite 149, Bentonite 329, Bentonite 331, Bentonite 344 from Brentag Specialities, Attagel from BASF and the like, polyaminoamide phosphate, high molecular weight carboxylic acid salts of polyamine amides, and alkylene amine salts of an unsaturated fatty acid, all available from BYK Chemie USA as ANTI TERRA™, polyamide modified castor oil derivatives such as Luvotix ZH5, Luvitix ZH50 from Lehmann & Voss; micronized amide wax such as Crayvallac SUPER from Arkema. Preferred rheology modifiers are selected from fumed silica (e.g., Cab-O-Sil TS720), organoclay (e.g., Garamite 7303), and mixtures thereof.

The rheology modifier may be present in the coating composition in an amount ranging from about 0.01-10 wt. % (e.g., 0.05-9 wt. %, 0.1-8 wt. %, 0.5-7 wt. %, 1-6 wt. %, 2-5 wt. %, 3-4 wt. %), based on the total weight of the coating composition.

Suitable corrosion inhibitors include, without limitation, zinc-phosphate-based corrosion inhibitors, calcium borosilicate-based corrosion inhibitors, and zinc and aluminum-based corrosion inhibitors. Preferably, the corrosion inhibitor is selected from Halox SZP391, Halox CW-2230, Halox 700, and mixtures thereof.

The corrosion inhibitor may be present in the coating composition in an amount ranging from about 0.01-15 wt. % (e.g., 0.05-10 wt. %, 0.1-9 wt. %, 0.5-8 wt. %, 1-7 wt. %, 2-6 wt. %, 3-5 wt. %), based on the total weight of the coating composition.

Suitable pigments include, without limitation, carbon black, TiO₂, orange pigment dispersion, pigment Yellow 184 in mineral oil, TiO₂ in mineral oil, and Sudan Blue II. Preferably, the pigment is selected from carbon black, TiO₂, and mixtures thereof

The pigment may be present in the coating composition in an amount ranging from about 0.001-5 wt. % (e.g., 0.005-4 wt. %, 0.01-3 wt. %, 0.05-2 wt. %, 0.1-1 wt. %, 0.2-0.5 wt. %), based on the total weight of the coating composition.

The coating composition of the invention may be optionally formulated with or without a crosslinker, for example, a crosslinker selected from dialkyl peroxides, diacyl peroxides, and peroxyacids.

Antioxidants and antiozonants include any antioxidant or antiozonant used in the rubber or plastics industry. An “Index of Commercial Antioxidants and Antiozonants, Fourth Edition” is available from Goodyear Chemicals, The Goodyear Tire and Rubber Company, Akron, Ohio 44316. Suitable stabilizers (i.e., antioxidants or antiozonants) include without limitation: 2,6-di-tert-butyl-4-methylphenol (BHT); styrenated phenol, such as Wingstay® S (Goodyear); 2- and 3-tert-butyl-4-methoxyphenol; alkylated hindered phenols, such as Wingstay C (Goodyear); 4-hydroxymethyl-2,6-di-tert-butylphenol; 2,6-di-tert-butyl-4-sec-butylphenol; 2,2′-methylenebis(4-methyl-6-tert-butylphenol); 2,2′-methylenebis(4-ethyl-6-tert-butylphenol); 4,4′-methylenebis(2,6-di-tert-butylphenol); miscellaneous bisphenols, such as Cyanox® 53 (Cytec Industries Inc.) and Permanax WSO; 2,2′-ethylidenebis(4,6-di-tert-butylphenol); 2,2′-methylenebis(4-methyl-6-(1-methylcyclohexyl) phenol); 4,4′-butylidenebis(6-tert-butyl-3-methylphenol); polybutylated Bisphenol A; 4,4′-thiobis(6-tert-butyl-3-methylphenol); 4,4′-methylenebis(2,6-dimethylphenol); 1,1′-thiobis(2-naphthol); methylene bridged polyalkylphenol, such as Ethyl antioxidant 738; 2,2′-thiobis(4-methyl-6-tert-butylphenol); 2,2′-isobutylidenebis(4,6-dimethylphenol); 2,2′-methylenebis(4-methyl-6-cyclohexylphenol); butylated reaction product of p-cresol and dicyclopentadiene, such as Wingstay L; tetrakis(methylene-3,5-di-tert-butyl-4-hydroxyhydrocinnamate) methane, i.e., Irganox® 1010 (BASF); 1,3,5-trimethyl-2,4,6-tris(3,5-di-tert-butyl-4-hydroxybenzyl)benzene, e.g., Ethanox® 330 (Albemarle Corporation); 4,4′-methylenebis(2,6-di-tertiary-butylphenol), e.g., Ethanox 4702 or Ethanox 4710; 1,3,5-tris(3,5-di-tert-butyl-4-hydroxybenzyl) isocyanurate, i.e., Good-rite® 3114 (Emerald Performance Materials), 2,5-di-tert-amylhydroquinone, tert-butylhydroquinone, tris(nonylphenylphosphite), bis(2,4-di-tert-butyl) pentaerythritol)diphosphite, distearyl pentaerythritol diphosphite, phosphited phenols and bisphenols, such as Naugard® 492 (Chemtura Corporation), phosphite/phenolic antioxidant blends, such as Irganox B215; di-n-octadecyl(3,5-di-tert-butyl-4-hydroxybenzyl)phosphonate, such as Irganox 1093; 1,6-hexamethylene bis(3-(3,5-di-tert-butyl-4-hydroxyphenylpropionate), such as Irganox 259, and octadecyl-3,5-di-tert-butyl-4-hydroxyhydrocinnamate, i.e., Irganox 1076, tetrakis(2,4-di-tert-butylphenyl) 4,4′-biphenylylenediphosp honite, diphenylamine, and 4,4′-diemthoxydiphenylamine. Such materials are normally employed in the coating composition at levels of about 0.10 phr to 10 phr, such as at levels of about 0.1 phr to 5 phr.

Suitable fillers include, for example, metallic density modulators, microparticulate density modulators, such as, for example, microspheres, and macroparticulate density modulators, such as, for example, glass or ceramic beads. Metallic density modulators include, but are not limited to, powdered, sintered, shaved, flaked, filed, particulated, or granulated metals, metal oxides, metal nitrides, and/or metal carbides, and the like. Metallic density modulators include, among others, tungsten, tungsten carbide, aluminum, titanium, iron, lead, silicon oxide, aluminum oxide, boron carbide, and silicon carbide. Microparticulate density modulators include, but are not limited to, glass, metal, thermoplastic (either expandable or pre-expanded) or thermoset, and/or ceramic/silicate microspheres. Macroparticulate density modulators include, but are not limited to, glass, plastic, or ceramic beads; metal rods, chunks, pieces, or shot; hollow glass, ceramic, plastic, or metallic spheres, balls, or tubes; and the like.

The coating additive may be present in the coating compositions in an amount ranging from 0-about 25 wt. % (e.g., 0.01-20 wt. %, 0.05-15 wt. %, 0.1-14 wt. %, 0.5-13 wt. %, 1-12 wt. %, 2-11 wt. %, 3-10 wt. %, 4-9 wt. %, 5-8 wt. %, 6-7 wt. %), based on the total weight of the coating composition.

### Coating Composition

The coating composition of the invention may also comprise at least one substrate material. Additionally, the coating composition may be applied to at least one substrate material. The substrate material may be functionalized substrate material, such as, for example, a heteroatom-functionalized substrate, such as, for example, an amino-functionalized substrate. Additionally, the at least one substrate material may be, for example, a glass substrate material or carbon substrate material. Substrate materials may advantageously comprise an aminosilane-treated substrate.

The coating composition of the invention may additionally comprise an exogenous inhibitor. Exogenous inhibitors, or “gel modification additives,” for use in the invention are disclosed in U.S. Pat. No. 5,939,504, the disclosure of which is incorporated herein by reference. The coating composition of the invention may additionally comprise a hydroperoxide gel modifier. Hydroperoxide gel modifiers (e.g., cumene hydroperoxide) for use in the invention are disclosed in PCT/US2012/042850, the disclosure of which is incorporated herein by reference.

The coating composition of the invention may be made by combining the olefinic component, the metal carbene olefin metathesis catalyst, the optional thermoplastic hydrocarbon resin, the inorganic filler, the adhesion promoter, and the optional coating additive using any method known in the art.

The coating compositions of the invention are generally less sensitive to air and/or moisture than resins used to prepare polyurethane and epoxy-based polymers and DCPD polymers prepared from molybdenum and tungsten catalyzed DCPD resins (e.g., Telene® DCPD Resin, Metton® DCPD Resin, Pentam® DCPD Resin). Therefore, coating compositions of the invention are generally more robust to a wider array of environmental conditions (e.g., temperature, humidity, etc.). Resin systems that are less sensitive to air and/or moisture offer a benefit over more sensitive resin systems, particularly if objects are to be coated (corrosion prevention) at on-site marine environments, such as on boats, offshore oil rigs, offshore oil platforms, etc.

Furthermore, coating compositions of the invention offer improved ease of application over prior art coating compositions, particularly polypropylene systems. Unlike polypropylene systems, which are primarily limited to extrusion, coating compositions of the invention can be applied to an object and/or object surface by a variety of means including but not limited to pouring, casting, infusing, injecting, molding, spraying, rotationally molding, centrifugally casting, pultrusion, extrusion, etc. Moreover, coating compositions of the invention also offer improved ease of application over prior art coating compositions based on epoxy resins (e.g., elastomeric amine cured epoxy materials). Unlike epoxy-based resin systems (e.g., elastomeric amine cured epoxy materials), which are synthesized in at least two steps, coating compositions of the invention simply require a single mixing step (e.g., a coating composition of the invention is mixed with the catalyst composition of the invention) prior to application to an object surface or addition to a mold. Unlike DCPD resin systems containing molybdenum or tungsten two-component catalyst systems (e.g., Telene® DCPD Resin, Metton® DCPD Resin, Pentam® DCPD Resin), which require specialized and expensive processing and handling conditions and equipment, including specialized and expensive molds, injection equipment, and storage tanks, coating compositions of the invention can be applied to an object and/or object surface by a variety of means including but not limited to simple casting.

A particular benefit of the coating compositions of the invention is that they are easy to handle and can be easily formulated such that the resultant ROMP polymer and ROMP polymer composites, discussed below, meet the needs/requirements of the application or service. For example, coating compositions of the invention used to prepare ROMP polymers or ROMP polymer composites of the invention can be easily formulated such that the resultant ROMP polymers or ROMP polymer composites may exhibit a range of physical, mechanical and/or thermal properties spanning the range from elastomeric behavior and/or properties to rigid thermoset behavior and/or properties depending on the needs/requirements of the application.

### ROMP Polymers and ROMP Polymer Composites

The invention is also directed to ROMP polymers or ROMP polymer composites comprising, consisting essentially of, or consisting of the reaction product of the coating composition of the invention, wherein the coating composition is subjected to conditions effective to polymerize the coating composition.

The invention also relates to the ROMP polymer or ROMP polymer composite of the invention for use as anti-corrosion materials.

The invention also relates to the use of the ROMP polymer or the ROMP polymer composite for preventing corrosion of an object. For example, ROMP polymers and/or ROMP polymer composites of the invention can be used to prevent corrosion of any object from a surrounding environment or surrounding material, where the surrounding environment or surrounding material may be a gas (e.g., air), a fluid (liquid) (e.g., sea water, fresh water), or a solid (e.g., ice or subterranean solids as in the case of a buried pipeline), or mixtures thereof.

In particular, the ROMP polymer and ROMP polymer composite of the invention are suitable for anti-corrosion of objects, such as oil pipelines in cold water (e.g., cold sea water, cold fresh water). The ROMP polymer and ROMP polymer composite of the invention may also be used for preventing corrosion of other objects including but not limited to pipes, sub-sea pipes, pipelines, oil pipelines, subsea oil pipelines, subsea pipelines, pipe fittings, hose, hose fitting, tanks, containers, drums, manifolds, risers, field joints, configurations designated as Christmas tree (oil field Christmas tree, subsea Christmas tree), jumpers, spool pieces, configurations designated as pipeline end termination (PLET), configurations designated as pipeline end manifolds (PLEM), and other sub-sea architectures and equipment. The ROMP polymers and ROMP polymer composites of the invention may also be used to coat other objects such as robotic parts, devices and vehicles used in sub-sea applications. Moreover, the ROMP polymer and ROMP polymer composite of the invention may be used to construct anti-corrosion structures such as configurations designated as subsea dog houses.

The invention also relates to a process for a ROMP polymer coating for offshore applications, the process comprising, providing an object surface to be at least partially coated, encased, or contacting the object surface with the coating composition or applying the coating composition to the object surface, and subjecting the coating composition to conditions effective to polymerize the coating composition.

While the ROMP polymer and ROMP polymer composite of the invention are well suited for coating or encasing objects which are to be submerged in water (e.g., fresh water, salt water, sea water, etc.) the ROMP polymers and ROMP polymer composites may also be used to coat or encase objects which are not exposed to an aqueous environment.

ROMP polymers and ROMP polymer composites of the invention may be used for coating or encasing objects (e.g., pipes and/or other subsea structures) where the temperature of materials (e.g., hydrocarbons, oil, gas, etc.) transported by the objects (e.g., pipes and/or other structures) is greater than or equal to 160° C. Therefore, by default, ROMP polymers and/or ROMP polymer composites of the invention may also be used for coating or encasing objects (e.g., pipes and/or other subsea structures) where the temperature of materials (e.g., hydrocarbons, oil, gas, etc.) transported by the objects (e.g., pipes and/or other subsea structures) is less than 160° C.

The application of the coating composition of the invention to the object surface to be at least partially coated is carried out by methods known in the art, examples include, but are not limited to casting, centrifugal casting, pultrusion, molding, rotational molding, open molding, reaction injection molding (RIM), resin transfer molding (RTM), pouring, vacuum impregnation, surface coating, filament winding, cell casting, dip casting, continuous casting, embedding, potting, encapsulation, film casting or solvent casting, gated casting, mold casting, slush casting, extrusion, mechanical foaming, chemical foaming, physical foaming, compression molding or matched die molding, spray up, spraying, Vacuum Assisted Resin Transfer Molding (VARTM), Seeman's Composite Resin Infusion Molding Process (SCRIMP), blow molding, in mold coating, in-mold painting or injection, vacuum forming, Reinforced Reaction Injection Molding (RRIM), Structural Reaction Injection Molding (SRIM), thermal expansion transfer molding (TERM), resin injection recirculation molding (RICM), controlled atmospheric pressure resin infusion (CAPRI), hand-layup. For manufacturing techniques requiring the use of a RIM or impingement style mixhead, including without limitation RIM, SRIM, and RRIM, articles of manufacture may be molded using a single mixhead or a plurality of mixheads as well as a plurality of material injection streams (e.g., two resin streams and one catalyst stream).

The ROMP polymer and/or ROMP polymer composite of the invention need not necessarily be molded around an object to prevent corrosion. In the alternative, a ROMP polymer article and a ROMP polymer composite article may be independently prepared by a variety of methods known in the art and then subsequently affixed to or placed around an object to prevent corrosion of the object from the surrounding environment. Moreover, the means for affixing the ROMP polymer article and ROMP polymer composite article to an object may be by any known means including an adhesive means and/or mechanical means such as fasteners, bolts, screws, etc. For example, the ROMP polymer and a ROMP polymer composite can be pre-made into sections which are shaped to complement the object to be protected from corrosion. The pre-made sections may then be secured or affixed to the object using any known means.

Additionally, the object to be protected from corrosion may be pretreated with any known tie coat or primer, which is suitable to improve and/or enhance the adhesion of the ROMP polymer and ROMP polymer composite of the invention to the object. For example, the tie coat or primer may be first applied to the object to be protected from corrosion, then the coating composition of the invention may be applied to the object, and the coating composition is subsequently subjected to conditions effective to polymerize the coating composition. Furthermore, the tie coat or primer may be applied to the object to be protected from corrosion, and a pre-made ROMP polymer or pre-made ROMP polymer composite of the invention may be subsequently affixed to the object.

### Anti-Corrosion Materials

The invention is also directed to a anti-corrosion material comprising, consisting essentially of, or consisting of the coating composition, ROMP polymer, or ROMP polymer composite of the invention.

The ROMP polymer and ROMP polymer composite of the invention offer improved thermal stability and/or improved hydrolytic stability over prior art anti-corrosion materials. Anti-corrosion materials made from ROMP polymers of the invention offer an advantage over prior art anti-corrosion materials made from polypropylene in such ROMP polymers possess improved thermal stability.

The invention also relates to a anti-corrosion material for use in coating or encasing (1) an object; (2) at least a portion of an object; and/or (3) at least a portion of at least one surface of an object, wherein the anti-corrosion material comprises the coating composition, ROMP polymer, or ROMP polymer composite of the invention.

The invention also relates to the use of a anti-corrosion material for coating or encasing (1) an object; (2) at least a portion of an object; and/or (3) at least a portion of at least one surface of an object, wherein the anti-corrosion material comprises the coating composition, ROMP polymer, or ROMP polymer composite of the invention.

The invention also relates to a method of preventing corrosion of an object from a surrounding fluid, the method comprising interposing a anti-corrosion material between the object and the fluid where the anti-corrosion material comprises the coating composition, ROMP polymer, or ROMP polymer composite of the invention.

The invention also relates to a method for coating or encasing (1) an object; (2) at least a portion of an object; and/or (3) at least a portion of at least one surface of an object, with a anti-corrosion material, wherein the anti-corrosion material comprises the coating composition, ROMP polymer, or ROMP polymer composite of the invention.

The invention also relates to a method for coating or encasing (1) an object; (2) at least a portion of an object; and/or (3) at least a portion of at least one surface of an object, with a anti-corrosion material, comprising: contacting the coating composition of the invention with, or applying the coating composition of the invention to, (1) the object; (2) at least a portion of the object; and/or (3) at least a portion of at least one surface of the object; and subjecting the coating composition to conditions effective to promote a ROMP reaction of the coating composition to form the ROMP polymer or ROMP polymer composite of the invention, wherein the anti-corrosion material is the ROMP polymer or ROMP polymer composite.

The invention also relates to a process for applying a anti-corrosion material to an object, comprising: placing a mold around an object to define a cavity between an internal surface of the mold and the object; injecting a anti-corrosion material in the cavity, wherein the anti-corrosion material composition comprises the coating composition of the invention; and subjecting the anti-corrosion material composition to conditions effective to promote a ROMP reaction of the coating composition to form the ROMP polymer or ROMP polymer composite of the invention.

The invention relates to an object at least partially coated or encased with a anti-corrosion material of the invention.

The objects to be encased and/or coated may be of any configuration, weight, size, thickness, or geometric shape. For example, pipe coated with the ROMP polymer and/or ROMP polymer composite of the invention can have any outer diameter, inner diameter, and length.

Furthermore, the objects to be encased and/or coated may be constructed of any material including but not limited to metal, metal alloys, plastic, rubber, polymer, wood, ceramic, glass, carbon, cement, concrete, etc.

The objects to be encased and/or coated may be partially or fully encased and/or coated.

The anti-corrosion material may be of any configuration, weight, size, thickness, or geometric shape. Furthermore, the anti-corrosion material is not limited to a single polymer layer, but also include multiple polymer layers, where each polymer layer may comprise the same or different composition.

The invention also relates to a anti-corrosion material comprising the ROMP polymer of the invention, where the ROMP polymer has an elongation at break that ranges from at least 20%, from at least 50%, from at least 75%, from at least 100%, from at least 125%, from at least 150%, from at least 175%, from at least 200%, from at least 225%, from at least 250%, from at least 275%, from at least 300%, or from at least 400%.

The invention also relates to a anti-corrosion material comprising the ROMP polymer of the invention, where the ROMP polymer has an elongation at break that ranges from 20% to 400%, 20% to 300%, 20% to 275%, 20% to 250%, 20% to 225%, 20% to 200%, 20% to 175%, 20% to 150%, 20% to 125%, 20% to 100%, 20% to 75%, 20% to 50%, 50% to 300%, 50% to 275%, 50% to 250%, 50% to 225%, 50% to 200%, 50% to 175%, 50% to 150%, 50% to 125%, 50% to 100%, 50% to 75%, 75% to 400%, 75% to 300%, 75% to 275%, 75% to 250%, 75% to 225%, 75% to 200%, 75% to 175%, 75% to 150%, 75% to 125%, 75% to 100%, 100% to 400%, 100% to 300%, 100% to 275%, 100% to 250%, 100% to 225%, 100% to 200%, 100% to 175%, 100% to 150%, 100% to 125%, 125% to 400%, 125% to 300%, 125% to 275%, 125% to 250%, 125% to 225%, 125% to 200%, 125% to 175%, 125% to 150%, 150% to 400%, 150% to 300%, 150% to 275%, 150% to 250%, 150% to 225%, 150% to 200%, 150% to 175%, 175% to 400%, 175% to 300%, 175% to 275%, 175% to 250%, 175% to 225%, 175% to 200%, 200% to 400%, 200% to 300%, 200% to 275%, 200% to 250%, 200% to 225%, 225% to 400%, 225% to 300%, 225% to 275%, 225% to 250%, 250% to 400%, 250% to 300%, 250% to 275%, 275% to 400%, or 275% to 300%.

Anti-corrosion materials made from ROMP polymers of the invention offer an advantage over prior art anti-corrosion materials made from polyurethane and epoxy-based materials, including elastomeric amine cured epoxy materials, in that cyclic olefins (cyclic olefin monomers) used to make such ROMP polymers may be selected so that the resultant ROMP polymers do not contain carbon-heteroatom bonds in the polymer backbone. Therefore, ROMP polymers of the invention are generally more hydrolytically stable than polyurethanes and/or epoxy-based polymers, each of which possess carbon-heteroatom bonds in the polymer backbone. Preferentially, ROMP polymers of the invention possess a polymer backbone containing only carbon-carbon single bonds and carbon-carbon double bonds, where the carbon atoms may be substituted or unsubstituted. ROMP polymers of the invention may be optionally hydrogenated by any known method, to provide a hydrogenated ROMP polymer for use as anti-corrosion.

Unexpectedly, the ROMP polymers, ROMP polymer composites, and anti-corrosion materials of the invention possessed some or all the desired characteristics and/or properties specified above for anti-corrosion materials, in particular anti-corrosion materials used in offshore drilling (e.g., subsea applications). As such, the ROMP polymer, ROMP polymer composites, and anti-corrosion materials of the invention satisfy this need in the industry.

### Articles of Manufacture

The invention is also directed to an article of manufacture manufactured from the coating composition, ROMP polymer, ROMP polymer composite, or anti-corrosion material of the invention.

The invention also relates to an article of manufacture comprising an object, wherein at least a portion of at least one surface of the object is coated or encased with the coating composition, ROMP polymer, ROMP polymer composite, or anti-corrosion material of the invention.

The invention is also directed to articles manufactured from the coating composition of the invention, wherein the coating composition is applied to at least one substrate material.

The invention is also directed to articles manufactured from the coating composition of the invention and at least one substrate material, wherein the article is a anti-corrosion material. Additionally, the invention relates to articles manufactured from the coating composition of the invention, wherein the coating composition is applied to at least one substrate material, which may be, for example, a functionalized substrate, such as, for example, a heteroatom-functionalized substrate, such as, for example, an amino-functionalized substrate, wherein the article is a anti-corrosion material.

The invention also relates to an article of manufacture made by any of the methods described herein.

### Exemplary Embodiments of the Invention

E1) A coating composition comprising, consisting essentially of, or consisting of:
a) at least one olefinic resin composition comprising, consisting essentially of, or consisting of:
   a.1) at least one olefinic component consisting of:
      a.1.1) 80-100 wt. %, based on the total weight of the olefinic component, of at least one cyclic olefin selected from the group consisting of Formulae (I), (II), and (III); and
      a.1.2) 0-20 wt. %, based on the total weight of the olefinic component, of at least one linear olefin of Formula (IV);
      wherein the wt. % of the cyclic olefins of Formulae (I), (II), and (III), and the linear olefin of Formula (IV) add to 100 wt. % of the olefinic component; and
   a.2) at least one metal carbene olefin metathesis catalyst, present in an olefin to catalyst molar ratio of 10,000,000:1 to 1,000:1; and
   a.3) optionally, at least one thermoplastic hydrocarbon resin;
b) optionally, at least one inorganic filler;
c) at least one adhesion promoter selected from functionalized polyolefins; and
d) optionally, at least one coating additive;
wherein the cyclic olefin of Formulae (I), (II), and (III), and the linear olefin of Formula (IV) have the following structures:

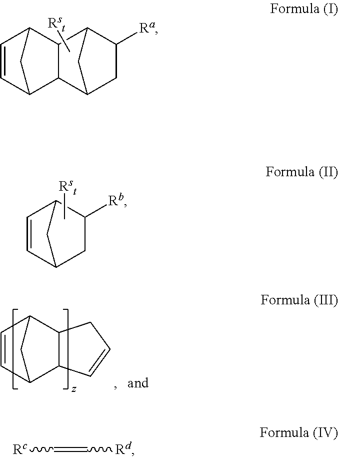

wherein:
R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, —C(R^{h})(Rⁱ)C(O)NR^{o}ORⁿ, or

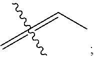 [SMILES: *=CC]

R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —Si(OR^{k})₃—S(O)₂OR^{h}, —OS(O)₂R^{h}, optionally substituted heterocycle, spiro optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{c} and R^{d} are, independent of one another, H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)-(optionally substituted C₅₋₂₄ aryl), —C(O)-(optionally substituted linear or branched C₂₋₂₄ alkenyl), or optionally substituted C₃₋₁₂ cycloalkenyl;
R^{h}, Rⁱ, R^{j}, R^{l}, R^{m}, Rⁿ, R^{o}, and R^{p} are, independent of one another, H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
t is 0, 1, 2, 3, 4, 5, or 6; and
z is 0, 1, 2, or 3.
E2) The coating composition of E1, wherein:
R^{a} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, optionally substituted C₃₋₁₂ cycloalkenyl, or

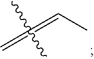 [SMILES: *=CC]

R^{b}, R^{c}, and R^{d} are, independent of one another, H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
R^{f} is OH, OR^{k}, NR^{g}R^{h}, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{g}, R^{h}, Rⁱ, R^{j}, R^{l}, R^{m}, Rⁿ, R^{o}, and R^{p} are, independent of one another, H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{k} is optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
t is 0; and
z is 2.
E3) The coating composition of E1 or E2, wherein:
the cyclic olefin of formula (I) is 2-ethylidene-1,2,3,4,4a,5,8,8a-octahydro-1,4:5,8-dimethanonaphthalene, 2-hexyl-1,2,3,4,4a,5,8,8a-octahydro-1,4:5,8-dimethanonaphthalene, or mixtures thereof;
the cyclic olefin of formula (II) is 2-hydroxyethyl bicyclo[2.2.1]hept-5-ene-2-carboxylate, [3-(triethoxysilyl) propyl]-bicyclo[2.2.1]hept-5-en-2-ylmethyl ester, octyl-norbornene, 5-norbornene-2-methanol, 5-norbornene-2-exo,3-exo-dimethanol, 2-hydroxyethyl bicyclo[2.2.1]hept-5-ene-2-carboxylate, norbornene triethoxy silane, 5-(perfluorobutyl) bicyclo[2.2.1]hept-2-ene, 2,2,3,3,4,4,5,5,6,6,7,7-dodecafluoroheptyl bicyclo[2,2,1]hept-5-ene-2-carboxylate, dicyclo[2.2.1]hept-5-ene-2-carboxylic acid, 2,2,2-trifluoro-1-(trifluoromethyl)ethyl ester, or mixtures thereof; and
the cyclic olefin of formula (III) is dicyclopentadiene, tricyclopentadiene, or mixtures thereof.
E4) The coating composition of any one of E1-E3, wherein the coating composition comprises at least one cyclic olefin represented selected from the group consisting of Formulae (I) and (II).
E5) The coating composition of any one of E1-E3, wherein the coating composition comprises at least one cyclic olefin selected from the group consisting of Formulae (I) and (III).
E6) The coating composition of any one of E1-E3, wherein the coating composition comprises at least one cyclic olefin selected from the group consisting of Formulae (II) and (III).
E7) The coating composition of any one of E1-E3, wherein the coating composition comprises at least one cyclic olefin selected from the group consisting of Formulae (I), (II), and (III).
E8) The coating composition of any one of E1-E3, wherein the coating composition comprises at least one cyclic olefin selected from the group consisting of Formulae (III).
E9) The coating composition of E8, wherein the at least one cyclic olefin is selected from dicyclopentadiene (DCPD), tricyclopentadiene (TCPD), and mixtures thereof.
E10) The coating composition of E9 wherein, DCPD and TCPD are present in a ratio of 3:7 to 2:3 DCPD wt. %:TCPD wt. %.
E11) The coating composition of any one of E1-E10, wherein the olefinic component is present in the coating composition in an amount ranging from about 35-99.9 wt. % (e.g., 40-99 wt. %, 45-98 wt. %, 50-95 wt. %, 55-90 wt. %, 60-85 wt. %, 65-80 wt. %, 70-75 wt. %), based on the total weight of the coating composition.
E12) The coating composition of any one of E1-E11, wherein the at least one metal carbene olefin metathesis catalyst is a Group 8 transition metal complex having the structure of formula (I):

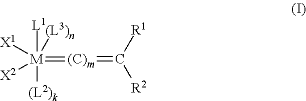

wherein:
M is a Group 8 transition metal;
L¹, L², and L³ are neutral electron donor ligands;
n is 0 or 1, such that L³ may or may not be present;
m is 0, 1, or 2;
k is 0 or 1;
X¹ and X² are anionic ligands; and
R¹ and R² are independently selected from hydrogen, hydrocarbyl, substituted hydrocarbyl, heteroatom-containing hydrocarbyl,
wherein any two or more of X¹, X², L¹, L², L³, R¹, and R² can be taken together to form one or more cyclic groups, and further wherein any one or more of X¹, X², L¹, L², L³, R¹, and R² may be attached to a support.
E13) The coating composition of E12, wherein the at least one metal carbene olefin metathesis catalyst is a Group 8 transition metal complex having the structure of formula (I), wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCP₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ is an N-heterocyclic carbene selected from 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene; and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ and L² are N-heterocyclic carbenes independently selected from the group consisting of 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene;
X¹ and X² are chlorine; and
R¹ is hydrogen and R² is phenyl or —CH═C(CH₃)₂; or R¹ and R² are taken together to form an indenylidene moiety.
E14) The coating composition of any one of E1-E13, wherein the at least one metal carbene olefin metathesis catalyst is a Group 8 transition metal complex having the structure of formula (VII):

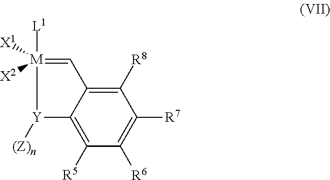

wherein:
M is a Group 8 transition metal;
X¹ and X² are anionic ligands;
L¹ is a neutral electron donor ligand;
Y is a heteroatom selected from N, O, S, and P;
R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, isocyanate, hydroxyl, ester, ether, amine, imine, amide, trifluoroamide, sulfide, disulfide, sulfonate, carbamate, silane, siloxane, phosphine, phosphate, borate, or -A-Fn, wherein A is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group; and any combination of R⁵, R⁶, R⁷, and R⁸ can be linked to form one or more cyclic groups;
n is 1 or 2, such that n is 1 for the divalent heteroatoms O or S, and n is 2 for the trivalent heteroatoms N or P; and
Z is a group selected from hydrogen, alkyl, aryl, functionalized alkyl, functionalized aryl where the functional group may independently be one or more or the following: alkoxy, aryloxy, halogen, carboxylic acid, ketone, aldehyde, nitrate, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and
wherein any combination or combinations of X¹, X², L¹, V, Z, R⁵, R⁶, R⁷, and R⁸ may be linked to a support.
E15) The coating composition of any one of E1-E14, wherein the thermoplastic hydrocarbon resin is present in the coating composition in an amount ranging from 0-about 25 wt. % (e.g., 0.01-20 wt. %, 0.1-15 wt. %, 0.5-10 wt. %, 1-9 wt. %, 2-8 wt. %, 3-7 wt. %, 4-6 wt. %), based on the total weight of the coating composition.
E16) The coating composition of any one of E1-E15, wherein the olefinic resin composition is present in the coating composition in an amount ranging from about 5-99.99 wt. % (e.g., 10-99.98 wt. %, 15-99.89 wt. %, 20-99.88 wt. %, 25-99 wt. %, 30-95 wt. %, 35-90 wt. %, 40-85 wt. %, 45-80 wt. %, 50-75 wt. %, 55-70 wt. %, 60-65 wt. %), based on the total weight of the coating composition.
E17) The coating composition of any one of E1-E16, wherein the inorganic filler is selected from aluminum powder or alloys thereof, aluminum flakes or alloys thereof, zinc aluminum flakes or alloys thereof, micaceous iron oxide, mica, glass flakes, calcium metasilicate, wollastonite, talc, calcium carbonate, barium sulfate, silica, and mixtures thereof
E18) The coating composition of any one of E1-E17, wherein the inorganic filler is selected from aluminum powder, aluminum flakes (paste), zinc aluminum flakes (paste), micaceous iron oxide, mica, glass flakes, calcium metasilicate, wollastonite, talc, and mixtures thereof.
E19) The coating composition of any one of E1-E18, wherein the inorganic filler is selected from aluminum flakes (paste), zinc aluminum flakes (paste), micaceous iron oxide, mica, glass flakes, talc, and mixtures thereof.
E20) The coating composition of any one of E1-E19, wherein the inorganic filler is present in the coating composition in an amount ranging from 0-about 70 wt. % (e.g., 0.1-65 wt. % 0.5-60 wt. %, 1-55 wt. %, 5-50 wt. %, 10-45 wt. %, 15-40 wt. %, 20-35 wt. %, 25-30 wt. %), preferably, 0-about 20 wt. % (e.g., 0.05-15 wt. %, 0.1 to 10 wt. %, 0.5 to 5 wt. %, 1 to 4 wt. %, 2 to 3 wt. %) or about 14-64 wt. % (e.g., 27-58 wt. %), based on the total weight of the coating composition.
E21) The coating composition of any one of E1-E17, wherein the adhesion promoter is selected from at least one functionalized polybutadiene.
E22) The coating composition of E21, wherein the functionalized polybutadiene is selected from maleic anhydride-functionalized polybutadienes, silane-functionalized polybutadienes, epoxidized polybutadienes, silane and maleic anhydride modified polybutadienes, and mixtures thereof.
E23) The coating composition of any one of E1-E22, wherein the adhesion promoter is selected from maleic anhydride-functionalized polybutadienes, silane-functionalized polybutadienes, or mixtures thereof.
E24) The coating composition of E22 or E23, wherein the maleic anhydride-functionalized polybutadiene is selected from Ricobond 1731, Polyvest MA 100, and mixtures thereof.
E25) The coating composition of E22 or E23, wherein the silane-functionalized polybutadiene is selected from Polyvest ST E60, Polyvest ST E100, SE X-12-1287A, SE X-12-1267B, and mixtures thereof.
E26) The coating composition of E22, wherein the silane and maleic anhydride modified polybutadiene is selected from X-12-1287A.
E27) The coating composition of E1-E17, wherein the adhesion promoter is an oligomeric coupling agent containing reactive functional groups and alkoxysilyl groups (e.g, KR-516).
E28) The coating composition of any one of E1-E27, wherein the adhesion promoter is present in the coating composition in an amount ranging from about 0.01-10 wt. % (e.g., 0.05-9 wt. %, 0.1-8 wt. %, 0.5-7 wt. %, 1-6 wt. %, 2-5 wt. %, 3-4 wt. %), based on the total weight of the coating composition.
E29) The coating composition of any one of E1-E28, wherein the coating composition comprises the coating additive and the coating additive is selected from the group consisting of a gel modifier, a hardness modulator, an impact modifier, an antioxidant, an antiozonant, a binder, a thixotrope, a rheology modifier, a corrosion inhibitor, a dispersant, a wetting agent, a plasticizer, a pigment, a flame retardant, a dye, fibers, a reinforcement material, a coupling agent, a UV absorber, a UV light stabilizer, a film former, a lubricant, and mixtures thereof.
E30) The coating composition of E29, wherein the coating additive is selected from the group consisting of at least one rheology modifier, at least one corrosion inhibitor, at least one pigment, and mixtures thereof.
E31) The coating composition of E29 and E30, wherein the corrosion inhibitor is selected from zinc-phosphate-based corrosion inhibitors, calcium borosilicate-based corrosion inhibitors, zinc and aluminum-based corrosion inhibitors, and mixtures thereof.
E32) The coating composition of E31, wherein the corrosion inhibitor is selected from Halox SZP391, Halox CW-2230, Halox 700, and mixtures thereof.
E33) The coating composition of any one of E29-E31, wherein the corrosion inhibitor is present in the coating composition in an amount ranging from about 0.01-15 wt. % (e.g., 0.05-10 wt. %, 0.1-9 wt. %, 0.5-8 wt. %, 1-7 wt. %, 2-6 wt. %, 3-5 wt. %), based on the total weight of the coating composition.
E34) The coating composition of any one of E29-E33, wherein the pigment is selected from carbon black, TiO₂, orange pigment dispersion, pigment Yellow 184 in mineral oil, TiO₂ in mineral oil, Sudan Blue II, and mixtures thereof.
E35) The coating composition of E34, wherein the pigment is selected from carbon black, TiO₂, and mixtures thereof.
E36) The coating composition of any one of E29-E35, wherein the pigment is present in the coating composition in an amount ranging from about 0.001-5 wt. % (e.g., 0.005-4 wt. %, 0.01-3 wt. %, 0.05-2 wt. %, 0.1-1 wt. %, 0.2-0.5 wt. %), based on the total weight of the coating composition.
E37) The coating composition of any one of E29-E36, wherein the coating additive is selected from at least one rheology modifier.
E38) The coating composition of any one of E29-E37, wherein the rheology modifier is selected from fumed silica, organoclay, and mixtures thereof.
E39) The coating composition of any one of E29-E38, wherein the rheology modifier is present in the coating composition in an amount ranging from about 0.01-10 wt. % (e.g., 0.05-9 wt. %, 0.1-8 wt. %, 0.5-7 wt. %, 1-6 wt. %, 2-5 wt. %, 3-4 wt. %), based on the total weight of the coating composition.
E40) The coating composition of any one of E29-E39, wherein the coating additive is present in the coating composition in an amount ranging from 0-about 25 wt. % (e.g., 0.01-20 wt. %, 0.05-15 wt. %, 0.1-14 wt. %, 0.5-13 wt. %, 1-12 wt. %, 2-11 wt. %, 3-10 wt. %, 4-9 wt. %, 5-8 wt. %, 6-7 wt. %), based on the total weight of the coating composition.
E41) The coating composition of E1, wherein:
the olefinic component is selected from dicyclopentadiene, tricyclopentadiene, or mixtures thereof;
the inorganic filler is selected from mica, micaceous iron oxide, aluminum flakes (paste), zinc aluminum flakes (paste), talc, calcium metasilicate, glass flake, aluminum powder, wollastonite, and mixtures thereof;
the adhesion promoter is selected from maleic anhydride-functionalized polybutadienes, silane-functionalized polybutadienes, epoxidized polybutadienes, silane and maleic anhydride modified polybutadienes, silane and epoxy modified polybutadienes, and mixtures thereof; and
the coating additive is selected from at least one rheology modifier.
E42) The coating composition of E1, wherein:
the olefinic component is selected from dicyclopentadiene, tricyclopentadiene, or mixtures thereof;
the inorganic filler is selected from mica, micaceous iron oxide, aluminum flakes (paste), zinc aluminum flakes (paste), talc, glass flake, and mixtures thereof;
the adhesion promoter is selected from maleic anhydride-functionalized polybutadienes, silane-functionalized polybutadienes, and mixtures thereof; and
the coating additive is selected from at least one rheology modifier.
E43) The coating composition of E1, comprising:
about 5-99.99 wt. % (e.g., 10-99.98 wt. %, 15-99.89 wt. %, 20-99.88 wt. %, 25-99 wt. %, 30-95 wt. %, 35-90 wt. %, 40-85 wt. %, 45-80 wt. %, 50-75 wt. %, 55-70 wt. %, 60-65 wt. %), based on the total weight of the coating composition, of the olefinic component, wherein the olefinic component is selected from dicyclopentadiene, tricyclopentadiene, or mixtures thereof;
0-about 25 wt. % (e.g., 0.01-20 wt. %, 0.1-15 wt. %, 0.5-10 wt. %, 1-9 wt. %, 2-8 wt. %, 3-7 wt. %, 4-6 wt. %), based on the total weight of the coating composition, of the thermoplastic hydrocarbon resin;
0-about 70 wt. % (e.g., 0.1-65 wt. % 0.5-60 wt. %, 1-55 wt. %, 5-50 wt. %, 10-45 wt. %, 15-40 wt. %, 20-35 wt. %, 25-30 wt. %), preferably 0-about 20 wt. % (e.g., 0.05-15 wt. %, 0.1 to 10 wt. %, 0.5 to 5 wt. %, 1 to 4 wt. %, 2 to 3 wt. %) or about 14-64 wt. % (e.g., 27-58 wt. %), based on the total weight of the coating composition, of the inorganic filler, wherein the inorganic filler is selected from mica, micaceous iron oxide, aluminum flakes (paste), zinc aluminum flakes (paste), talc, calcium metasilicate, glass flake, aluminum powder, wollastonite, and mixtures thereof;
about 0.01-10 wt. % (e.g., 0.05-9 wt. %, 0.1-8 wt. %, 0.5-7 wt. %, 1-6 wt. %, 2-5 wt. %, 3-4 wt. %), based on the total weight of the coating composition, of the adhesion promoter, wherein the adhesion promoter is selected from maleic anhydride-functionalized polybutadienes, silane-functionalized polybutadienes, and mixtures thereof; and
0-about 5 wt. % (e.g., 0.05-4 wt. %, 0.1-3 wt. %, 0.5-2 wt. %, 1-1.5 wt. %), based on the total weight of the coating composition, of the coating additive, wherein the coating additive is selected from a rheology modifier.
E44) The coating composition of E1, comprising:
about 41-72 wt. %, based on the total weight of the coating composition, of the olefinic component, wherein the olefinic component is selected from dicyclopentadiene, tricyclopentadiene, or mixtures thereof;
0-about 21 wt. %, based on the total weight of the coating composition, of the thermoplastic hydrocarbon resin;
about 27-58 wt. %, based on the total weight of the coating composition, of the inorganic filler, wherein the inorganic filler is selected from mica, micaceous iron oxide, aluminum flakes (paste), zinc aluminum flakes (paste), talc, glass flake, and mixtures thereof;
about 0.05-6 wt. %, based on the total weight of the coating composition, of the adhesion promoter, wherein the adhesion promoter is selected from maleic anhydride-functionalized polybutadienes, silane-functionalized polybutadienes, and mixtures thereof; and
0-about 5 wt. %, based on the total weight of the coating composition, of the coating additive, wherein the coating additive is at least one rheology modifier selected from a fumed silica, organoclay, and mixtures thereof.
E45) The coating composition of any one of E41-E44, wherein the maleic anhydride-functionalized polybutadiene is selected from Ricobond 1731, Polyvest MA 100, and mixtures thereof.
E46) The coating composition of any one of E41-E45, wherein the silane-functionalized polybutadiene is selected from Polyvest ST E60, Polyvest ST E100, SE X-12-1287A, SE X-12-1267B, and mixtures thereof.
E47) The coating composition of any one of E41-E43, wherein the rheology modifier is selected from fumed silica, organoclay, and mixtures thereof.
E48) The coating composition of E47, wherein the fumed silica is Cab-O-Sil TS720 and the organoclay is Garamite 7303.
E49) The coating composition of any one of E41-E48, further comprising at least one corrosion inhibitor selected from zinc-phosphate-based corrosion inhibitors, calcium borosilicate-based corrosion inhibitors, zinc and aluminum-based corrosion inhibitors, and mixtures thereof.
E50) The coating composition of E49, wherein the corrosion inhibitor is selected from Halox SZP391, Halox CW-2230, Halox 700, and mixtures thereof.
E51) The coating composition of E49 or E50, wherein the corrosion inhibitor is present in the coating composition in an amount ranging from about 0.01-15 wt. % (e.g., 0.05-10 wt. %, 0.1-9 wt. %, 0.5-8 wt. %, 1-7 wt. %, 2-6 wt. %, 3-5 wt. %), based on the total weight of the coating composition.
E52) The coating composition of any one of E41-E51, further comprising at least one pigment selected from carbon black, TiO₂, orange pigment dispersion, pigment Yellow 184 in mineral oil, TiO₂ in mineral oil, Sudan Blue II, and mixtures thereof.
E53) The coating composition of E52, wherein the pigment is selected from carbon black, TiO₂, and mixtures thereof.
E54) The coating composition of E52 or E53, wherein the pigment is present in the coating composition in an amount ranging from about 0.001-5 wt. % (e.g., 0.005-4 wt. %, 0.01-3 wt. %, 0.05-2 wt. %, 0.1-1 wt. %, 0.2-0.5 wt. %), based on the total weight of the coating composition.
E55) A method for coating a substrate material, comprising:
optionally applying an adhesion promoter onto the substrate surface;
applying onto the substrate surface a coating composition of any one of E1-E54; and
curing at room temperature the coating applied on the substrate surface.
E56) The method of E55, further comprising the step of adhering a second substrate by placing a second substrate on the coated substrate to adhere the two substrates together.
E57) The method of E55, wherein the coating applied on the substrate surface is cured at room temperature.
E58) An article of manufacture produced by the method of any one of E55-E57.
E59) An article of manufacture comprising a substrate coated with a cured coating composition wherein the coating composition is a coating composition of any one of E1-E54.
E60) An article of manufacture of E59, wherein the substrate is a metal surface.
E61) An article of manufacture of E59, wherein the substrate is a nonmetal surface.

### EXPERIMENTAL

In the following examples, efforts have been made to ensure accuracy with respect to numbers used (e.g., amounts, temperature, etc.) but some experimental error and deviation should be accounted for. Unless indicated otherwise, temperature is in degrees Celsius (° C.), pressure is at or near atmospheric, viscosity is in centipoise (cP). Additives added to the coating compositions are reported as ppm, which is defined as the weight in grams of additive per million grams of cyclic olefin composition, or as phr, which is defined as the weight in grams of the additive per hundred grams of cyclic olefin composition.

The following examples are to be considered as not being limiting of the invention as described herein, and are instead provided as representative examples of compositions of the invention and methods for their use, and articles made from such compositions and methods.

### Examples

### Materials and Methods

All glassware was oven dried and reactions were performed under ambient conditions unless otherwise noted. All solvents and reagents were purchased from commercial suppliers and used as received unless otherwise noted.

The cyclic olefin resins, fillers, rheology modifiers, color pigments and dispersions, corrosion inhibitors, and adhesion promoters used in the examples are set forth in Tables 1-6.

“2-hydroxyethyl bicyclo[2.2.1]hept-2-ene-5-carboxylate” is defined as HENB herein. “methylene diphenyl diisocyanate” is defined as MDI herein.

TABLE 1
Cyclic Olefin Resin (RSN) Packages

| Abbreviation | Composition |
|---|---|
| RSN 1 | 60:40 wt. % |
| | TCPD/DCPD |
| RSN 2 | 70/30 wt. % |
| | TCPD/DCPD |
| THR 1 | Thermoplastic |
| | Hydrocarbon Resin |

TABLE 2
Filler (FIL) Packages

| Abbreviation | Name | Chemical Nature | Vendor |
|---|---|---|---|
| FIL 1 | Mica C3000 | mica | Imerys |
| FIL 2 | Mica Suzorite 200- | mica | Imerys |
| | HK | | |
| FIL 3 | MIOX M50 | micaseous iron oxide | Kish |
| FIL 4 | STAPA 4, nl | aluminum flake paste | ECKART |
| FIL 5 | STAPA SDF 6-900 | aluminum flake paste | ECKART |
| FIL 6 | STAPA 4 ZnAl | zinc aluminum flakes | ECKART |
| | | paste | |
| FIL 7 | Talc | talc | Imerys |
| FIL 8 | Wollastonite | calcium metasilicate | Imerys |
| FIL 9 | Glass Flake 001 | glass flake | Glassflake |
| | | | Limited |
| FIL 10 | Glass Flake 003 | glass flake | Glassflake |
| | | | Limited |
| FIL 11 | Al powder | aluminum powder | ECKART |

TABLE 3
Rheology Modifier (RM) Packages

| Abbreviation | Name | Chemical Nature | Vendor |
|---|---|---|---|
| RM 1 | Cab-O-Sil TS720 | fumed silica | Cabot |
| RM 2 | Garamite 7303 | Organophilic | BYK |
| | | phyllosilicates | |

TABLE 4
Color (COLR) Pigment and Dispersion Packages

| Abbreviation | Name | Chemical Nature | Vendor |
|---|---|---|---|
| COLR 1 | Black | carbon black pigment | American |
| | | | Colors |
| COLR 2 | White | TiO₂ | Chemours |
| COLR 3 | Burnt Orange | Orange pigment | American |
| | | dispersion | Colors |
| COLR 4 | MO-80406 | Pigment Yellow 184 in | Chromaflo |
| | Yellow BV | mineral oil | |
| COLR 5 | Chro White | TiO₂ in mineral oil | Chromaflo |
| COLR 6 | Blue | Sudan Blue II | Sigma- |
| | | | Aldrich |
| COLR 7 | Silver | aluminum flake paste | ECKART |

TABLE 5
Corrosion Inhibitor (CORR-INH) Packages

| Abbreviation | Name | Chemical Nature | Vendor |
|---|---|---|---|
| CORR-INH 1 | Halox SZP391 | zinc phosphate-based | ICL |
| | | corrosion inhibitor | |
| CORR-INH 2 | Halox CW-2230 | calcium borosilicate- | ICL |
| | | based corrosion inhibitor | |
| CORR-INH 3 | Halox 700 | zinc and aluminum-based | ICL |
| | | corrosion inhibitor | |

TABLE 6
Adhesion Promoter (AP) Packages

| | | | Functional | |
|---|---|---|---|---|
| Abbreviation | Name | Backbone | Group | Vendor |
| AP 1 | HENB-MDI | Norbornene | Isocyanate | Materia |
| AP 2 | NB-TESI | Norbornene | Silane | Gelest |
| AP 3 | Ricon 130 MA8 | Polybutadiene | Anhydride | Cray Valley |
| AP 4 | Ricon 603 | Polybutadiene | Silane | Cray Valley |
| AP 5 | Ricon 130 | Polybutadiene | Anhydride | Cray Valley |
| | MA20 | | | |
| AP 6 | Ricon 131 | Polybutadiene | Anhydride | Cray Valley |
| | MA10 | | | |
| AP 7 | Ricon 131 | Polybutadiene | Anhydride | Cray Valley |
| | MA20 | | | |
| AP 8 | Ricon 184 MA6 | Polybutadiene | Anhydride | Cray Valley |
| AP 9 | Ricobond 1731 | Polybutadiene | Anhydride | Cray Valley |
| AP 10 | Ricobond 1756 | Polybutadiene | Anhydride | Cray Valley |
| AP 11 | Ricobond 2031 | Polybutadiene | Anhydride | Cray Valley |
| AP 12 | Polyvest MA | Polybutadiene | Anhydride | Evonik |
| | 100 | | | |
| AP 13 | Polyvest ST E60 | Polybutadiene | Silane | Evonik |
| AP 14 | Polyvest ST | Polybutadiene | Silane | Evonik |
| | E100 | | | |
| AP 15 | Polyvest MA 75 | Polybutadiene | Anhydride | Evonik |
| AP 16 | Polyvest MV | Polybutadiene | Anhydride | Evonik |
| | MA60 | | | |
| AP 17 | AL 15MA | Polybutadiene | Anhydride | Synthomer |
| AP 18 | N4-B-10MA | Polybutadiene | Anhydride | Synthomer |
| AP 19 | N4-5000-10MA | Polybutadiene | Anhydride | Synthomer |
| AP 20 | N4-5000-15MA | Polybutadiene | Anhydride | Synthomer |
| AP 21 | PM4-7.5MA | Polybutadiene | Anhydride | Synthomer |
| AP 23 | SE X-12-1287A | Polybutadiene | Silane, | Shin-Etsu |
| | | | Anhydride | |
| AP 24 | SE X-12-1267B | Polybutadiene | Silane | Shin-Etsu |
| AP 25 | KR-516 | Polybutadiene | Silane, | Shin-Etsu |
| | | | Epoxy | |
| AP 26 | Silquest A-151 | Vinyl | Silane | Momentive |
| AP 27 | LIR-403 | Polyisoprene | Anhydride | Kuraray |
| AP 28 | LIR-410 | Polyisoprene | Carboxylic | Kuraray |
| | | | acid | |

### General Procedure

The olefinic component was added to an appropriate size mixing vessel and inorganic fillers, adhesion promoter, coating additives (rheology modifier, color pigment and pigment dispersion, corrosion inhibitor, was individually added and mixed into the olefinic component until the mixture was fully homogeneous.

Lab panel preparation: To prepare the coated panels, catalyzed coating formulations were applied onto the 10 cm×10 cm (4″×4″) grit-blasted carbon steel panels using a film applicator at a gap setting of 500 μm (20 mils). SSPC—SP 10 surface preparation standard was followed using steel grits to attain a surface profile of 50-75 μm (2-3 mil). The catalyzed coating formulation was prepared with ruthenium catalyst suspension at a 1:50 weight ratio to the resin formulation. The coated panels were cured at ambient conditions for 7 days in a well-ventilated hood before testing.

Pull-off adhesion test samples: A similar procedure to ASTM D4551 was followed. Coating surface was roughened using 100 grit sandpaper and the 14 mm aluminum dollies were grit-blasted to facilitate adhesion between the epoxy glue and the coating surface. The epoxy glue was cured at room temperature for 24 hours before testing. An automated portable pull-off adhesion tester was used to conduct the pull-off adhesion test. Both the adhesion failure mode as well as the adhesion value were reported. Various codes of failure modes, e.g., ACS (Adhesive failure between Coating and Substrate), CC(Cohesive failure of Coating), ACG (Adhesive failure between Coating and Glue) were reported.

Hot water (95° C.) immersion test: A similar procedure to ASTM D870 was followed. The coated panels after the specified cure schedule (ambient cure for 7 days (RT-7 days) were completely submerged in a 95° C. deionized water bath for 7 days. After 7 days, the panels were removed from the water bath for visual inspection. Pull-off adhesion testing was also conducted after immersion.

Salt fog corrosion chamber test (ASTM B117): This test covers operating procedures for testing the corrosion resistance of coatings in a continuous salt fog spray condition. Prior to the test, fully coated steel panels were scribed per ISO standard 12944-9, section A.1. A drill bit attached to a drill press was used make the scribe with a dimension of 50 mm×2 mm. The scribed panels were loaded into the salt fog chamber 15° to 30° from the vertical. The salt solution was prepared by dissolving 5±1 parts by mass of sodium chloride (≤0.3% total impurity) in 95 parts of water confirming to Type IV water per Specification D1193. The temperature of the chamber was 35±2° C. After 3 weeks of continuous salt spray test, samples were removed from the chamber and rinsed with clean running water to remove salt deposits, and then immediately dried. A rigid pointed knife was used to remove delaminated coatings around the scribes by inserting the knife blade under the loose coating with a level action until no more disbandment can be detected. After removing the non-adherent coating, measure the width of the steel corrosion at nine points (the midpoint of the scribe line and four other points, 5 mm apart, on each side of the midpoint). The corrosion creep at the scribe was calculated using the following equation in a precision of 0.1 mm:

$$M = \frac{( C - W )}{2}$$

where C is the average of the nine width measurements and W is the measured and recorded width of the scribe.

### Results and Discussion

Table 7 showed a low level (1 phr) of polybutadiene maleic anhydride (PBD-MA) adhesion promoter (AP9) provided favorable adhesion failure mode (ACG) and good pull-off adhesion values in the two resin compositions, RSN 1 and RSN 2/THR 1 (70/30), compared to the compositions with a high level of AP1 (6 phr) adhesion promoter and the no AP control, illustrating the high effectiveness of the PBD-MA adhesion promoter.

TABLE 7
Resins Plus Adhesion Promoter Performance

| | | | | RT - 7-days | | After 1-week 95° C. | |
|---|---|---|---|---|---|---|---|
| | Thermo- | | | Cure | | Water Immersion | |
| | plastic | | | | Pull- | | Pull- |
| | Hydro- | | AP | Fail- | off | | off |
| | carbon | AP | Level | ure | Values | Failure | Values |
| Resin | Resin | Type | (phr) | mode | (psi) | mode | (psi) |
| 100 | None | No AP | | ACS | 537 | 13% ACS, | 2179 |
| phr | | | | | | 67% ACG | |
| RSN | | AP1 | 6 | ACG | 1336 | ACG | 2328 |
| 1 | | AP9 | 1 | ACG | 1140 | ACG | 2258 |
| 70 | 30 phr | No AP | | 40% | 911 | ACG | 2262 |
| phr | THR 1 | | | ACS, | | | |
| RSN | | | | 60% | | | |
| 2 | | | | ACG | | | |
| | | AP1 | 6 | ACG | 1193 | ACG | 1991 |
| | | AP9 | 1 | ACG | 1288 | ACG | 1894 |

Table 8 showed that PBD-MA adhesion promoters (AP3 and AP9) can be used over a wide range of addition level to attain good adhesion failure mode and pull-off values after a room temperature cure for 7 days in formulations with inorganic fillers (FIL 1). AP9 adhesion promoter exhibited better adhesion than AP3 after 1 week of 95° C. water immersion.

TABLE 8
Cyclic Olefin Resin Compositions with 40 phr Mica Filler

| | | | | | RT - 7-days | | After 1-week 95° C. | |
|---|---|---|---|---|---|---|---|---|
| | | | | | Cure | | Water Immersion | |
| | | | | | | Pull- | | Pull- |
| | | | | AP | Fail- | off | | off |
| | | | AP | Level | ure | Values | Failure | Values |
| RSN | THR | FIL | Type | (phr) | mode | (psi) | mode | (psi) |
| 100 | none | 40 | AP1 | 6 | ACG | 1478 | CC | 2151 |
| phr | | phr | AP2 | 6 | 10% | 1120 | CC | 1609 |
| RSN | | mica | | | ACS, | | | |
| 1 | | (FIL | | | 90% | | | |
| | | 1) | | | ACG | | | |
| | | | AP3 | 1 | ACG | 1516 | ACS | 917 |
| | | | | 2 | ACG | 1537 | ACS | 383 |
| | | | | 3 | ACG | 1559 | ACS | 530 |
| | | | | 6 | ACG | 1819 | ACS | 372 |
| | | | | 8.4 | ACG | 1525 | ACS | 461 |
| | | | AP9 | 0.125 | ACG | 1089 | 33% CC, | 1500 |
| | | | | | | | 67% ACG | |
| | | | | 0.25 | 20% | 1318 | 50% CC, | 1970 |
| | | | | | ACS, | | 50% ACG | |
| | | | | | 80% | | | |
| | | | | | ACG | | | |
| | | | | 0.5 | ACS | 1444 | 70% CC, | 2148 |
| | | | | | | | 30% ACG | |
| | | | | 1 | ACG | 1517 | CC thin | 1445 |
| | | | | 2 | ACG | 1490 | CC thin | 1555 |
| | | | | 3 | ACG | 1747 | CC | 1814 |
| | | | | 6 | ACG | 1882 | CC | 1570 |
| | | | | 8.4 | ACG | 1745 | CC | 1315 |
| 70 | 30 | | AP3 | 1 | ACG | 1496 | ACS | 1046 |
| phr | phr | | | 2 | ACG | 1385 | CC | 609 |
| RSN | THR | | | 6 | ACG | 1437 | ACS | 518 |
| 2 | 1 | | | 8.4 | ACG | 1276 | ACS | 523 |
| | | | AP9 | 1 | ACG | 1715 | CC | 1786 |
| | | | | 2 | ACG | 1537 | CC | 1455 |
| | | | | 3 | ACG | 1395 | ACG | 1799 |
| | | | | 6 | ACG | 1452 | ACS | 1002 |
| | | | | 8.4 | ACG | 1363 | 95% ACS, | 1674 |
| | | | | | | | 5% ACG | |

Table 9 showed different types of PBD-MA adhesion promoters and polybutadiene silane (PBD-silane) adhesion promoters attained good adhesion performance for filled formulations based on resin RSN 1 and inorganic filler FIL 1. Some PBD-MA and PBD-silane provided better adhesion after 95° C. water immersion than others.

TABLE 9
Cyclic Olefin Resin Compositions with 40 phr Mica Filler and Different Adhesion Promoters

| | | | | | | After 1-week 95° C. | |
|---|---|---|---|---|---|---|---|
| | | | | | | Water Immersion | |
| | | | | RT - 7-days Cure | | | Pull-off |
| | | | AP conc | | Pull-off | | Values |
| RSN | FIL | AP | (phr) | Failure mode | Values (psi) | Failure mode | (psi) |
| 100 | 40 phr | AP1 | 6 | ACG | 1478 | CC | 2151 |
| phr | mica | AP2 | 6 | 10% ACS, 90% ACG | 1120 | CC | 1609 |
| RSN 1 | (FIL 1) | AP3 | 1 | ACG | 1516 | ACS | 917 |
| | | AP3 | 3 | ACG | 1559 | ACS | 530 |
| | | AP4 | 1 | ACG | 1377 | 90% CC, 10% ACG | 1710 |
| | | AP4 | 3 | ACG | 1341 | 90% CC, 10% ACG | 1914 |
| | | AP4 | 6 | ACG | 1223 | 90% CC, 10% ACG | 1985 |
| | | AP5 | 1 | ACG | 1357 | 65% CC, 35% ACG | 2401 |
| | | AP5 | 3 | ACG | 1852 | CC thin | 1689 |
| | | AP6 | 1 | ACG | 1577 | CC | 1899 |
| | | AP6 | 3 | ACG | 1533 | ACS | 1457 |
| | | AP7 | 1 | ACG | 1430 | CC | 2239 |
| | | AP7 | 3 | ACG | 1770 | 90% CC, 10% ACG | 1875 |
| | | AP8 | 1 | ACG | 1371 | CC | 1377 |
| | | AP8 | 3 | ACG | 1703 | CC thin | 1813 |
| | | AP9 | 1 | ACG | 1517 | CC thin | 1445 |
| | | AP9 | 3 | ACG | 1747 | CC | 1814 |
| | | AP10 | 1 | ACG | 1478 | 60% CC, 40% ACG | 2319 |
| | | AP10 | 3 | ACG | 1131 | CC thin | 1260 |
| | | AP11 | 1 | ACG | 1422 | ACG | 2315 |
| | | AP11 | 3 | ACG | 1721 | 90% CC, 10% CC thin | 1602 |
| | | AP12 | 1 | ACG | 1300 | 75% CC thin, 25% ACG | 1689 |
| | | AP12 | 3 | ACG | 1322 | 90% ACS, 10% ACG | 1209 |
| | | AP13 | 1 | ACG | 1422 | CC | 1988 |
| | | AP13 | 3 | ACG | 1601 | ACG/CC | 2218 |
| | | AP13 | 6 | ACG | 1669 | ACG/CC | 2200 |
| | | AP14 | 1 | ACG | 1428 | CC | 1721 |
| | | AP14 | 3 | ACG | 1533 | ACG/CC | 2335 |
| | | AP14 | 6 | ACG | 1424 | ACG/CC | 2505 |
| | | AP15 | 1 | ACG | 1232 | 10% CC, 85% CC thin, 5% ACG | 1653 |
| | | AP15 | 3 | ACG | 1498 | ACS | 1115 |
| | | AP16 | 1 | ACG | 1276 | ACS | 873 |
| | | AP16 | 3 | ACG | 1237 | ACS | 831 |
| | | AP17 | 1 | ACG | 1430 | ACS | 946 |
| | | AP17 | 3 | ACG | 1644 | ACS | 514 |
| | | AP18 | 1 | ACG | 1507 | 70% CC thin, 30% ACG | 2349 |
| | | AP18 | 3 | ACG | 1769 | 95% CC thin, 5% ACG | 2226 |
| | | AP19 | 1 | ACG | 1522 | 85% CC thin, 15% ACG | 2314 |
| | | AP19 | 3 | ACG | 1728 | 90% ACS, 10% ACG | 1464 |
| | | AP20 | 1 | ACG | 1270 | 85% CC, 15 ACG | 1927 |
| | | AP 20 | 3 | ACG | 1619 | 95% CC, 5 ACG | 2163 |
| | | AP21 | 1 | ACG | 1832 | ACS | 1007 |
| | | AP21 | 3 | ACG | 1760 | ACS | 698 |
| | | AP23 | 1 | ACG | 2057 | CC | 1712 |
| | | AP23 | 3 | ACG | 2066 | 80% CC, 20% AGD | 1561 |
| | | AP24 | 1 | ACG | 1574 | 80% CC, 20% AGD | 1806 |
| | | AP24 | 3 | ACG | 1734 | CC | 1624 |
| | | AP25 | 1 | ACS | 347 | CC | 1781 |
| | | AP25 | 3 | ACS | 578 | CC | 1598 |

Table 10 showed different types of polybutadiene maleic anhydride (PBD-MA) adhesion promoters and polybutadiene silane (PBD-silane) adhesion promoters attained good adhesion performance for filled formulations based on resin RSN 2/THR 1 (70/30) and inorganic filler FIL 1. Some PBD-MA and PBD-silane adhesion promoters provided better adhesion after 95° C. water immersion.

TABLE 10
Cyclic Olefin Resin Compositions with 70 phr RSN 2, 30 phr
THR 1, 40 phr FIL 1, and Different Adhesion Promoters

| | | | | | RT - 7-days Cure | | After 1-week 95° C. Water Immersion | |
|---|---|---|---|---|---|---|---|---|
| | | | | | | Pull-off | | Pull-off |
| | | | | AP conc | Failure | Values | | Values |
| RSN | THR | FIL | AP | (phr) | mode | (psi) | Failure mode | (psi) |
| 70 | 30 phr | 40 phr FIL 1 | AP4 | 1 | ACG | 784 | 70% CC, 30% ACG | 1519 |
| phr | THR 1 | | AP6 | 1 | ACG | 1344 | CC | 1857 |
| RSN 2 | | | AP7 | 1 | ACG | 1219 | 60% CC, 40% ACG | 1831 |
| | | | AP8 | 1 | ACG | 1324 | CC | 1971 |
| | | | AP9 | 1 | ACG | 1384 | CC | 1293 |
| | | | AP10 | 1 | ACG | 1141 | 70% ACS, 30 ACG | 1457 |
| | | | AP12 | 1 | ACG | 1290 | CC | 1489 |
| | | | AP13 | 1 | ACG | 1039 | 55% CC, 45% ACG | 1249 |
| | | | AP13 | 3 | ACG | 952 | 50% CC, 50% ACG | 1583 |
| | | | AP13 | 6 | ACG | 1019 | 70% CC, 30% ACG/CC | 1242 |
| | | | AP14 | 1 | ACG | 1025 | 50% CC, 50% ACG | 1544 |
| | | | AP14 | 3 | ACG | 1348 | 3% CC thin, 97% ACG/CC | 1582 |
| | | | AP14 | 6 | ACG | 1205 | ACG | 1357 |
| | | | AP15 | 1 | ACG | 1292 | CC | 1924 |
| | | | AP16 | 1 | ACG | 1236 | ACS | 1062 |
| | | | AP17 | 1 | ACG | 1081 | ACS | 1233 |
| | | | AP18 | 1 | ACG | 1252 | 90% CC, 10% ACG | 1747 |
| | | | AP18 | 3 | ACG | 1472 | CC thin | 1696 |
| | | | AP19 | 1 | ACG | 1304 | 85% ACS, 15% ACG | 1599 |
| | | | AP20 | 1 | ACG | 1469 | 10% CC thin, 60% CC, 30% ACG | 1561 |
| | | | AP21 | 1 | ACG | 1046 | ACS | 904 |
| | | | AP22 | 1 | ACG | 1469 | 10% CC thin, 60% CC, 30% ACG | 1561 |
| | | | AP23 | 1 | ACG | 1571 | CC | 1677 |
| | | | AP23 | 3 | ACG | 1385 | CC | 1499 |
| | | | AP24 | 1 | ACG | 1363 | CC | 1746 |
| | | | AP24 | 3 | ACG | 1314 | CC | 1904 |

Table 11 showed that PBD-MA adhesion promoters are effective and compatible with different inorganic fillers. Some inorganic fillers provided better adhesion performance after 95° C. water immersion.

TABLE 11
Cyclic Olefin Resin Compositions with Adhesion Promoter, Rheology Modifier, and Different Filler Packages

| | | | | | | | After 1-week 95° C. Water | |
|---|---|---|---|---|---|---|---|---|
| | | | | | RT - 7-days Cure | | Immersion | |
| | | | | | | Pull-off | | Pull-off |
| | | | | | | Values | | Values |
| RSN | FIL | FIL conc (phr) | AP | RM | Failure mode | (psi) | Failure mode | (psi) |
| 100 | FIL 1 | 40 | 1 phr AP9 | 6 phr RM1 | ACG | 1635 | CC | 1764 |
| phr | FIL 2 | | | | 15% CC, 85% ACG | 1223 | CC | 1219 |
| RSN 1 | FIL 8 | | | | ACG | 1366 | 60% ACS, 40% CC | 2951 |
| | FIL 11 | | | | ACG | 1592 | ACG | 2743 |
| | FIL 6 | | | | ACG | 1076 | ACG | 2540 |
| | FIL 9 | | | | ACG | 1534 | 95% ACS, 5% CC | 1060 |
| | FIL 10 | | | | ACG | 1504 | 95% ACS, 5% ACG | 1766 |
| | FIL 3 | | | | ACG | 1626 | ACG | 2829 |
| | FIL 1 | | 1 phr AP12 | | ACG | 1489 | CC | 2152 |
| | FIL 2 | | | | 15% CC, 85% ACG | 1152 | CC | 1194 |
| | FIL 8 | | | | ACG | 1660 | 30% CC, 70% ACG | 2646 |
| | FIL 11 | | | | ACG | 1541 | 33% ACS, 67% ACG | 1546 |
| | FIL 6 | | | | ACG | 812 | ACG | 1802 |
| | FIL 9 | | | | ACG | 1354 | ACS | 370 |
| | FIL 10 | | | | ACG | 1357 | ACS | 988 |
| | FIL 3 | | | | ACG | 1475 | 50% ACS, 50% ACG | 2118 |

Table 12 showed that PBD-MA and PBD-silane adhesion promoters were effective over a wide range of inorganic filler loading (40 phr to 140 phr) to the highly filled formulations. Different fillers were used in combination.

TABLE 12
Cyclic Olefin Resin Compositions with Different Adhesion Promoters,
and Different Filler Packages at High Concentrations

| | | | | | | After 1-week 95° C. | |
|---|---|---|---|---|---|---|---|
| | | | | RT - 7-days Cure | | Water Immersion | |
| | | AP | | | Pull-off | | Pull-off |
| | | conc | | | Values | | Values |
| RSN | AP | (phr) | FIL | Failure mode | (psi) | Failure mode | (psi) |
| 100 | AP4 | 3 | 40 phr FIL 1 | ACG | 1181 | 80% CC, 20% AGD | 1822 |
| phr | AP13 | 3 | 40 phr FIL 1 | ACG | 1730 | 80% CC, 20% AGD | 2091 |
| RSN 1 | AP4 | 3 | 60 phr FIL 1 | ACG | 1329 | CC | 1500 |
| | AP13 | 3 | 60 phr FIL 1 | 90% CC, 10% ACG | 1674 | CC | 1782 |
| | AP3 | 3 | 60 phr FIL 1 | ACG | 1820 | ACS | 717 |
| | AP9 | 3 | 60 phr FIL 1 | ACG | 1875 | CC | 1847 |
| | AP4 | 3 | 80 phr FIL 1 | ACG | 1561 | CC | 1607 |
| | AP13 | 3 | 80 phr FIL 1 | CC | 1609 | CC | 1545 |
| | AP3 | 3 | 80 phr FIL 1 | ACG | 1868 | ACS | 432 |
| | AP9 | 3 | 80 phr FIL 1 | 40% CC, 60% ACG | 2036 | CC | 1191 |
| | AP3 | 3 | 100 phr FIL 1 | 85% CC, 15% ACG | 2142 | ACS | 604 |
| | AP9 | 3 | 100 phr FIL 1 | 95% CC, 5% ACG | 2390 | CC | 1031 |
| | AP4 | 3 | 100 phr FIL 1 | ACG | 1440 | CC | 1409 |
| | AP13 | 3 | 100 phr FIL 1 | CC | 1355 | CC | 1333 |
| | AP3 | 3 | 120 phr FIL 1 | 50% CC, 50% ACG | 1730 | 90% ACS, 10% CC | 507 |
| | AP9 | 3 | 120 phr FIL 1 | 90% CC, 10% ACG | 2032 | CC | 927 |
| | AP9 | 1 | 60 phr FIL 1 + 60 phr FIL 3 | ACG | 2140 | CC | 1232 |
| | AP9 | 1 | 60 phr FIL 1 + 60 phr FIL 7 | 10% CC, 90% ACG | 1368 | CC | 1039 |
| | AP3 | 3 | 140 phr FIL 1 | 95% CC, 5% ACG | 1180 | 75% ACS, 25% CC | 473 |
| | AP9 | 3 | 140 phr FIL 1 | 90% CC, 10% ACG | 2174 | CC | 898 |

PBD-MA and PBD-silane adhesion promoters were used in combination and were compatible with other coating additives such as rheology modifiers (RM 1, RM 2) and attained proper rheological profile for applications.

TABLE 13
Cyclic Olefin Resin Compositions with 100 phr RSN 1 and Different Adhesion Promoter, Rheology Modifier, and Filler Packages

| | | | | | After 1-week 95° C. | |
|---|---|---|---|---|---|---|
| | | | RT - 7-days Cure | | Water Immersion | |
| | | | | Pull- | | Pull- |
| | | | | off | | off |
| | | | | Values | | Values |
| FIL | RM | AP | Failure mode | (psi) | Failure mode | (psi) |
| 40 phr FIL 1 | none | 2 phr AP9 + 1 phr AP4 | ACG | 2013 | CC | 1708 |
| 40 phr FIL 1 | none | 1.5 phr AP9 + 1.5 phr AP4 | ACG | 1442 | CC | 2134 |
| 40 phr FIL 1 | none | 2 phr AP9 + 1 phr AP26 | ACG | 1453 | 3 ACS, 97 ACG/thin CC | 1872 |
| 40 phr FIL 1 | 2 phr RM1 | 0.5 phr AP9 + 0.5 phr AP13 | ACG | 1532 | CC | 1930 |
| 40 phr FIL 1 + | 2 phr RM1 | 0.5 phr AP9 + 0.5 phr AP13 | ACG | 1825 | CC | 1886 |
| 20 phr FIL 3 | | | | | | |
| 40 phr FIL 1 | 2 phr RM1 | 1 phr AP9 + 1 phr AP13 | ACG | 1865 | 30% ACG, 70% CC | 2013 |
| 40 phr FIL 1 + | 2 phr RM1 | 1 phr AP9 + 1 phr AP13 | ACG | 1621 | CC | 1800 |
| 20 phr FIL 3 | | | | | | |
| 40 phr FIL 1 | 2 phr RM1 + 0.2 phr RM2 | 3 phr AP13 | 60% CC, 40% ACG | 1495 | CC | 1501 |
| 40 phr FIL 1 | 2 phr RM1 + 0.2 phr RM2 | 1 phr AP13 | 80% ACG, 20% ACS | 1590 | CC | 1322 |
| 40 phr FIL 1 | 2 phr RM1 + 0.2 phr RM2 | 1 phr AP18 | ACG | 2010 | 30% ACS, 70% CC | 1307 |

Table 14 showed that PBD-MA adhesion promoter was compatible with corrosion inhibitors and the combination provided good initial pull-off adhesion after a 7 day room temperature cure, good adhesion retention after a 1 week of 95° C. water immersion as well good anti-corrosion performance with low rust creep values and retention of good adhesion after 3 months of salt fog corrosion chamber testing.

TABLE 14
Cyclic Olefin Resin Compositions with 100 phr RSN 1, 40 phr FIL 1, 1 phr
AP9, 4 phr RM1, 5 phr COLR, and Different Corrosion Inhibitor Packages

| | | RT - 7-days | | After 1-week 95° C. | | 3-month B117 Corrosion Chamber Testing | | |
|---|---|---|---|---|---|---|---|---|
| | | Cure | | Water Immersion | | | Pull-off Adhesion | |
| | | | Pull- | | Pull- | | | Pull- |
| CORR-INH | | | off | | off | Rust | | off |
| | Conc | Failure | Values | | Values | Creep | | Values |
| Type | (phr) | mode | (psi) | Failure mode | (psi) | (mm) | Failure mode | (psi) |
| CORR-INH 1 | 7.5 | ACG | 1566 | ACG | 2024 | 0.44 | ACS | 200 |
| CORR-INH 1 | 15 | ACG | 1712 | ACG | 2525 | 0.44 | 5% ACS, 95% ACG/CC | 2035 |
| CORR-INH 2 | 7.5 | ACG | 1489 | ACG | 2033 | 0.17 | 3% ACS, 97% ACG | 1857 |
| CORR-INH 2 | 15 | ACG | 1351 | ACG | 1957 | 0.28 | 30% ACS, 70% ACG | 1666 |
| CORR-INH 3 | 7.5 | ACG | 1472 | 90% CC, 10% ACG | 1674 | 0.78 | ACG | 1654 |
| CORR-INH 3 | 15 | ACG | 1251 | 65% CC, 35% ACG | 1951 | 0.06 | ACG/ACS | 888 |

Table 15 showed PBD-MA adhesion promoter were compatible with different color pigments and pigment dispersions and attained good initial adhesion as well as good adhesion after 95° C. water immersion.

TABLE 15
Cyclic Olefin Resin Compositions with Different Color Pigments and Color Dispersions

| | | | | | | | | After 1-week 95° C. | |
|---|---|---|---|---|---|---|---|---|---|
| | | | | | | RT - 7-days Cure | | Water Immersion | |
| | | | | | | | Pull-off | | Pull-off |
| | | | | | | | Values | Failure | Values |
| RSN | FIL | AP | RM | COLR | COLR conc (phr) | Failure mode | (psi) | mode | (psi) |
| 100 | 60 | 3 phr | 2 phr | None | | CG | 1581 | CC | 1723 |
| phr | phr | AP9 | RM2 | TiO2 | 0.57 | CG | 1546 | CC | 1625 |
| RSN 1 | FIL 1 | | | Orange | 0.57 | CG | 1479 | CC | 1748 |
| | | | | Carbon Black | 0.57 | CG | 1570 | CC | 1752 |
| | | | | Yellow | 0.57 | 85% ACG, 15% CG | 1652 | CC | 1943 |
| | | | | Chro White | 0.57 | 70% ACG, 30% CG | 1521 | CC | 1839 |
| | | | | Blue | 0.57 | 90% ACG, 10% CG | 1608 | CC | 1995 |
| | | | | Silver | 5 | 90% ACG, 10% CG | 1035 | CC | 1119 |

Table 17 showed good anti-corrosion performance with low rust creep values and good retention of adhesion was attained with proper choice of resins (RSN 1, RSN 2), thermoplastic hydrocarbon resin (THR 1), inorganic fillers (e.g., FIL 1, FIL 4, FIL 5), adhesion promoter (PBD-MA and PBD-silane), rheology modifier (RM1, RM2) and corrosion inhibitors (CORR—INH 1, 2, 3). The Examples in Table 16 illustrated the superior performance of PBD-MA and PBD-silane adhesion promoter to known norbornene-isocyanate adhesion promoters and norbornene-silane adhesion promoters.

TABLE 16
Formulations for ASTM B117 Salt Fog Corrosion Test

| | | | THR | | | | | | | | | | | | COLR | | | |
|---|---|---|---|---|---|---|---|---|---|---|---|---|---|---|---|---|---|---|
| | RSN (phr) | | (phr) | FIL (phr) | | | | | | | | | RM (phr) | | (phr) | CORR-INH (phr) | | |
| Formu- | RSN | RSN | THR | FIL | FIL | FIL | AP (phr) | | | | | | RM | RM | COLR | CORR- | CORR- | CORR- |
| lation | 1 | 2 | 1 | 1 | 4 | 5 | AP1 | AP2 | AP9 | AP13 | AP23 | AP24 | 1 | 2 | 1 | INH 1 | INH 2 | INH 3 |
| F1 | 100 | | | 40 | | | 6 | | | | | | | | | | | |
| F2 | 100 | | | 40 | | | | 6 | | | | | | | | | | |
| F3 | 100 | | | 40 | | | | | 1 | | | | 2 | | | | | |
| F4 | 100 | | | 40 | | | | | | 3 | | | 2 | 0.2 | | | | |
| F5 | | 70 | 30 | 40 | | | | | 3 | | | | | | 0.56 | | | |
| F6 | 100 | | | 40 | 5 | | | | 1 | | | | 4 | | | 15 | | |
| F7 | 100 | | | 40 | 5 | | | | 1 | | | | 4 | | | | 7.5 | |
| F8 | 100 | | | 40 | 5 | | | | 1 | | | | 4 | | | | 15 | |
| F9 | 100 | | | 40 | 5 | | | | 1 | | | | 4 | | | | | 7.5 |
| F10 | 100 | | | 40 | 5 | | | | 1 | | | | 6 | | | | | |
| F11 | 100 | | | 40 | 5 | | | | 3 | | | | 6 | | | | | |
| F12 | 100 | | | 20 | 25 | | | | 1 | | | | 6 | | | | | |
| F13 | 100 | | | 20 | 25 | | | | 3 | | | | 6 | | | | | |
| F14 | 100 | | | | | 45 | | | 1 | | | | 6 | | | | | |
| F15 | 100 | | | | | 45 | | | 3 | | | | 6 | | | | | |
| F16 | 100 | | | 40 | | 5 | | | 1 | | | | 6 | | | | | |
| F17 | 100 | | | 40 | | 5 | | | 3 | | | | 6 | | | | | |
| F18 | 100 | | | 20 | | 25 | | | 3 | | | | 6 | | | | | |
| F19 | 100 | | | | | 45 | | | 1 | | | | 6 | | | | | |
| F20 | 100 | | | | | 45 | | | 3 | | | | 6 | | | | | |
| F21 | 100 | | | 40 | | | | | | | | 3 | 6 | | | | | |
| F22 | | 70 | 30 | 40 | | | | | | | 3 | | | | | | | |
| F23 | | 70 | 30 | 40 | | | | | | | | 3 | | | | | | |

TABLE 17
ASTM B117 Salt Fog Corrosion Test Results
3-month B117 Corrosion

| For- | Rust | Adhesion Failure | Pull-off Adhesion |
|---|---|---|---|
| mulation | Creep | Mode | (psi) |
| F1 | 1.11 | 60% ACS, 40% ACG | 751 |
| F2 | 0.44 | ACS | 408 |
| F3 | 0.83 | 50% ACS, 50% ACG/CC | 1175 |
| F4 | 1.78 | 25% ACG, 75% CC | 2032 |
| F5 | n/a | ACS/CC | 1064 |
| F6 | 0.44 | 5% ACS, 95% ACG/CC | 2035 |
| F7 | 0.17 | 3% ACS, 97% ACG | 1857 |
| F8 | 0.28 | 30% ACS, 70% ACG | 1666 |
| F9 | 0.78 | ACG | 1654 |
| F10 | 1.28 | ACG | 1951 |
| F11 | 1.94 | ACG/ACS | 996 |
| F12 | 0.06 | 15% ACS, 85% ACG | 1399 |
| F13 | 2.33 | 30% ACS, 70% ACG | 1206 |
| F14 | 0.56 | 3% ACS, 97% ACG | 1333 |
| F15 | 1.06 | ACG/ACS | 1050 |
| F16 | 0.00 | ACG | 1609 |
| F17 | 0.00 | ACG | 2076 |
| F18 | 0.17 | 53% ACS, 47% ACG | 879 |
| F19 | 1.00 | 15% ACS, 85% ACG | 1382 |
| F20 | 0.61 | ACG | 1539 |
| F21 | 1.94 | CC/ACS | 1555 |
| F22 | 1.50 | ACS/ACG | 936 |
| F23 | 1.78 | ACG/CC | 1441 |

It is to be understood that while the invention has been described in conjunction with specific embodiments thereof, that the description and examples above are intended to illustrate and not limit the scope of the invention. Other aspects, advantages, and modifications within the scope of the invention will be apparent to those skilled in the art to which the invention pertains.

1. A coating composition comprising:
a) at least one olefinic resin composition comprising:
a.1) at least one olefinic component consisting of:
a. 1.1) 80-100 wt. %, based on the total weight of the olefinic component, of at least one cyclic olefin selected from the group consisting of Formulae (I), (II), and (III); and
a. 1.2) 0-20 wt. %, based on the total weight of the olefinic component, of at least one linear olefin of Formula (IV);
wherein the wt. % of the cyclic olefins of Formulae (I), (II), and (III), and the linear olefin of Formula (IV) add to 100 wt. % of the olefinic component; and
a.2) at least one metal carbene olefin metathesis catalyst, present in an olefin to catalyst molar ratio of 10,000,000:1 to 1,000:1; and
a.3) optionally, at least one thermoplastic hydrocarbon resin;
b) optionally, at least one inorganic filler;
c) at least one adhesion promoter selected from functionalized polyolefins; and
d) optionally, at least one coating additive;
wherein the cyclic olefin of Formulae (I), (II), and (III), and the linear olefin of Formula (IV) have the following structures: 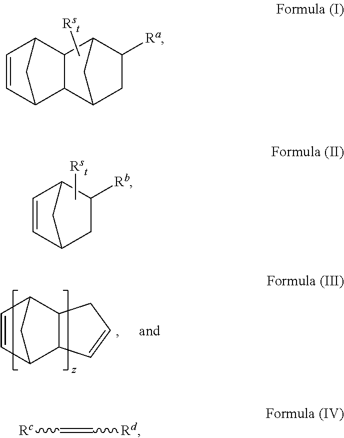
wherein:
R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, —C(R^{h})(Rⁱ)C(O)NR^{o}ORⁿ, or 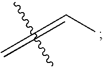
R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —Si(OR^{k})₃—S(O)₂OR^{h}, —OS(O)₂R^{h}, optionally substituted heterocycle, spiro optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{c} and R^{d} are, independent of one another, H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₂ cycloalkenyl, —CH₂-(optionally substituted C₃₋₁₂ cycloalkenyl), C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₂₄ alkenyl, —C(O)-(optionally substituted C₅₋₂₄ aryl), —C(O)-(optionally substituted linear or branched C₂₋₂₄ alkenyl), or optionally substituted C₃₋₁₂ cycloalkenyl;
R^{h}, Rⁱ, R^{j}, R^{l}, R^{m}, Rⁿ, R^{o}, and R^{p} are, independent of one another, H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₁₂ cycloalkenyl;
t is 0, 1, 2, 3, 4, 5, or 6; and
z is 0, 1, 2, or 3.

2. The coating composition of claim 1, wherein:
R^{a} is H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, optionally substituted C₃₋₁₂ cycloalkenyl, or 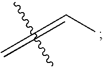
R^{b}, R^{c}, and R^{d} are, independent of one another, H, optionally substituted linear or branched C₁₋₁₂ alkyl, optionally substituted linear or branched C₂₋₆ alkenyl, halogen, —C(O)R^{f}, —OR^{g}, —CN, —NO₂, —CF₃, —P(O)(OR^{h})₂, —OP(O)(OR^{h})₂, —S(O)₂OR^{h}, —OS(O)₂R^{h}, optionally substituted heterocycle, optionally substituted C₃₋₁₀ cycloalkyl, optionally substituted C₆₋₁₀ aryl, or optionally substituted C₃₋₁₂ cycloalkenyl;
R^{f} is OH, OR^{k}, NR^{g}R^{h}, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{g}, R^{h}, Rⁱ, R^{j}, R^{l}, R^{m}, Rⁿ, R^{o}, and R^{p} are, independent of one another, H, optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
R^{k} is optionally substituted C₁₋₁₂ alkyl, optionally substituted C₃₋₈ cycloalkyl, optionally substituted heterocycle, optionally substituted C₆₋₁₀ aryl, or optionally substituted C₃₋₁₂ cycloalkenyl;
t is 0; and
z is 2.

3. The coating composition of claim 1, wherein:
the cyclic olefin of formula (I) is 2-ethylidene-1,2,3,4,4a,5,8,8a-octahydro-1,4:5,8-dimethanonaphthalene, 2-hexyl-1,2,3,4,4a,5,8,8a-octahydro-1,4:5,8-dimethanonaphthalene, or mixtures thereof;
the cyclic olefin of formula (II) is 2-hydroxyethyl bicyclo[2.2.1]hept-5-ene-2-carboxylate, [3-(triethoxysilyl) propyl]-bicyclo[2.2.1]hept-5-en-2-ylmethyl ester, octyl-norbornene, 5-norbornene-2-methanol, 5-norbornene-2-exo,3-exo-dimethanol, 2-hydroxyethyl bicyclo[2.2.1]hept-5-ene-2-carboxylate, norbornene triethoxy silane, 5-(perfluorobutyl) bicyclo[2.2.1]hept-2-ene, 2,2,3,3,4,4,5,5,6,6,7,7-dodecafluoroheptyl bicyclo[2,2,1]hept-5-ene-2-carboxylate, dicyclo[2.2.1]hept-5-ene-2-carboxylic acid, 2,2,2-trifluoro-1-(trifluoromethyl)ethyl ester, or mixtures thereof; and
the cyclic olefin of formula (III) is dicyclopentadiene, tricyclopentadiene, or mixtures thereof.

4. (canceled)

5. (canceled)

6. (canceled)

7. (canceled)

8. (canceled)

9. The coating composition of claim 1, wherein the at least one cyclic olefin is selected from dicyclopentadiene (DCPD), tricyclopentadiene (TCPD), and mixtures thereof.

10. The coating composition of claim 9 wherein, DCPD and TCPD are present in a ratio of 3:7 to 2:3 DCPD wt. %:TCPD wt. %.

11. (canceled)

12. The coating composition of claim 1, wherein the at least one metal carbene olefin metathesis catalyst is a Group 8 transition metal complex having the structure of formula (I): 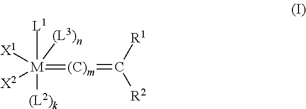
wherein:
M is a Group 8 transition metal;
L¹, L², and L³ are neutral electron donor ligands;
n is 0 or 1, such that L³ may or may not be present;
m is 0, 1, or 2;
k is 0 or 1;
X¹ and X² are anionic ligands; and
R¹ and R² are independently selected from hydrogen, hydrocarbyl, substituted hydrocarbyl, heteroatom-containing hydrocarbyl,
wherein any two or more of X¹, X², L¹, L², L³, R¹, and R² can be taken together to form one or more cyclic groups, and further wherein any one or more of X¹, X², L¹, L², L³, R¹, and R² may be attached to a support; or
wherein the at least one metal carbene olefin metathesis catalyst is a Group 8 transition metal complex having the structure of formula (I), wherein:
M is ruthenium;
n is 0;
m is 0;
k is 1;
L¹ and L² are trisubstituted phosphines independently selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ is an N-heterocyclic carbene selected from 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene; and L² is a trisubstituted phosphine selected from the group consisting of tri-n-butylphosphine (Pn-Bu₃), tricyclopentylphosphine (PCp₃), tricyclohexylphosphine (PCy₃), triisopropylphosphine (P-i-Pr₃), triphenylphosphine (PPh₃), methyldiphenylphosphine (PMePh₂), dimethylphenylphosphine (PMe₂Ph), and diethylphenylphosphine (PEt₂Ph); or
L¹ and L² are N-heterocyclic carbenes independently selected from the group consisting of 1,3-bis(2,4,6-trimethylphenyl)-2-imidazolidinylidene, 1,3-bis(2,6-di-isopropylphenyl)-2-imidazolidinylidene, 1,3-bis(2,4,6-trimethylphenyl)-2-imidazol-2-ylidene, and 1,3-bis(2,6-di-isopropylphenyl)-2-imidazol-2-ylidene;
X¹ and X² are chlorine; and R¹ is hydrogen and R² is phenyl or —CH═C(CH₃)₂; or R¹ and R² are taken together to form an indenylidene moiety.

13. (canceled)

14. The coating composition of claim 1, wherein the at least one metal carbene olefin metathesis catalyst is a Group 8 transition metal complex having the structure of formula (VII): 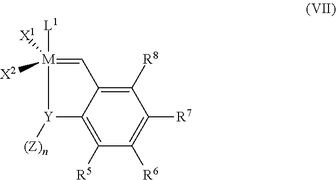
wherein:
M is a Group 8 transition metal;
X¹ and X² are anionic ligands;
L¹ is a neutral electron donor ligand;
Y is a heteroatom selected from N, O, S, and P;
R⁵, R⁶, R⁷, and R⁸ are each, independently, selected from the group consisting of hydrogen, halogen, alkyl, alkenyl, alkynyl, aryl, heteroalkyl, heteroatom containing alkenyl, heteroalkenyl, heteroaryl, alkoxy, alkenyloxy, aryloxy, alkoxycarbonyl, carbonyl, alkylamino, alkylthio, aminosulfonyl, monoalkylaminosulfonyl, dialkylaminosulfonyl, alkylsulfonyl, nitrile, nitro, alkylsulfinyl, trihaloalkyl, perfluoroalkyl, carboxylic acid, ketone, aldehyde, nitrate, isocyanate, hydroxyl, ester, ether, amine, imine, amide, trifluoroamide, sulfide, disulfide, sulfonate, carbamate, silane, siloxane, phosphine, phosphate, borate, or -A-Fn, wherein A is a divalent hydrocarbon moiety selected from alkylene and arylalkylene, wherein the alkyl portion of the alkylene and arylalkylene groups can be linear or branched, saturated or unsaturated, cyclic or acyclic, and substituted or unsubstituted, wherein the aryl portion of the of arylalkylene can be substituted or unsubstituted, and wherein hetero atoms and/or functional groups may be present in either the aryl or the alkyl portions of the alkylene and arylalkylene groups, and Fn is a functional group; and any combination of R⁵, R⁶, R⁷, and R⁸ can be linked to form one or more cyclic groups;
n is 1 or 2, such that n is 1 for the divalent heteroatoms O or S, and n is 2 for the trivalent heteroatoms N or P; and
Z is a group selected from hydrogen, alkyl, aryl, functionalized alkyl, functionalized aryl where the functional group may independently be one or more or the following: alkoxy, aryloxy, halogen, carboxylic acid, ketone, aldehyde, nitrate, isocyanate, hydroxyl, ester, ether, amine, imine, amide, trifluoroamide, sulfide, disulfide, carbamate, silane, siloxane, phosphine, phosphate, or borate; methyl, isopropyl, sec-butyl, t-butyl, neopentyl, benzyl, phenyl and trimethylsilyl; and
wherein any combination or combinations of X¹, X², L¹, V, Z, R⁵, R⁶, R⁷, and R⁸ may be linked to a support.

15. The coating composition of claim 1, wherein the thermoplastic hydrocarbon resin is present in the coating composition in an amount ranging from 0-about 25 wt. %, based on the total weight of the coating composition.

16. (canceled)

17. (canceled)

18. (canceled)

19. (canceled)

20. (canceled)

21. (canceled)

22. The coating composition of claim 1, wherein the adhesion promoter is selected from maleic anhydride-functionalized polybutadienes, silane-functionalized polybutadienes, epoxidized polybutadienes, silane and maleic anhydride modified polybutadienes, and mixtures thereof.

23. (canceled)

24. (canceled)

25. (canceled)

26. (canceled)

27. (canceled)

28. (canceled)

29. The coating composition of claim 1, wherein the coating composition comprises the coating additive and the coating additive is selected from the group consisting of a gel modifier, a hardness modulator, an impact modifier, an antioxidant, an antiozonant, a binder, a thixotrope, a rheology modifier, a corrosion inhibitor, a dispersant, a wetting agent, a plasticizer, a pigment, a flame retardant, a dye, fibers, a reinforcement material, a coupling agent, a UV absorber, a UV light stabilizer, a film former, a lubricant, and mixtures thereof.

30. The coating composition of claim 29, wherein the coating additive is selected from the group consisting of at least one rheology modifier, at least one corrosion inhibitor, at least one pigment, and mixtures thereof.

31. The coating composition of claim 29, wherein the corrosion inhibitor is selected from zinc-phosphate-based corrosion inhibitors, calcium borosilicate-based corrosion inhibitors, zinc and aluminum-based corrosion inhibitors, and mixtures thereof.

32. The coating composition of claim 31, wherein the corrosion inhibitor is selected from Halox SZP391, Halox CW-2230, Halox 700, and mixtures thereof.

33. The coating composition of claim 29, wherein the corrosion inhibitor is present in the coating composition in an amount ranging from about 0.01-15 wt. %, based on the total weight of the coating composition.

34. (canceled)

35. (canceled)

36. (canceled)

37. The coating composition of claim 29, wherein the coating additive is selected from at least one rheology modifier.

38. The coating composition of claim 29, wherein the rheology modifier is selected from fumed silica, organoclay, and mixtures thereof.

39. The coating composition of claim 29, wherein the rheology modifier is present in the coating composition in an amount ranging from about 0.01-10 wt. %, based on the total weight of the coating composition.

40. (canceled)

41. (canceled)

42. (canceled)

43. The coating composition of claim 1, comprising:
about 35-99.89 wt. %, based on the total weight of the coating composition, of the olefinic component, wherein the olefinic component is selected from dicyclopentadiene, tricyclopentadiene, or mixtures thereof;
0-about 25 wt. %, based on the total weight of the coating composition, of the thermoplastic hydrocarbon resin;
about 0.1-65 wt. %, based on the total weight of the coating composition, of the inorganic filler, wherein the inorganic filler is selected from mica, micaceous iron oxide, aluminum flakes (paste), zinc aluminum flakes (paste), talc, calcium metasilicate, glass flake, aluminum powder, wollastonite, and mixtures thereof;
about 0.01-10 wt. %, based on the total weight of the coating composition, of the adhesion promoter, wherein the adhesion promoter is selected from maleic anhydride-functionalized polybutadienes, silane-functionalized polybutadienes, and mixtures thereof; and
0-about 5 wt. %, based on the total weight of the coating composition, of the coating additive, wherein the coating additive is selected from a rheology modifier.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A method for coating a substrate material, comprising:
optionally applying an adhesion promoter onto the substrate surface;
applying onto the substrate surface a coating composition of claim 1; and
curing at room temperature the coating applied on the substrate surface.

56. (canceled)

57. (canceled)

58. (canceled)

59. An article of manufacture comprising a substrate coated with a cured coating composition, wherein the coating composition is a coating composition of claim 1.

60. (canceled)

61. (canceled)
